(19) United States
(12) Patent Application Publication
(10) Pub. No.: US 2026/0255146 A1
(43) Pub. Date: Aug. 27, 2026

(54) METHODS, APPARATUS, AND SYSTEMS FOR USER-CENTRIC AND DECENTRALIZED ROAMING

(71) Applicant: InterDigital Patent Holdings, Inc., Wilmington, DE (US)

(72) Inventors: Efat Fathalla, Lexington, VA (US); Chonggang Wang, Princeton, NJ (US); Xu Li, Plainsboro, NJ (US); Robert Gazda, Spring City, PA (US); Ulises Olvera-Hernandez, Saint-Lazare (CA)

(73) Assignee: InterDigital Patent Holdings, Inc., Wilmington, DE (US)

(21) Appl. No.: 18/995,335

(22) PCT Filed: Aug. 16, 2023
(86) PCT No.: PCT/US2023/072268

§ 371 Date: Jan. 16, 2025

Related U.S. Application Data
(60) Provisional application No. 63/399,115, filed on Aug. 18, 2022.

(51) Int. Cl. H04W 8/08; H04W 8/26; H04W 12/06

(52) U.S. Cl. CPC H04W 8/08; H04W 8/26; H04W 12/06

(57) ABSTRACT

A wireless transmit/receive unit (WTRU) may send a roaming request to a network. The network may be a visited network. The roaming request may comprise an address associated with a WTRU roaming proof transaction. The WTRU may receive an authentication vector that depends on an authentication policy described in the WTRU roaming proof transaction. The WTRU may generate an authentication response based on the authentication policy. The WTRU may send the authentication response to the network. The WTRU may receive a notification from the network. The notification may indicate whether the roaming request has been successful.

### CROSS-REFERENCE TO RELATED APPLICATIONS

This patent application claims the benefit of U.S. Provisional Patent Application No. 63/399,115, filed on Aug. 18, 2022, the entirety of which is herein incorporated by reference.

### BACKGROUND

Cellular networks are shifting toward complex systems with heterogeneous participants. Reliable wireless communication coverage and service provisioning requires uninterrupted connectivity between wireless communication components, including radio cells and core networks. Due to the high mobility of WTRUs, reliable yet uninterrupted connectivity remains a challenge. Roaming in wireless communications alleviates the problems of interrupted connectivity and ensures full wireless communication coverage to the subscribers who visited other networks (e.g., roaming WTRUs). Roaming extends the coverage of the Home Network (HN) operator, allowing the HN operator's mobile WTRUs to use the network and services provided by another network operator, referred to as Visited Network (VN). According to the 3GPP, there are two roaming implementations based on the geographical location of the visited and home networks. The first roaming implementation is the national roaming services, where the roaming WTRUs utilize the network resources of another network operator within the same geographical location of the roaming WTRU's HN. The other roaming implementation is international roaming, where the UE exploits the network coverage of a VN located in another geographical location of the WTRU's HN.

Two roaming models are Home-Routed (HR) and Local Breakout (LBO) models. Both models (e.g., HR and LBO) rely on a new network function called Security Edge Protection Proxy (SEPP). SEPP acts as a service relay between the VN and HN providing a secure connection as well as hiding the complexity of the network topology of both VN and HN. Further, an Application Function (AF) in both networks (i.e., HN and VN) interacts with 5GC to provide the required services, such as traffic routing or policy control. AUSF within the HN is responsible for performing authentication between the WTRU and the 5GC. It is worth noting that, in both models (e.g., LBO and HN), the HN is responsible for authenticating the roaming WTRU and verifying the roaming WTRU to the VN. For example, the HN may authenticate the roaming WTRU using one of the authentication mechanisms like 5G-AKA. During the authentication process, the HN reveals the permanent identifier (e.g., SUPI) to the VN to assure the authentication and verification of the roaming WTRU identity to the VN.

### SUMMARY

Methods and apparatuses are provided for user-centric and decentralized roaming for wireless communications. Methods and apparatuses are provided for roaming service enablement. Methods and apparatuses are provided for roaming service activation. Methods and apparatuses are provided for roaming wireless transmit/receive unit (WTRU) mutual authentication and/or initial access. Methods and apparatuses are provided for roaming WTRU temporary visited network (VN) accessibility.

A WTRU may send a roaming request to a network. The network may be a visited network. The roaming request may comprise an address associated with a WTRU roaming proof transaction. The WTRU may receive an authentication vector that depends on an authentication policy described in the WTRU roaming proof transaction. The WTRU may generate an authentication response based on the authentication policy. The WTRU may send the authentication response to the network. The WTRU may receive a notification from the network. The notification may indicate whether the roaming request has been successful.

The WTRU may perform a method where the WTRU sends a request to a first network system requesting a roaming proof address from the first network system. The first network system comprises a home network system through which the WTRU is registered for performing wireless communications. The WTRU may receive a response from the first network system comprising a roaming proof address, wherein the roaming proof address comprises an address to a second network system where roaming proof information is accessible via the roaming proof address. The WTRU sends the roaming proof address to a third network system to access the third network system, where the third network system is a visited network system. The WTRU receives an authentication request from the third network system wherein the authentication request comprises a request to perform authentication based on the roaming proof information and sends an authentication response to the third network system wherein the authentication response comprises a response to the authentication request that is based on the roaming proof information. The third network system may retrieve the roaming proof information from the second network system according to the roaming proof address. The roaming proof information may be accessible via distributed ledgers, where the distributed ledgers may comprise a blockchain.

The WTRU may access the roaming proof information using distributed ledgers. The distributed ledgers may comprise a blockchain.

The request sent by the WTRU may comprise an indication of an authentication policy supported by the WTRU. The authentication policy may comprise an RSA (Rivest-Shamir-Adleman) authentication policy or a Chameleon Hash (CH) authentication policy. The request sent by the WTRU may further comprise an indication of a lifetime for the roaming proof address and a location of the WTRU.

The WTRU receives an authentication challenge from the third network system, wherein the authentication challenge may be determined based on the authentication policy supported by the WTRU. The authentication policy supported by the WTRU may comprise an RSA or CH authentication policy. The WTRU, further, may perform the authentication challenge to determine the authentication response.

The WTRU receives the response from the first network system, wherein the response comprises the roaming proof address, authentication parameters (e.g., WTRU Roaming Proof Parameters (WTRU−RPP)), and a WTRU−Proof value that may be used to anonymously authenticate the WTRU.

The WTRU sends a request to a blockchain system to obtain one or more public keys of the third network system to verify and authenticate the third network system. The WTRU may receive a response from the third network system that comprises the one or more public keys of the third network system.

The WTRU may receive an indication from the third network system that the authentication is complete.

The WTRU may comprise a processor configured to send a request to a first network system requesting a roaming proof address from the first network system. The first network system comprises a home network system through which the WTRU is registered for performing wireless communications. The one or more processors may be further configured to receive a response from the first network system comprising the roaming proof address wherein the roaming proof address comprises an address to a second network system, where roaming proof information is accessible via the roaming proof address. The processor may be further configured to send the roaming proof address to a third network system to access the third network system, wherein the third network system is a visited network system. The one or more processors may be further configured to receive an authentication request from the third network system, wherein the authentication request comprises a request to perform authentication based on the roaming proof information. The processor may be further configured to send an authentication response to the third network system wherein the authentication response comprises a response to the authentication request that is based on the roaming proof information. The roaming proof information may be accessible via distributed ledgers, where the distributed ledgers may comprise a blockchain.

The processor may be configured to send an indication of an authentication policy supported by the WTRU. The authentication policy may be an RSA authentication policy or a CH authentication policy.

The processor is configured to send a request to the first network system. The request may comprise an indication of a lifetime for the roaming proof and a location of the WTRU.

The processor is configured to receive an authentication challenge from the third network system, where the authentication challenge may be determined based on the authentication policy supported by the WTRU. The processor may perform the authentication challenge to determine the authentication response.

The processor is configured to receive a response from the first network system, where the response comprises the roaming proof address. The response may further comprise authentication parameters (e.g., WTRU Roaming Proof Parameters (WTRU−RPP)) and a WTRU−Proof Value that is used to anonymously authenticate the WTRU.

The processor may be configured to send a request to a blockchain system to obtain one or more public keys of the third network system to verify and authenticate the third network system. The third network system comprises a visited network system. The processor is further configured to receive a response from the third network system that may comprise one or more public keys of the third network system.

The processor may be further configured to receive an indication from the third network system that indicates the authentication is complete.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example of the Chameleon Hash Functions;

FIG. 3 is a diagram illustrating 5G System Architecture;

FIG. 4 is a diagram illustrating an example of general procedures in 5G System Architecture;

FIG. 5A and FIG. 5B are diagrams illustrating examples of roaming architecture;

FIG. 6 is a diagram illustrating examples of different use cases for decentralized roaming services;

FIG. 7 is a diagram illustrating an example of an overview of the decentralized Wireless Transmit/Receive Unit (WTRU)-centric Roaming model that may be provided;

FIG. 8 is a table illustrating an example of a comparison between Traditional Roaming and Decentralized WTRU-centric Roaming;

FIG. 9 is a diagram illustrating an example of main procedures to realize WTRU-centric decentralized roaming services;

FIG. 10 is a flow diagram illustrating an example of roaming services enablement;

FIG. 11 is a flow diagram illustrating an example of roaming services activation;

FIG. 12 is a flow diagram illustrating an example of an RSA-based Authentication Policy;

FIG. 13 is a flow diagram illustrating an example of Chameleon Hash (CH)-based Authentication Policy;

FIG. 14 is a flow diagram illustrating an example of a mutual authentication phase;

FIG. 15 is a flow diagram illustrating an example of a mutual authentication phase according to an RSA-based authentication policy;

FIG. 16 is a flow diagram illustrating an example of a mutual authentication phase according to CH-based authentication policy;

FIG. 17 is a flow diagram illustrating an example of an initial access phase;

FIG. 18 is a flow diagram illustrating an example of a roaming service agreement considering Visited Network (VN)-Proof;

FIGS. 19A and 19B is a flow diagram illustrating an example of a dual authentication phase;

FIG. 20 is a flow diagram illustrating an example of roaming WTRU Temporary VN Accessibility;

FIGS. 21A and 21B illustrate an example 3GPP Service Flow for Roaming Service Enablement Strategy;

FIG. 22 is a flow diagram illustrating an example of 3GPP Service Flow for Roaming Service Activation Stage;

FIGS. 23A and 23B illustrate an example 3GPP Service Flow for WTRU Dual Authentication Stage; and

FIG. 24 is a flow diagram illustrating an example of 3GPP Service Flow for Initial Access Stage.

### DETAILED DESCRIPTION

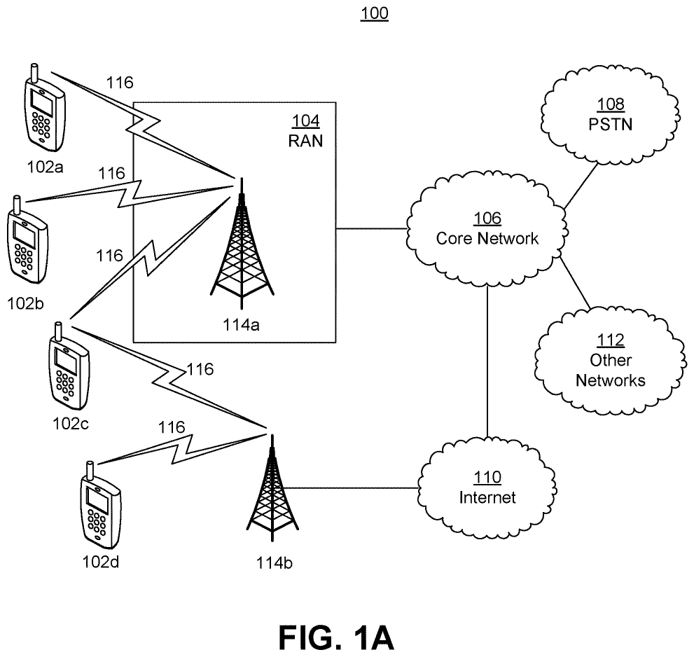

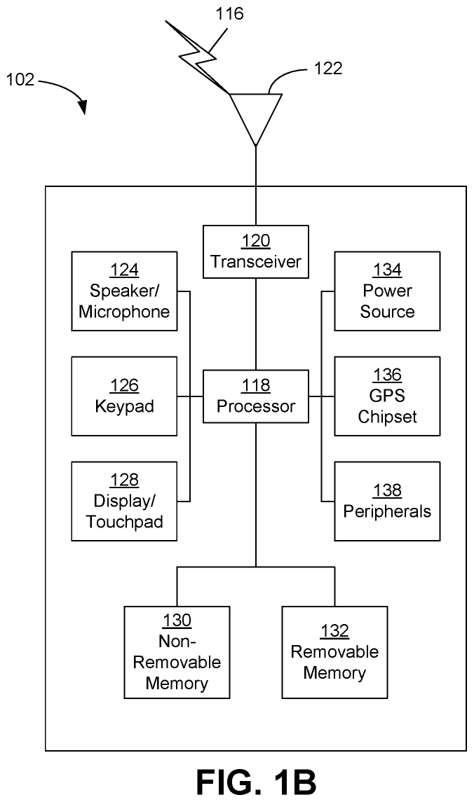

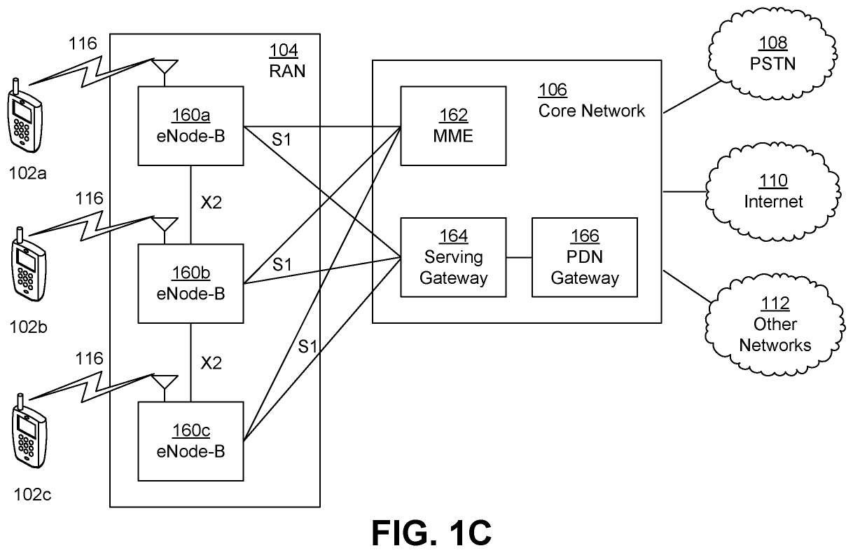

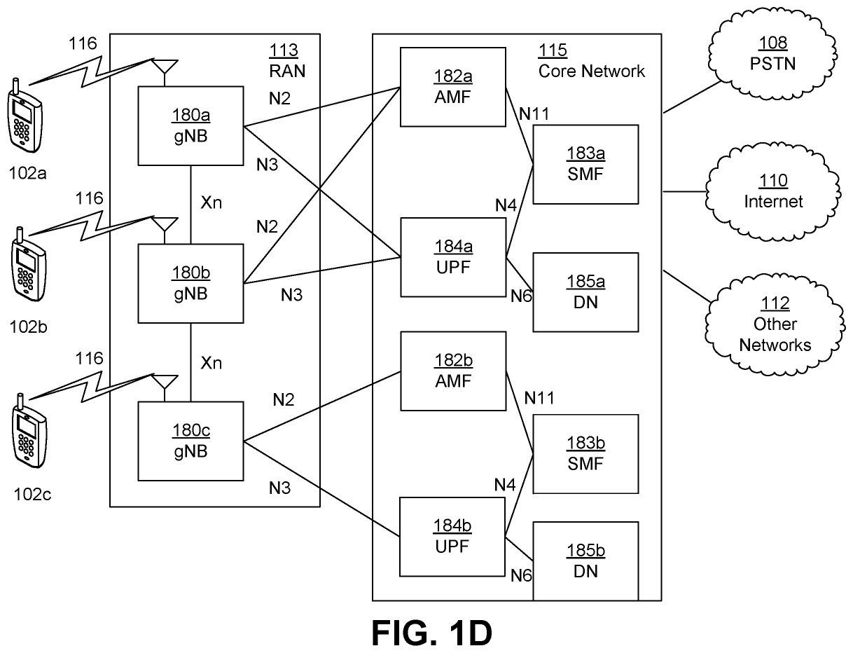

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WIMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a(not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b(and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Blockchain systems may be provided. Distributed Ledger Technology (DLT) usually refers to shared, immutable, and tamper-proof decentralized records of transactions maintained across several computers linked in a peer-to-peer network. Distributed ledgers like blockchain may facilitate recording the history of transactions between two or more (e.g. multiple) entities that may not trust each other. The interactions between entities within the Distributed Ledger System (DLS) may be placed in a pool of transactions until verified. Verified transactions may then compacted to form a Merkle tree stored within cryptographically chained blocks. In any DLS, the network peers may follow a consensus mechanism to manage the transactions and block validations. In other words, the consensus mechanism may be to enable multiple network peers to have the same/consistent view/decision on the ledger status (e.g., which new transaction block may be appended to the ledger in each round, etc.). According to the DLS requirements, type, speed of verifications, and application, the adopted consensus mechanisms may differ. The most common consensus protocols may be the Proof-of-Work (PoW) and the Proof-of-Stake (POS).

Proof-of-Work (PoW) consensus protocols may be provided. For example, PoW may be the consensus mechanism adopted by the famous bitcoin application. The blocks generation and validation in PoW may include a mining process. In the mining process, the network peers (e.g., miners) may solve arbitrary puzzles that may require finding a nonce used to complete the block generation. The miners' incentive to find the nonce correctly may be to win the corresponding block reward. The rest of the network peers may then validate the proffered effort done by the winning miner and broadcast the generated block to the rest of the network peers. PoW may be known for the exertion of computational power in finding unique nonce values that satisfy the hashing criteria of the generated blocks. The adoption of the PoW mechanism may guarantee fairness between the competing miners and maintains system security; however, the PoW mechanism may require high energy consumption and/or a longer processing time. Proof-of-Stake (PoS), on the other hand, evolved as a low-cost energy-friendly consensus mechanism. PoS depends on responsibility allocation to maintain the network. Thus, the validators' selection criteria may be based on the staked coins. Staking more cryptocurrency gives the validator more chances to have the rights to check and add new blocks of transactions to the distributed ledger. However, this comes with the drawback that incentives crypto coin hoarding instead of spending.

Other consensus mechanisms (e.g., blockchain consensus mechanisms) may be provided herein. Delegated proof-of-stake (DPoS) and/or Practical Byzantine Fault Tolerance (PBFT) may require lower energy consumption that may replace the computation hunger PoW mechanism. DPOS may be a variation of PoS by which higher staking miners may vote on several delegates who may manage and/or secure the DLS network. The voting and delegation mechanism incentivizes blockchain nodes to secure the network with their staked collateral. In the PBFT mechanism, any block to be verified may require a group of a certain number of blockchain nodes to agree on its validity. The nodes may reach a consensus at a predetermined threshold (e.g. when more than three times the assumed Byzantine nodes vote towards a particular decision).

There may be various types of DLS herein that include public, private, consortium, and permissioned DLS. Public DLS may allow anyone to join, participate, and access the DLS records. The bitcoin blockchain application may be a well-known example of public DLS networks. Private DLS may be a small-scale DLS that may be hosted within an internal local network governed by one or more (e.g. a single) organization. In private DLS, there may be restrictions on who will generate the transaction blocks and/or how the consensus protocol may be applied. The organization may oversee the DLS network and/or manage transaction generation, accessibility, and/or verification. Permissioned DLS may be comparable to private DLS, where single/multiple entities may control the network. Any data accessibility may be private or public under the control of the governing entity. Consortium DLS may be a network governed by a group of organizations controlling the execution of the consensus mechanism(s) and/or maintaining the shared ledger using a byzantine fault tolerance mechanism. Governing organizations may manage which data to store in the ledger and/or the accessibility constraints to the network transactions. Blockchain system and DLT may be used interchangeably herein.

Hashing, in general, may be defined as a one-way function that accepts an input message of any arbitrary length and may generate a unique random output that may be denoted as one or more of the hash value; the hash output; input's fingerprint; or fingerprint. Being a one-way function means it may be likely impossible to derive the input message knowing only its hash. Hashing schemes are usually characterized as collision-resistance, where any arbitrary change in the input message may result in a completely new hash value. The hash function effectiveness and security may be based on the likelihood of finding collisions between two distinctive messages (m1, m2). Thus, the possibility to find a collision between two different input messages may be almost negligible in more robust hashing schemes. The most well-known hashing schemes are SHA256, SHA512, MD5, etc. Depending on the scheme, the hash output may have the same length. As an example, the length of the hash output of SHA256 may be 256 bits regardless of the length of the input message, and SHA512 may generate a 512-bits hash value. Therefore, any cryptographic hash function may have any of the following properties.

A cryptographic hash function may accept an input with any arbitrary length and produce a fixed-length output.

A cryptographic hash function may include a one-way function, such that given only the output, it may be impossible to recognize the input.

A cryptographic hash function may include collision-resistance (or collision-free), where it may be nearly impossible to find two different input messages that have the same hash value. Hashing schemes may be used in applications that require integrity checks. For example, backend servers may employ hash schemes to store passwords by their hash values to avoid keeping the unencrypted data related to stored passwords. When an online user specifies his password during a service request, the hash values of such a password may be compared to the stored hash value within the backend server database as the user identification and/or authentication check. Blockchain system may be another example of demonstrating the strength of hash function schemes. The generated blocks in the blockchain system may be chained by their hash values, making the blockchain system immutable and tamper-proof. Despite being effective in obtaining information integrity checks, other applications may require some flexibility to alter the data while keeping the computed hash value the same. For instance, the append-only nature of blockchain may have already been abused, leading crypto criminals and hackers to inject arbitrary, illegal contents into distributed ledgers successfully.

An alternative solution to traditional collision-free hashing schemes, Krawczyk and Rabin in 2000 proposed a hashing scheme called Chameleon Hashing (CH). CH may provide a one-way function generating unpredicted hash values (h) for an input message (m). By theory, it may be impossible to extract the value of m given only the knowledge value of h. Further, CH may also a collision-free scheme, where it may be likely impossible to find any two messages (m1, m2) resulting in the exact hash value (h) unless a collision trapdoor key is employed. The difference between CH and other hashing schemes may be that CH leverages a secret trapdoor key to enable a trapdoor and cause hash collisions. The owner of the secret trapdoor key may be an (e.g., the only) entity that may cause collisions between two or more different input messages (m₁, m₂, . . . , mₙ).

Structure-wise, the chameleon hash scheme may include a user-generated key pair, which may be a public key (Y) and/or a private trapdoor key (X). The usage of each key may be described as follows:

The public key (Y) may facilitate the calculation of the CH hash value or the CH value (m₁−CH) for a given input message (m₁), where m₁∈[0,1]*. The public key may allow any entity to calculate and/or verify the CH value (m₁−CH) corresponding to the given input message (m₁).

The private trapdoor key (X) may trigger the CH trapdoor that cause a collision between two or more distinctive input messages (m₁, m₂, . . . , mₙ), with arbitrary lengths. The terms trapdoor key or secret trapdoor key may be used as alternative acronyms to the private trapdoor key (X).

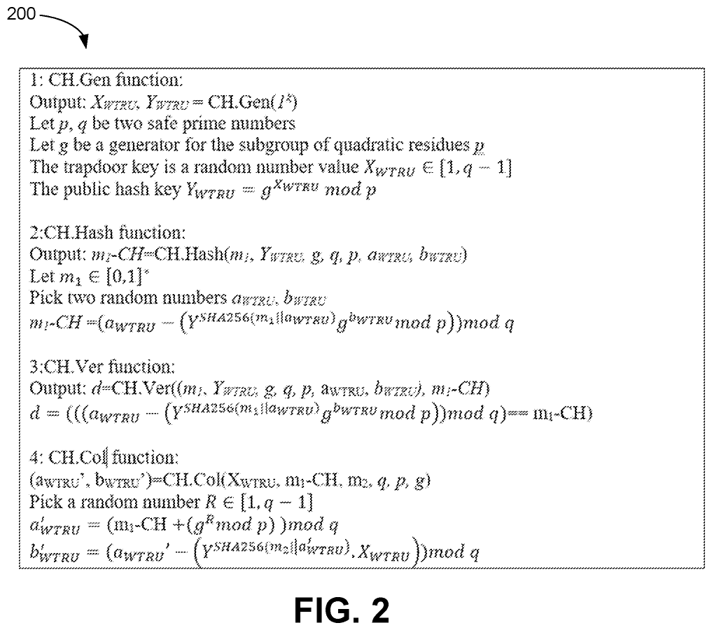

FIG. 2 illustrates example Chameleon Hash Functions 200. The CH scheme may define four or more operational functions herein: CH.Gen; CH. Hash; CH.Ver; and/or CH.Col.

The CH. Gen function may enable the generation of the public (Y_{WTRU})/private (X_{WTRU}) key pairs for at least a particular WTRU, where the subscript WTRU refers to the WTRU that generates and/or owns the CH key pair. CH. Hash may be a one-way irreversible hashing function that accepts an input message with any arbitrary length and/or computes as an output its corresponding unique and/or collision-free CH value. Such a function may include the WTRU's public key (Y_{WTRU}), some precalculated cryptographic primitives (g, p, q), and/or a least (e.g. two) randomly generated numbers (a_{WTRU}, b_{WTRU}) referred to as CH collision public parameters (CHCPP) in computing CH value (m₁−CH) of the input message (m₁).

CH. Ver may be a function that validates the equality between a given CH value (m₁−CH) of a certain input message (m₁) and/or the output of executing CH.Hash function for the same input message (m₁). For example, CH. Ver may indicate whether m₁−CH is equal to the resulting value of executing CH. Hash function, given public parameters (Y_{WTRU}, g, p, q), and/or message (m₁), and/or corresponding CHCPP (a_{WTRU}, b_{WTRU}).

CH. Col may be a CH unique function that may require the private trapdoor key (X_{WTRU}) to enable induced collisions between the CH value of the input message (m₁) and any other input messages (m₂, m₃, . . . , mₙ). CH collisions in this matter may be represented by the fact that m₁−CH may have the same value of m₂−CH, m₃−CH, . . . , mₙ−CH.

A private trapdoor key X_{WTRU} may be a secret value, while the tuple (Y_{WTRU}, p, q, g, a_{WTRU}, b_{WTRU}) may be public values. The tuple (Y_{WTRU}, p, q, g) may be denoted as CH Public Parameter (CHPP), while the CH collision public parameters (a_{WTRU}, b_{WTRU}) may be called CHCPP.

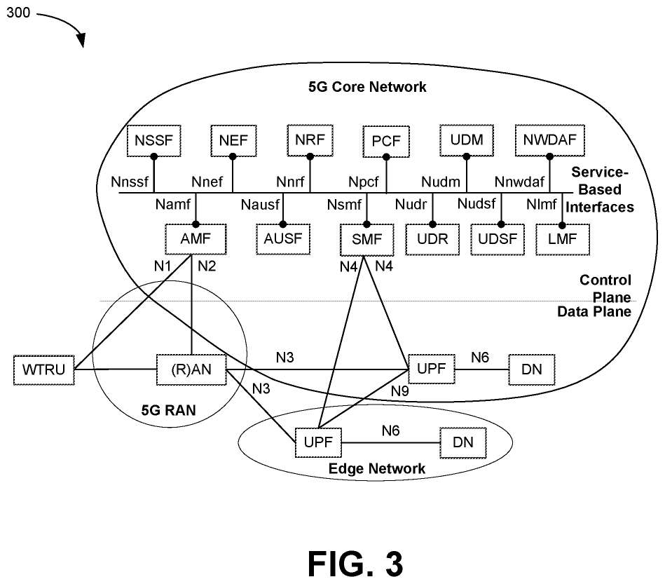

FIG. 3 illustrates an example 5G system architecture 300. 5G system architecture may include WTRUs, Radio Access Network (RAN), and/or Core Network. One of the design principles for 5G system architecture may be service-centric or service-based. As shown in FIG. 3, 5G Core Network may include a variety of network functions, which may work together to fulfill and/or provide needed services to RAN, WTRU, and/or Application Server/Service Provider. A network function may access another function in request/response mode or subscription/notification mode. Before two network functions interact with each other, they may first need to register with Network Repository Function (NRF) so that they may discover each other from NRF. Among these network functions, the Access and Mobility Management Function (AMF), dedicated to managing WTRU's access to the 5G system and its mobility, Session Management Function (SMF) is responsible for establishing sessions between a WTRU and 5G core network.

Authentication Server Function (AUSF) takes charge of WTRU authentication. Alternatively or additionally, Policy Control Function (PCF) may provide policy rules for other control plane network functions and WTRU. PCF may assign an identifier for each created policy rule, which other control plane network functions and WTRU may use to refer to the corresponding policy rule. User Plane Function (UPF) may be the only function for the user plane; UPF may facilitate monitoring, managing, controlling, and/or redirecting user plane traffic flows, such as between a WTRU and an application server. Network Exposure Function (NEF) may enable exploration control plane functions to entities such as network applications outside the 5G system and/or not in the same trusted domain. 5G core network also may provide data storage and/or analytics services through functions like Unified Data Management (UDM), Unified Data Repository (UDR), Unstructured Data Storage Function (UDSF), and/or Network Data Analytics Function (NWDAF). Another feature of the 5G system may be network slicing, facilitated by Network Slice Selection Function (NSSF).

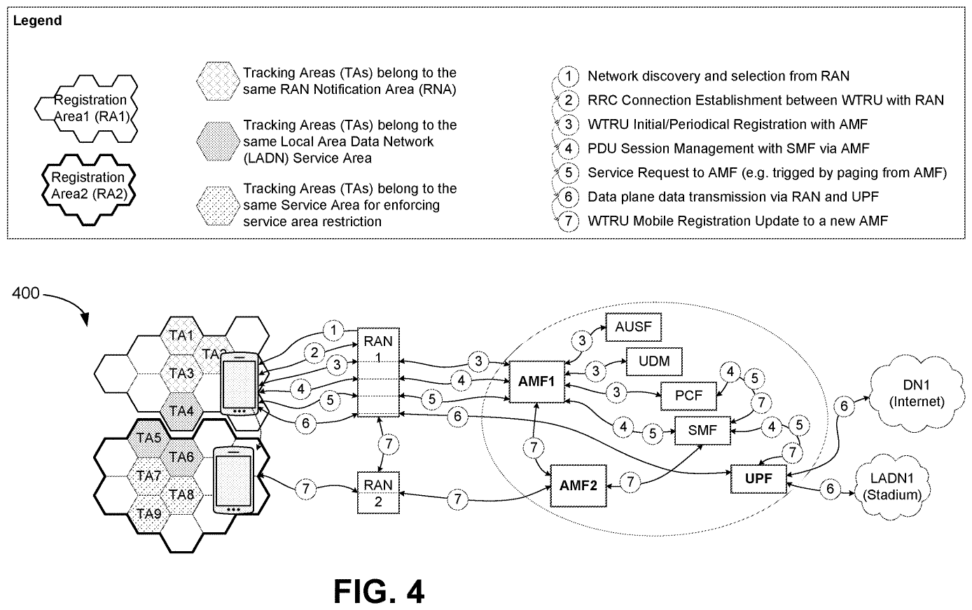

Although these network functions may be defined as separate logical entities, a particular scenario may require multiple functions; for instance, WTRU mobility may need AMF, AUSF, and/or SMF. For a type of network function, multiple instances may be instantiated, and NRF may maintain the information of each instantiated network function instance. Some network functions in the 5G Core Network, such as UPF and NEF, may be deployed and/or resided in an edge network that may be much nearer to and potentially co-located with RAN. FIG. 4 illustrates example procedures 400 in a 5G system architecture. The example procedures 400 may be jointly performed by entities including a WTRU, RAN node, and/or 5GC sequentially to enable the WTRU to fulfill the following functionalities.

The WTRU may discover and/or select a network (e.g., a PLMN, a RAN, a cell) based on the received System Information Block (SIB), which RAN nodes broadcast to one or more (e.g., all) WTRUs.

The WTRU may establish a Radio Resource Control (RRC) connection with the selected RAN (e.g., RAN1) so that the WTRU may communicate with the core network via the selected RAN.

The WTRU may initiate registration with a serving AMF, determined by the selected RAN. The serving AMF may check with AUSF for primary access authentication and/or authorization, request WTRU's subscription data from UDM, check with PCF for access and/or mobility policies, and/or contact SMF to activate any existing PDU session if WTRU indicates. 5G may introduce the Registration Area (RA) concept, which may include multiple Tracking Areas (TAs). When the WTRU stays within a RA (e.g., RA1), the WTRU may not need to perform a registration update with the serving AMF again to reduce signaling overhead unless the periodical registration timer expires. It is important to note that each TA may cover multiple cells. When the WTRU moves from one RA to another RA (e.g., RA2), the WTRU may need to perform a new registration with the registration type set to Mobility Registration Update. A larger RA may help reduce registration overhead, but the larger RA may increase the overhead of paging signaling, which the serving AMF may use to page a WTRU.

The WTRU may then enter the RM-REGISTERED state and may start interacting with one or more other control plane NFs via the serving AMF. The serving AMF may be the only entry point for the WTRU to access and/or interact with the core network control plane. It is important to note that the third, fifth and seventh general procedures in a 5G system architecture may be related to connection management. Alternatively or additionally, the service request may be done together with WTRU registration. As a result, the WTRU may enter CM-CONNECTED. When the WTRU stays in a CM-CONNECTED state, the WTRU may move within the RA, potentially without notifying the serving AMF. But if the WTRU moves out of a RAN Notification Area (RNA) yet is still within the RA, the WTRU may need to perform a RAN update to trigger the RAN to update the WTRU context and/or the corresponding RRC connection maintained by the RAN. It is important to note that an RNA may be a subset of a RA; for example, TA1, TA2, and TA3 form an RNA.

Alternatively or additionally, the WTRU may establish a PDU session for a designated DN with an SMF, which the serving AMF may determine. The SMF may check with a PCF for PDU session policies and/or select a UPF as the PDU Session Anchor (PSA). The PSA may be the entry point for the WTRU to access a Data Network (DN) or receive packets from a DN. When the SMF checks with the PCF for session policies, the PCF may retrieve WTRU's subscription data from a UDR.

Additionally or alternatively, the SMF may perform primary session authentication using the WTRU's subscription data as retrieved from a UDM and/or optionally perform secondary authentication between the WTRU and a DN−AAA server using an Extensible Authentication Protocol (EAP). It is important to note that this procedure may be jointly performed with the fifth general procedure in a 5G system architecture.

When the WTRU may enter to CM-IDLE state (e.g., after the WTRU's connection with the serving AMF may be released), the WTRU (e.g., in Mobile Initiated Connections Only (MICO) mode) may actively initiate the service request procedure to reestablish a connection with the serving AMF and/or enters to CM-CONNECTED state. If the WTRU is not in MICO mode while in CM-IDLE state, the serving AMF may page and/or trigger the WTRU to initiate service request procedure, for example, to receive any downlink packets. As a result of the service request, a Non-Access-Stratum (NAS) connection may be established between the WTRU and its serving AMF.

The WTRU may now start data plane data transmission with the designated DN via RAN and/or the UPF as PSA. It is important to note that each DN may have a Data Network Name (DNN).

When the WTRU may move from RA1 to RA2, the WTRU may detect this event by checking the list of TAs for each RA as configured by the serving AMF. Then, the WTRU may perform a Mobile Registration Update with a new serving AMF. Xn-based or N2-based inter-RAN handover may be conducted between the new RAN and the old RAN. The new serving AMF may contact the old serving AMF for transferring WTRU's context information. The SMF may contact PCF and UPF to update existing PDU sessions with the WTRU.

As shown in FIG. 4, multiple TAs may be grouped together as a Local Area Data Network (LADN) service area to support LADN service. As an example, TA4, TA5, and TA6 may form a LADN service area. The WTRU may be allowed to access LADN1 if the WTRU stays within TA4, TA5, or TA6. Similarly, a set of TAs may be grouped as a service area, based on which 5GS may specify and/or enforce service area restrictions for a WTRU. For example, TA7, TA8, and TA9 may form a service area, which 5GS may configure it with a WTRU for service area restriction—the WTRU may be allowed to access 5GS if the WTRU stays with TA7, TA8, or TA9.

FIG. 4 illustrates example procedures 400. It should be appreciated that the WTRU may perform these procedures in a different order, such as performing the seventh procedure before the sixth procedure and/or skipping the fifth procedure. It should also be appreciated that among these procedures, the sixth procedure may be associated with a data plane and one or more (e.g., all) of the other procedures may be associated with a control plane.

Roaming in 5Gs may be provided. Cellular networks may include complex systems with heterogeneous participants. A reliable wireless communication coverage and/or service provisioning may require uninterrupted connectivity between wireless communication components, including radio cells and/or core networks. Due to the high mobility of WTRUs, reliable yet uninterrupted connectivity may remain a challenge. Roaming in wireless communications may alleviate the problems of interrupted connectivity and/or ensures (e.g., full) wireless communication coverage to the subscribers who visited other networks (e.g., roaming WTRUs).

Roaming may extend the coverage of the Home Network (HN) operator, may allow the HN operator's mobile WTRUs to use the network and/or services provided by another network operator, as referred to as a Visited Network (VN). One or more (e.g., two) roaming implementations may be based on the geographical location of the visited and home networks in 3GPP. One roaming implementation may be the national roaming services, where the roaming WTRUs may utilize the network resources of another network operator within the same geographical location of the roaming WTRU's HN. The other roaming implementation may be an international roaming, where the WTRU may exploit the network coverage of a VN visited located in another geographical location of the WTRU's HN.

Roaming models may include a Home-Routed (HR) model and a Local Breakout (LBO) model. Both roaming models (e.g., HR and LBO) may be based on a network function called Security Edge Protection Proxy (SEPP). SEPP may act as a service relay between the VN and/or the HN and/or may provide a secure connection. Alternatively or additionally, this secure connection may hide the complexity of the network topology of both VN and/or HN. Further, an Application Function (AF) in both networks (e.g., HN and VN) may interact with 5GC to provide the required services, such as traffic routing or policy control. AUSF within the HN may be responsible for performing authentication between the WTRU and the 5GC. It is worth noting that, in both models (LBO and HN), the HN may be responsible for authenticating the roaming WTRU and/or verifying the roaming WTRU to the VN. For example, the HN may authenticate the roaming WTRU using one of the authentication mechanisms like the 5G-AKA. During the authentication process, the HN may reveal the permanent identifier (e.g., SUPI) to the VN to assure the authentication and/or verification of the roaming WTRU identity to the VN.

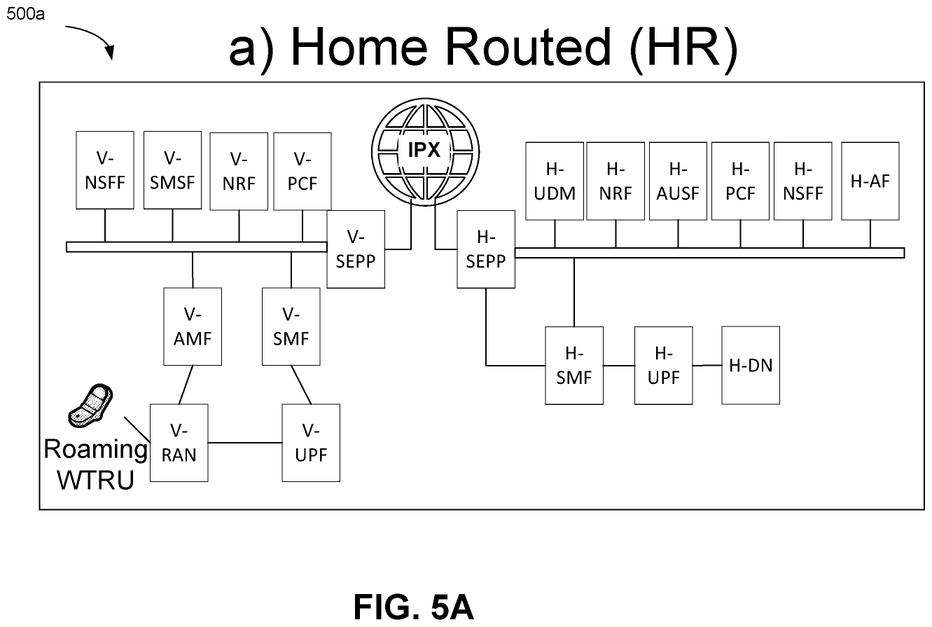

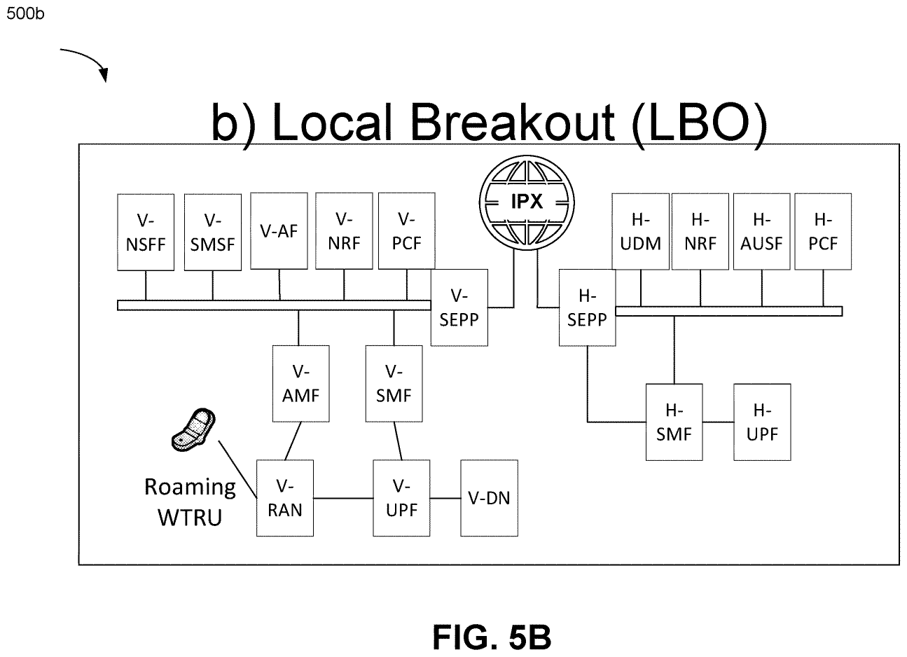

FIG. 5A is a diagram illustrating an example of Home Routed (HR) roaming architecture 500a. FIG. 5B is a diagram illustrating Local Breakout (LBO) roaming architecture 500b. A main difference between HR and LBO may include the way of handling a roaming WTRU's service data plane. In the HR model, the user plane traffic of the roaming WTRU may be served by the HN, thus potentially giving more control over the users' traffic as shown in FIG. 5A. The roaming WTRU may use AMF and/or SMF from the VN, while UPF of the HN may be used to connect the roaming WTRU to a DN. The SMF in the HN may obtain the subscription data directly from UDM. The LBO, as shown in FIG. 5B may depend on the VN to handle the user plane traffic of a roaming WTRU. The HN may be responsible for the authentication and/or handling of subscription data of the roaming WTRU. Considering the basic roaming policy and charging, the VN may apply the visited PCF per its roaming agreements with the HN.

The HR model may incur high latency since user plane traffic may pass through a secure channel (tunnel) from VN to HN managed by SEPPs. The HR model may be recommended when there may be insufficient (e.g., no) trust in the relationship between the two operators. Mobile network operators may switch to the LBO model to alleviate the load from the HN to the VN. Using the LBO model, control plane signaling data may be routed to the HN, which may allow more efficient data plane routing in terms of latency, although the HN may lose data plane control over its subscribers. Under the LBO model, the IP address of the roaming WTRU may be obtained from the VN. Therefore, the roaming WTRU may use a radio bearer and/or 5GC resource(s) of the VN. LBO may be considered the best architecture option for better service, less delay, and/or less overhead. However, intermediaries may be required to handle the billing settlements between independent mobile operators, thus potentially raising concerns regarding security, trust, and/or complexity. It is important to note that the terms WTRU and roaming WTRU may be used interchangeably unless otherwise explicitly specified. Described herein are some existing HR roaming architecture limitations.

HR roaming architecture limitations on the control plane may include the HN participating in the process of authenticating the roaming WTRU, which may lead to several potential limitations such as: 1) extra delay to the authentication process due to the HN involvement; 2) extra overhead to the HN to process authentication-related messages; 3) the risk of leaking the roaming WTRU's identity when the HN may send the roaming WTRU's permanent identifier (e.g., SUPI) to the VN; and/or 4) the HN becoming the single point of feature and/or the roaming WTRU may be able to access the VN if the HN becomes congested, inaccessible, etc.

HR roaming architecture limitations on the data plane may include the HN needing to route and/or manage the traffic from/to the roaming WTRU. This may cause some limitations such as: 1) extra delay to data plane packet transmission; 2) extra security protection between the HN and the VN; 3) extra transmission overhead between the HN and the VN; and/or 4) extra energy consumption due to the home-routed transmission.

Described herein are some existing LBO roaming architecture limitations. LBO roaming architecture limitations may include, the HN participating in the process of authenticating the roaming WTRU on the control plane, which may lead to several potential limitations such as: 1) extra delay to the authentication process due to the HN involvement; 2) extra overhead to the HN to process authentication-related messages; 3) the risk of leaking the roaming WTRU's identity when the HN sends the roaming WTRU's permanent identifier (e.g., SUPI) to the VN; and/or 4) the HN becoming the single point of failure and/or the roaming WTRU may sometimes not be able to (e.g. never) access the VN if the HN becomes congested, inaccessible, etc.

Limitations affiliated with both HR model and LBO model may be provided. Both HR model and LBO model may include the HN, which may be a network-centric architecture design. One limitation is that the HN may be able to track the roaming WTRU's new location and/or the roaming WTRU's privacy may not be protected.

Alternatively or additionally, both models may assume there is a trust between the HN and the VN. However, there may be no immutability guarantee for roaming records, which may cause problems in clearing and/or settlement between the HN and the VN.

Alternatively or additionally, both models may assume the roaming WTRU may have a subscription with the HN. However, in future wireless systems, the roaming WTRU may not have any traditional subscription with any mobile operator. In other words, from the roaming WTRU's perspective, the WTRU may not have any HN, but may select and/or access any available mobile networks based on its needs.

Alternatively or additionally, the VN services that a roaming WTRU may consume may depend on the HN, and/or the roaming WTRU may not have freedom to decide what VN services it wants to use.

Alternatively or additionally, both models may not support trustworthy dynamic pricing and/or QoS negotiation between the roaming WTRU and the HN/VN. For example, the QoS control may still be based on the roaming agreement between the HN and the VN and may not be a user-centric QoS control. For example, roaming solutions may depend on the HN to set the Service Level Agreement (SLA) that the roaming WTRU may have on the VN; if the roaming WTRU may want, and may be willing to pay for, a higher SLA with the VN, the roaming WTRU may not do so.

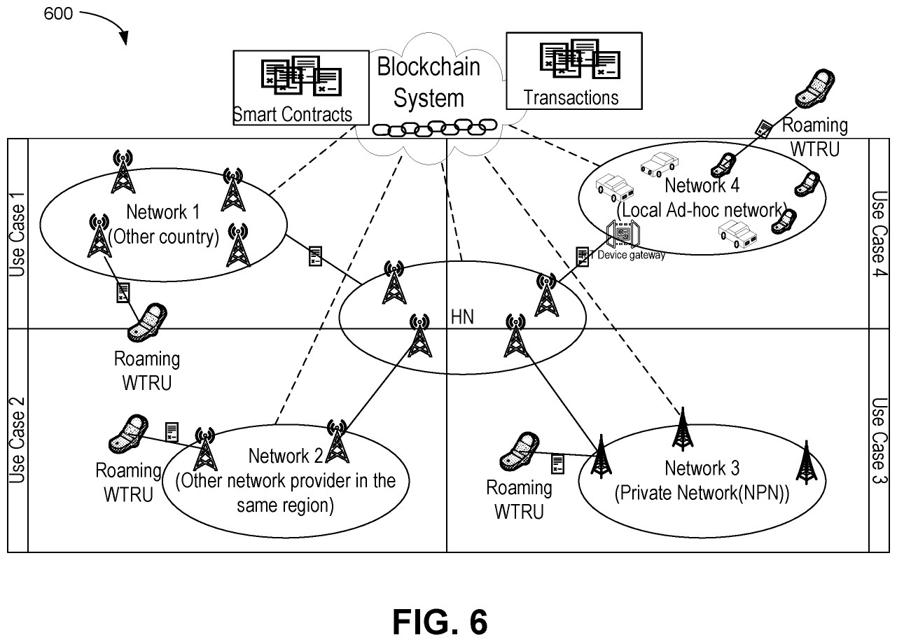

FIG. 6 is a diagram illustrating an example diagram 600 of different use cases for decentralized roaming services. Roaming in 5G may extend the coverage of a network operator, and/or enhances the network QoS, network reliability, and/or users' satisfaction. Roaming in 5G may be viewed within various cases, as shown in FIG. 6. For example, the roaming WTRU may be roaming internationally (as illustrated in Use Case 1), e.g., visited another country different and away from the HN coverage. For example, assume Bob (e.g., the roaming WTRU) be a subscriber to a specific HN in the US (e.g., AT&T). Bob decided to visit Toronto in Canada the next month. While Bob is planning for such a visit, he may select the appropriate international roaming plan on the AT&T user portal based on his travel plan, e.g., how long he will stay in Canada during this trip.

Another roaming scenario is national roaming within the same geographical location of the roaming WTRU's HN (as illustrated in Use Case 2). In this case, the HN and the VN may collaborate to support each other and/or share their resources to potentially guarantee better network coverage or have the VN as the backup when the HN may become inaccessible. For example, Rogers may have leveraged a VN to serve its customers when its network outage happened in July 2022. Moreover, the VN may enhance the HN coverage in certain locations or spots, where the VN radio signals may be better. As an example, assume Alice be a resident in Virginia, where AT&T has the best coverage, that Alice needed to travel to Florida and stay there for one month for her job, and that the coverage of T-Mobile in Florida is better than the coverage of AT&T. Assume further that there is an agreement between AT&T and T-Mobile to support each other and enhance the network coverage of their subscribers. Consequently, when Alice re-located to Florida, she may have initiated a seamless connection with T-Mobile as a national roaming subscriber given the agreement between AT&T and T-Mobile, and as per Alice's request to potentially exploit the available national roaming services.

Alternatively or additionally, roaming services may include services and/or network coverage obtained from an established private 5G network like 5G-enabled Non-Public Networks (NPN) (as illustrated in Use Case 3). A private 5G network may be exclusively dedicated to a particular business or organization and/or the private 5G network may include private cell sites and private core network servers, which may eliminate reliance on public cellular networks. When the roaming WTRU may enter the coverage of the private network, the roaming WTRU may request to utilize the private network resource(s) to have a better QoS and/or network coverage. As an example, assume a top-tier company like Google has created a new data center on the Caribbean Island. Consequently, to communicate with the employees in the scope of the data center project, Google established a local private 5G network. A few months later, Google hosted a conference on the Caribbean Island to announce the new technology exploited in this project. Kate was one of the visitors who was invited to attend Google's event. To ensure good coverage and/or better QoS on the Caribbean Island, Kate requested from her HN to enable roaming services with the private network provided by Google on the Caribbean Island.

Alternatively or additionally, roaming services may be witnessed through accessing an already established ad-hoc network (e.g., as illustrated in Use Case 4). Ad-hoc networks may be viewed as small-scale local area networks managed by cooperating network subscribers (e.g., WTRUs, IoT nodes, Vehicles) to provide services, data transfer, and/or local network coverage to at least each other. Managed by the core network, a group of the edge nodes and/or network subscribers who are joining such an ad-hoc network may be delegated to manage the control plane of the ad-hoc network without overwhelming the HN. In this case, the roaming WTRU may be another network subscriber who is nearby the already established ad-hoc network.

The roaming WTRU may be assumed to have limited connectivity to the HN, which is enough for him to obtain some information about the nearby ad-hoc network. Thus, one way to get moderated connectivity may be to join the nearby ad-hoc network. For example, in an emergency situation, where a massive hurricane occurred in Miami, Florida, the network coverage may become very limited and one or more (e.g. most) of the network base stations may become unavailable. In this situation, a limited amount (e.g., only a few) IoT gateways and/or subscribing WTRUs may still have good connectivity to the HN, by which they (gateways and/or WTRUs) may be delegated to establish an emergency ad-hoc network. The established ad-hoc network may be used to guarantee good coverage to one or more other network subscribers, who are in limited network coverage. Sam may have very limited connectivity to his HN, but he may be able to discover the established ad-hoc network near his location. At this point, Sam decided to join the ad-hoc network and/or utilize the provided connectivity. Given this situation, Sam requested to join the nearby ad-hoc network as a roaming WTRU and may be able to enjoy enough network coverage to survive.

The roaming implementations may require the HN to manage one or more (e.g., all) of the related information and/or even the requirements of the roaming WTRU. These roaming models restrict the roaming WTRU's ability to determine the roaming quality of service, billing criteria, and/or other network services since the HN is controlling the WTRU's activities within the VN (for example in case of HR). In other words, the roaming solution may be a network-centric design, not a WTRU-centric design.

With roaming modes, when the HN may become unreachable (e.g., Rogers network outage in July 2022), the roaming WTRU may not be able to get services from the VN. Similarly, the non-roaming WTRU of the HN may not be able to switch to use other networks when the HN becomes unavailable. There may be a problem as to how the roaming WTRU may still access the VN when the HN becomes unreachable.

The roaming models may require a lot of interactions between the visited VN and HN operators to 1) authenticate the roaming WTRU, 2) manage the activities of the roaming WTRU, 3) control the WTRU billing and/or charging settlements, and/or 4) guarantee the service continuity and/or reasonable networking coverage to the roaming. To handle the WTRU roaming process, both the VN and/or HN may need to exchange multiple records and/or information about the roaming WTRU, which may introduce massive communication overhead, delays, and/or extensive security protections.

Some embodiments may include a WTRU-centric roaming solution that may enable more flexibility and/or controllability to the roaming WTRU while potentially exploiting the VN resources. The WTRU-centric solution may provide the roaming WTRU the ability and/or more freedom to control and/or manage the roaming-related decision, data, authentication, and/or agreements, according to the WTRU's desired QoS from the VN, potentially without any interactions or interventions from the roaming WTRU's HN. One proposed WTRU-centric solution may leverage blockchain to potentially guarantee mutual trust between the interacting entities (e.g., in this case, the roaming WTRU and/or the VN). To ensure mutual trust, the roaming WTRU may authenticate the VN before being attached to the VN, in addition the VN may authenticate the roaming WTRU before accepting to provide roaming services to the roaming WTRU.

Described herein are two methods to potentially achieve mutual authentications. One mutual authentication scheme may depend on simple assumptions that the roaming WTRU may authenticate the VN through digital signature verifications, while the main focus may be to authenticate the roaming WTRU using an issued proof issued by the HN. Alternatively or additionally, an enhancement to the introduced mutual authentication and/or to increase the level of security, a dual authentication mechanism may be introduced. The dual authentication mechanism may include a VN and/or a roaming WTRU, where both the VN and/or roaming WTRU may authenticate each other through 1) digital signatures and/or 2) issued proofs from a trusted authority or from the HN. It is important to note that the requirements and preparation procedures to enable WTRU-centric roaming are described herein. It is also important to note that the needed interactions between the roaming WTRU and/or the VN to authenticate each other, potentially without requiring any interactions from the HN side, is described herein.

Some embodiments may include reducing the load from the HN by adopting a decentralized blockchain-enabled WTRU-centric roaming solution, which may alleviate at least some (e.g., massive) communication overhead and/or delays that may be required to manage WTRU activities during roaming. Blockchain technology may be used to append at least some (e.g., all) of the public data (e.g., roaming agreements, WTRU authentication public parameters, VN authentication public parameters, charging policies, etc.,) in blockchain or distributed ledgers managed by multiple entities (e.g., multiple network operators). Thus, since those key parameters or information stored in blockchain may be immutable, transparent, and/or available to various NFs in the VN, one or more (e.g., all) the necessary network operations may then be directly conducted by the VN and may not need to interact with NFs in the HN anymore. As a result, adopting blockchain-based roaming services may reduce the needed communication and/or delay to manage the WTRU roaming request between the HN and VN. Alternatively or additionally, enabling a WTRU-centric roaming solution may also overcome or mitigate at least some (e.g., massive) communication interactions needed between VN and HN to potentially authenticate the WTRU to the VN.

A decentralized WTRU-centric roaming solution may be provided, for example, to alleviate the resource overwhelming and/or reduce HN interactions with the VN to manage the roaming services and/or the authentication process of the roaming WTRU. WTRU-centric may be defined as the ability of the WTRU to control roaming service, VN selection, and/or billing settlement options. Alternatively or additionally the WTRU may receive a temporary identifier (WTRU−Proof) from the HN. The received WTRU−Proof may be used to introduce a flexible WTRU-centric authentication scheme, for example, to verify the WTRU identity to the VN without any assistance from the HN.

To achieve a decentralized WTRU-centric roaming model, a blockchain network may be utilized as a decentralized infrastructure to maintain and/or manage any public/permissioned information about the interacting entities (e.g., the HN, the VN, and/or the roaming WTRU) during the roaming process. For example, blockchain may store transactions including some agreements between the HN and the VN, which may indicate possible services provided by VN, charging cost per service, and/or public key credentials that may be used to authenticate the VN. Further, the blockchain ledger may hold public transactions between roaming WTRU and the HN that may show a method to the VNs how to verify and/or authenticate a roaming WTRU, for example, without requesting any information from the HN. Consequently, both the VN and the HN may provide the roaming services without overwhelming the communication resources and/or without facing too much delay (e.g., delay greater than a predefined threshold).

Exploiting the blockchain system (e.g., consortium blockchain distributed ledger system, private blockchain and/or distributed ledger system) to host or store public information (e.g. all the public information), as well as any needed information to authenticate the roaming WTRU may help alleviate the ineffective and/or expensive interactions between the HN and the VN to manage the roaming services because any information stored in the blockchain system may be transparent, immutable and/or non-repudiable. As a result, blockchain may be a good candidate to provide third-party services. In other words, blockchain may be treated as a trusted system to hold the public needed parameters to manage roaming services (e.g., authentication, service request, billing settlement, etc.) without requiring additional interactions from one or more (e.g. all) of the system entities (e.g. WTRU, HN, and/or VN at the same time).

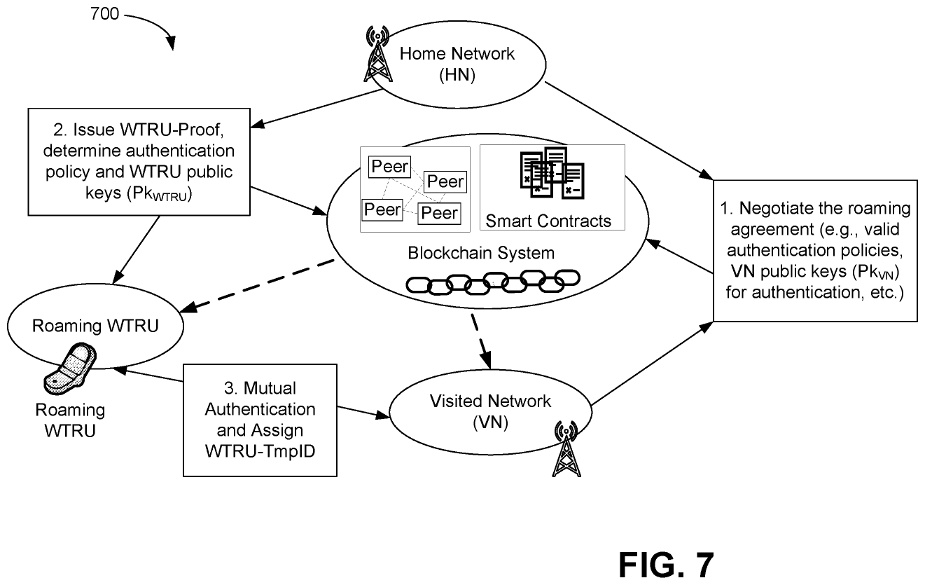

FIG. 7 is a diagram 700 illustrating an example of an overview of the decentralized Wireless Transmit/Receive Unit (WTRU)-centric Roaming model that may be provided. As shown in FIG. 7, the proposed decentralized WTRU-centric roaming scenario may include one or more (e.g., three) stages. A decentralized WTRU-centric roaming scenario may be based on direct interaction between the HN and the VN to negotiate and/or publish a blockchain transaction (e.g., VN−Roaming−Key−Repo) showing the requirements for the VN to handle the roaming requests, for example, without requesting any help from the HN. VN−Roaming−Key−Repo may be a kind of public repository in form of blockchain smart contracts used to maintain parameters, such as, but not limited to: Public Key of the VN; the agreement with the HN; and other authentication-related public parameters.

The decentralized WTRU-centric roaming scenario may be based on direct interaction between the HN and the roaming WTRUs to issue the WTRU−Proof that helps in authenticating and/or verifying the roaming WTRUs to the VN, for example, without interaction from the HN side. A third component may include the roaming services in a decentralized and/or WTRU-centric way. The decentralized WTRU-centric roaming scenario may include the roaming WTRU interacting with the VN to handle the roaming services and/or the WTRU authentication, for example, without any interactions from the HN side. Both the roaming WTRU and the VN may mutually authenticate each other and/or determine the service requirements (e.g., subscription requirements, billing criteria, the time of visit, etc.) to achieve a decentralized and/or trusted roaming service provisioning.

The decentralized WTRU-centric roaming scenario may reduce the load from the HN and/or the VN, which may alleviate at least some (e.g., massive) communication overhead and/or delays required to manage WTRU activities during roaming. Blockchain technology may be used to append one or more (e.g., all) of the public data (e.g., roaming agreements, WTRU authentication public parameters, VN authentication public parameters, charging policies, etc.,) in blockchain ledgers in comparison to the traditional roaming models, where managing one or more (e.g., all) of these processes may be needed one or more (e.g., every) time the roaming WTRU may need to attach itself to the VN.

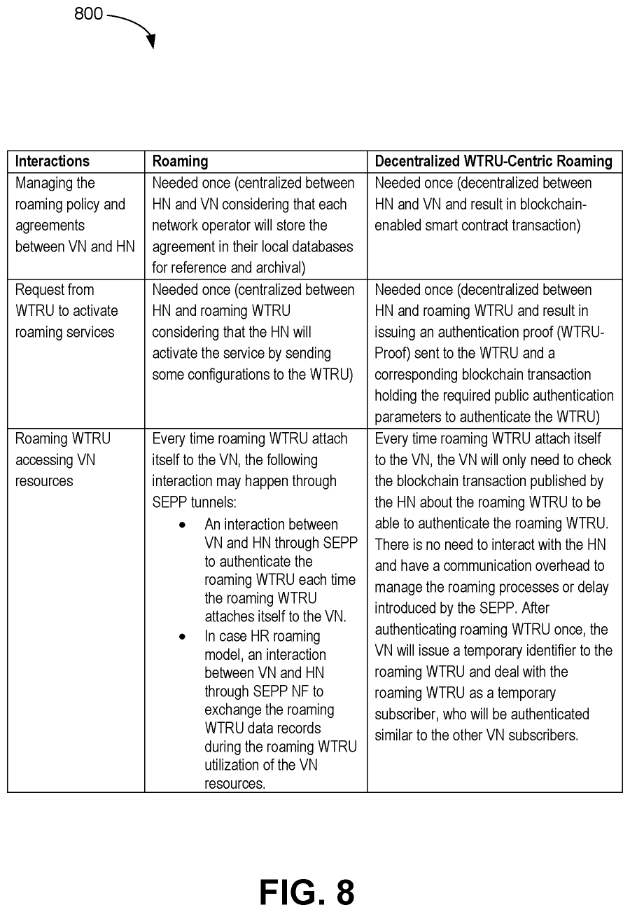

FIG. 8 illustrates an example comparison 800 between the needed interactions between the VN, HN, and roaming WTRU during the management of roaming requests.

As a result, adopting blockchain-based roaming services may reduce the needed communication and/or delay to manage the WTRU roaming request between the HN and VN. Alternatively or additionally, enabling a WTRU-centric roaming solution may also overcome or mitigate the massive communication interactions needed between the VN and the HN in order to authenticate the WTRU to the VN.

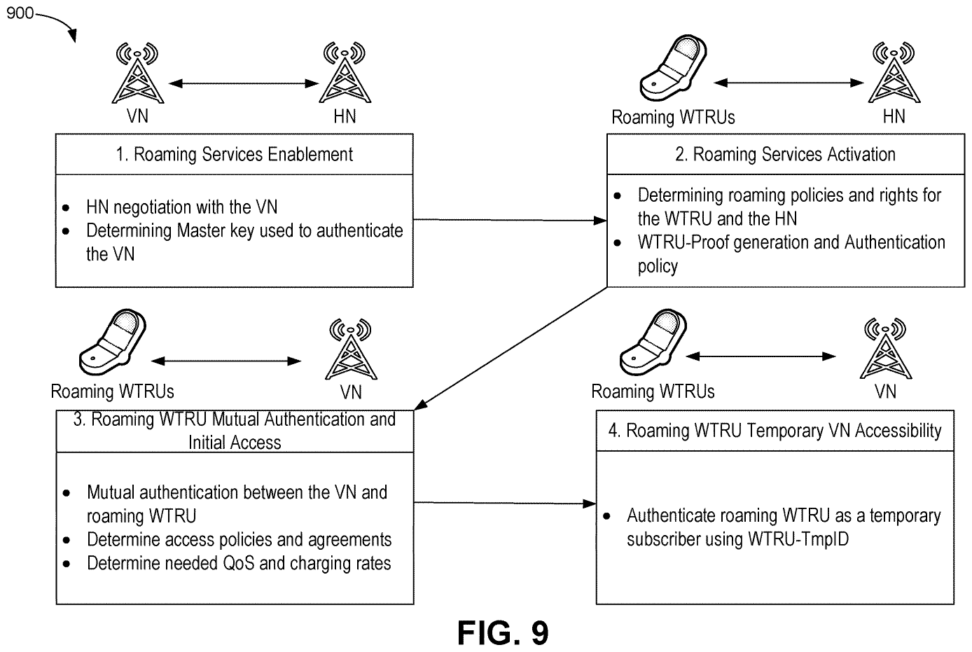

FIG. 9 illustrates example procedures 900 to realize user-centric decentralized roaming services. A decentralized WTRU-centric roaming solution may be proposed herein. The roaming WTRU may control (e.g., fully control) its roaming services and/or data management to achieve the best network service and/or requirements. One solution may utilize one or more (e.g., four) procedures (e.g., main procedures), which include 1) Roaming Service Enablement, 2) Roaming Service Activation, 3) Roaming WTRU Mutual Authentication and Initial Access, and/or 4) Roaming WTRU Temporary VN Accessibility. As shown in FIG. 9, each of the proposed procedures may achieve a step toward the decentralized WTRU-centric roaming and/or may pave the way for a subsequent procedure.

A WTRU-centric model may include the HN and and/or VN setting a decentralized agreement showing the regulations and/or policies that may be applied to the roaming WTRUs upon requesting the roaming service (e.g., connecting the WTRU to the VN to potentially use its resources and/or network services). The decentralized agreement between the HN and the VN (e.g., Roaming Service Enablement) is described herein. In Roaming Service Enablement, the VN and HN may cooperate to determine roaming service agreements to be published as a blockchain transaction denoted as “VN−Roaming−Key−Repo”. Alternatively or additionally, the VN may generate its own authentication credentials such that the roaming WTRU may acquire such authentication parameters to authenticate the VN before accessing the VN resources. The generated authentication parameters representing the VN may be published as a part of the VN−Roaming−Key−Repo transaction obtained between the VN and the HN.

In this second procedure (Roaming Service Activation), the HN issues the roaming WTRU an identity proof (e.g., WTRU−Proof) that will be used to identify the roaming WTRU to the VN and authenticate the roaming WTRU to the VN without the need for any interaction from the HN. Then, a blockchain transaction will be generated for the roaming WTRU, which includes the details about the WTRU−Proof issued for roaming WTRU. After the WTRU receives the WTRU−Proof from the HN, the roaming WTRU can exploit such a WTRU−Proof to authenticate itself to the VN, which is the detail explained in the third procedure (“Roaming WTRU Mutual Authentication and Initial Access”). When the roaming WTRU may authenticate itself to the VN, the roaming WTRU may use one of two proposed authentication policies, which may include either an Rivest-Shamir-Adleman (RSA) based authentication policy or a CH-based authentication policy. The roaming WTRU may authenticate itself to the VN using the issued WTRU−Proof, and may negotiate with the VN about the VN resources accessibility, required services, and/or charging policies.

After the WTRU negotiates with the VN about the WTRU Mutual Authentication and Initial Access, the VN may provide the roaming WTRU with temporary registration access (WTRU−TmpID), which may be used in the future to authenticate the roaming WTRU to the VN in a potentially more efficient way, which may ease the roaming WTRU authentication and/or accessibility to the VN resources without repeating the whole process explained in the Roaming WTRU Mutual Authentication and Initial Access procedure. The roaming WTRU Temporary VN Accessibility is the way the roaming WTRU may use the WTRU−TmpID to authenticate itself (WTRU) to the VN, which serves the same purpose of but may be more efficient than “WTRU Mutual Authentication and Initial Access”.

The HN may not be completely removed away in the proposed user-centric decentralized roaming. For example, the HN may interact with the VN in the procedure of roaming service enablement to negotiate roaming service with the VN. Alternatively or additionally, during the procedure of roaming service activation, the HN may determine roaming policies for the roaming WTRU. The involvement of the HN may be kept at a low level to reduce extra roaming delay and/or overhead. In other words, the HN may not participate in mutual authentication and/or initial access, which may only take place directly between the roaming WTRU and the VN in a decentralized way.

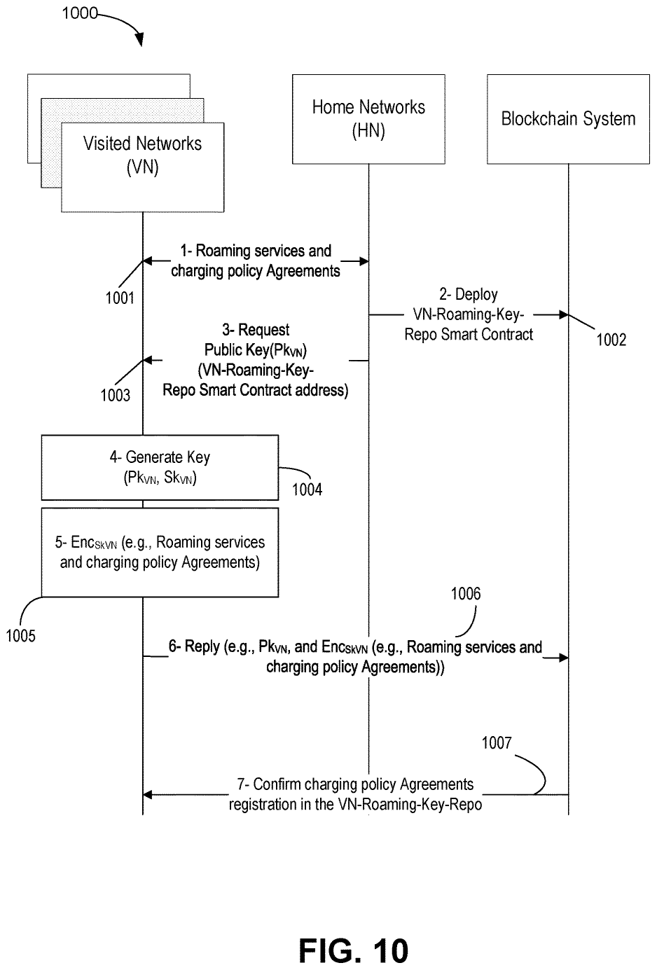

FIG. 10 depicts an example roaming service enablement procedure 1000. The HN may negotiate and/or interact with the VNs to determine roaming service general regulations and/or to announce the VN public key credentials that may be used by the WTRU to authenticate the VN to any potential roaming WTRU. As shown in FIG. 10, the roaming service enablement may include a decentralized agreement between the HN and the VNs published as a public transaction in the blockchain system. The following procedures, as depicted in FIG. 10, may be included in the embodiments affiliated with roaming service enablement.

The VN and the HN may exchange the potential roaming agreements, policies, and/or roaming service enablement criteria at 1001, for example, to standardize the provided roaming services by the VN to the potential roaming WTRUs, who are subscribed to the HN. For example, the roaming agreements can indicate that the roaming WTRUs may be authenticated by a predetermined authentication policy, and the minimum QoS the VN should provide to the roaming WTRU (e.g., the home subscribers), the minimum charging policy, the premium charging policy, etc. Such an agreement between the VN and HN may be denoted as a Roaming service and/or charging policy agreement.

Once the HN receives a confirmation from the VN about the Roaming service and/or charging policy agreement, the HN may deploy a VN−Roaming−Key−Repo smart contract at 1002. The VN−Roaming−Key−Repo smart contract may be included in a public or permissioned transaction that may document the Roaming service and/or charging policy agreement with the VN. Public transactions may refer to transactions that may be accessed by anyone anytime. Permissioned transactions may require the permissions from the HN and/or VN for certain entities (e.g., roaming WTRU) to access the content of these VN−Roaming−Key−Repo smart contract transactions. According to the agreement between the VN and the HN, the accessibility policy to the VN−Roaming−Key−Repo smart contract may be determined (public/permissioned). For example, the VN and HN may agree that the content of the VN−Roaming−Key−Repo may be accessed by the roaming WTRU who requested roaming services activations from the HN.

Once the HN finishes deploying the VN−Roaming−Key−Repo smart contract, the HN may request the VN to generate a PKI key pair at 1003. Alternatively or additionally, the HN may notify the VN with the VN−Roaming−Key−Repo smart contract address, where the VN may publish the generated public key credentials to the blockchain system in form of a smart contract (e.g., included in the VN−Roaming−Key−Repo smart contract). The generated PKI key pair (especially the public key credentials) of the VN may be used by any roaming WTRU: 1) to authenticate the VN before the roaming WTRU attaches to it (e.g. the VN); and/or 2) to verify any digital signatures provided by the VN during the interaction with the roaming WTRU.

The VN may generate the PKI key pair at 1004. One PKI key may be the private key (Sk_{VN}), which may be a secret key that no one should know except the VN. The other corresponding key may be the public key (Pk_{VN}) that may reverse any operations obtained by its corresponding private key (Sk_{VN}). The VN private key (Sk_{VN}) may be used by the VN to digitally sign any information provided by the VN, and decrypt any data encrypted by the corresponding public key (Pk_{VN}). In other words, the VN−generated public key may verify any information digital signatures obtained by the (Sk_{VN}) or encrypt any data that no one should know except the VN, whenever the VN governed private key (Sk_{VN}) may be used.

Once the VN finishes the generation of the PKI key pair, the VN may digitally sign the roaming service and/or charging policy agreement to confirm that the VN agrees to the terms and/or conditions mentioned in the roaming service and/or charging policy agreement at 1005.

The VN may then invoke the VN−Roaming−Key−Repo smart contract to publish its public key (Pk_{VN}) in the blockchain system at 1006. Alternatively or additionally, the VN may digitally sign the Roaming service and/or charging policy agreement using VN private key (Sk_{VN}). Alternatively or additionally, the HN may digitally sign the VN−Roaming−Key−Repo using the HN's private key (Sk_{HN}) and publish the signed agreement in the VN−Roaming−Key−Repo smart contract.

Once the blockchain system validates the VN−Roaming−Key−Repo smart contract, a confirmation may be sent to both the VN and/or the HN such that the transactions are validated at 1007.

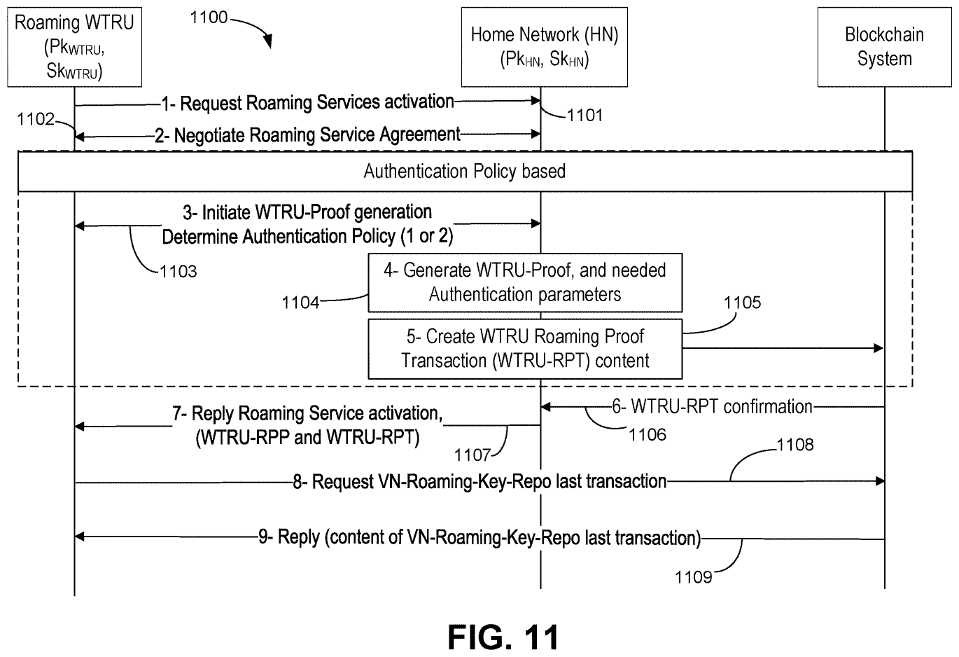

FIG. 11 depicts an example roaming services activation 1100. When a WTRU may decide to leave the perimeter of HN coverage, the WTRU may request a roaming service activation from the HN at 1101. The roaming service activation may include the HN generating a temporary decentralized proof (WTRU−Proof) to the roaming WTRU; the HN may publish a blockchain transaction about the public authentication parameters representing the issued WTRU−Proof, such that the VN may use this transaction to authenticate the roaming WTRU potentially without asking any interaction from the HN; and/or the roaming WTRU may obtain a copy of the blockchain transaction “VN−Roaming−Key−Repo” that may include the required public information about the VN.

This procedure may be taken place in, but not limited to the following scenarios. This procedure may take place before the roaming WTRU may move to the VN, the roaming WTRU may initiate to perform this procedure. Alternatively or additionally, this procedure may take place before the roaming WTRU moves to the VN, the HN may instruct/inform the roaming WTRU (e.g., via WTRU Configuration Update Command) to perform this procedure.

Alternatively or additionally, this procedure may take place after the roaming WTRU may move to a place out of the coverage of the HN, the roaming WTRU may use non-cellular connectivity (e.g., Wi-Fi, Internet) to access to the HN to perform this procedure.

Alternatively or additionally, this procedure may take place after the roaming WTRU may move to a place out of the coverage of the HN, the VN may allow the roaming WTRU to use the VN's network to access to the HN to perform this procedure. Described herein is an example of a proposed solution to handle the roaming service activation procedure, as shown in FIG. 11,

In some embodiments, the roaming WTRU may send a request to the HN to activate the roaming services. This request may include the following parameters: WTRU-ID, WTRU−Proof-Lifetime, Authentication Policy, WTRU-Location, and/or Request-Type.

WTRU-ID may denote the identifier of the WTRU (e.g., the SUCI of the WTRU, a decentralized identifier of the WTRU, a blockchain address of the WTRU, and/or the public key of the WTRU). WTRU−Proof-Lifetime may denote the requested lifetime for the WTRU proof to be generated by the HN. Authentication-Policy may denote the authentication policy(ies) that the WTRU may support and/or prefers (e.g., RSA-based, CH-based). WTRU-Location may denote the current location of the WTRU. This parameter may not be needed if the WTRU may have enabled location-based services and/or the HN may (e.g., always) know the location of the WTRU. Request-Type may indicate the type of this request (e.g., a request for activating roaming services).

Once the HN receives the roaming WTRU request for roaming services activation, the HN may start negotiating the roaming services agreements at 1102. For example, the roaming services agreements may include the cost and/or charges the roaming WTRU may pay for the HN for issuing the roaming WTRU proof (WTRU−Proof), time of the WTRU−Proof expiration if exist, the possibilities of using the WTRU−Proof once or multiple times, etc.

Once the roaming WTRU and the HN reaches a roaming service activation agreement, the HN may initiate a session to issue the WTRU−Proof for the roaming WTRU at 1103. The WTRU−Proof may be used to authenticate the roaming WTRU and may verify the roaming WTRU subscription status to the VN without revealing any information about the WTRU identity and potentially without the need for any interactions with the HN side. The way the WTRU−Proof may be issued may include the authentication policy that may be determined by the WTRU and the HN, as depicted in FIG. 11.

In FIG. 11, a general authentication policy model is depicted to express at a high-level the basic interactions required between the HN and the roaming WTRU to issue the WTRU−Proof. Consequently, the HN and roaming WTRU may negotiate to determine the authentication policy that fits the WTRU capabilities. For example, the WTRU may be optimized to execute certain cryptographic methods like CH or RSA in an efficient way without consuming too much computational power. Another example may include the capabilities of the WTRU to store more parameters and multiple private keys (e.g., CH trapdoor key and RSA private key) to be used for different requirements.

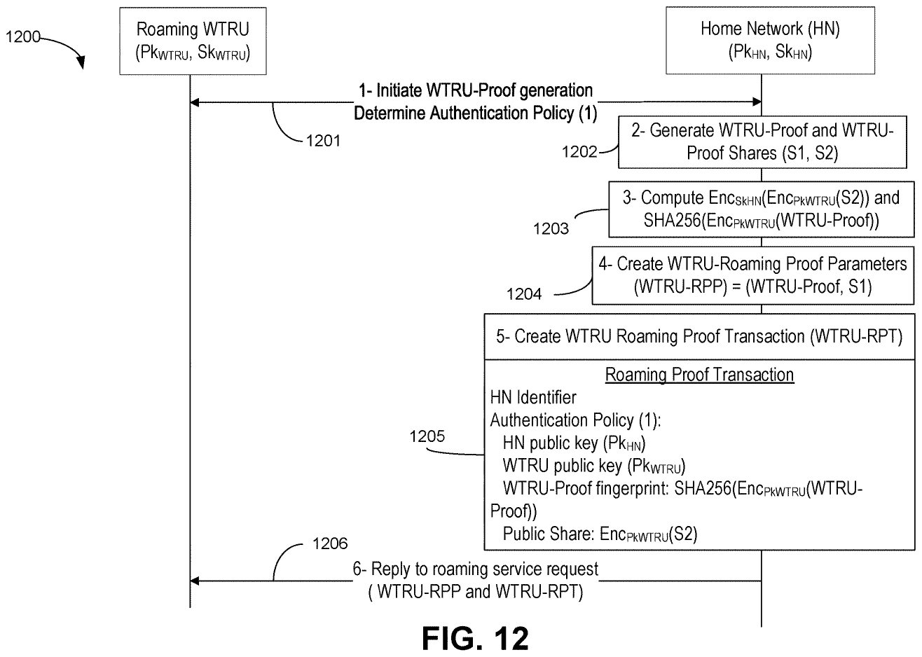

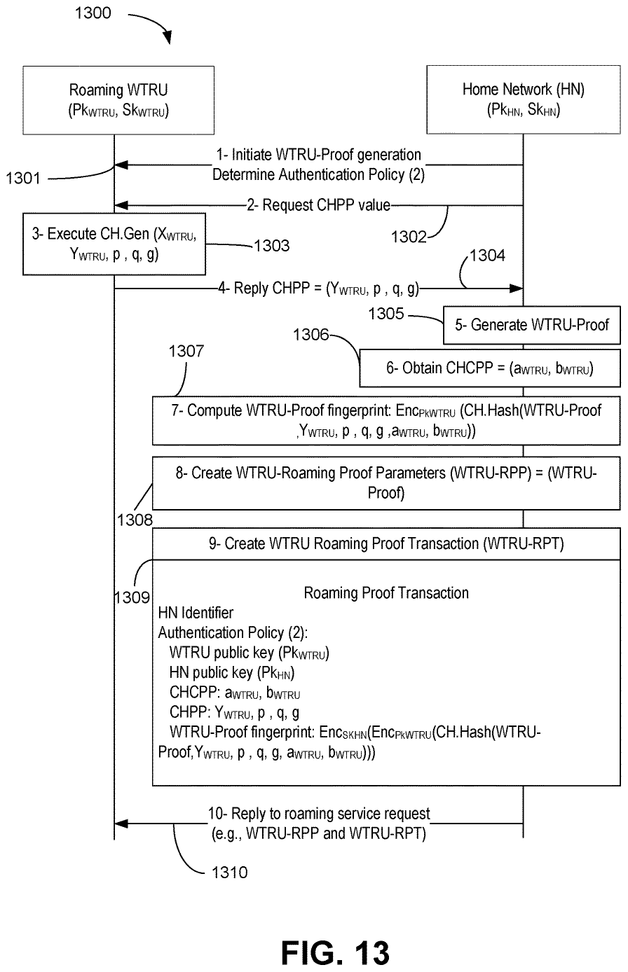

Two authentication policies may be proposed (e.g., authentication policy 1 and/or authentication policy 2). One authentication policy (authentication policy 1) may include a RSA homomorphic operations to manage the roaming WTRU authentication, while the other authentication policy (authentication policy 2) may include the CH functions to authenticate the roaming WTRU to the VN. Each of the proposed authentication policies may have the same goal, which is authenticating the roaming WTRU without revealing the roaming WTRU identity or any relatable information. The details of the mechanism of authentication policy 1 and/or authentication policy 2 are depicted in FIG. 12 and FIG. 13.

Once the roaming WTRU and the HN determine the best authentication policy that fits the roaming WTRU capabilities, the HN may start generating the WTRU−Proof and the needed authentication parameters to verify the WTRU−Proof given the selected authentication at 1104. The generated authentication parameters may be determined based on the selected authentication policy determined by the HN and/or the roaming WTRU.

Once the WTRU−Proof parameters are generated, the HN may then create a WTRU Roaming Proof Transaction (WTRU−RPT) at 1105. The HN may publish the WTRU−RPT in the blockchain ledger (e.g., the content of the WTRU−RPT may be determined according to the adopted authentication-based policy as shown in FIG. 12 and FIG. 13, respectively). The WTRU−RPT content may include the used public key for the roaming WTRU (Pk_{WTRU}), the determined authentication policy for the roaming WTRU, the computed authentication parameters for the determined authentication policy, the HN identifier, and/or any other related information to ease the roaming WTRU authentication process. After creating the WTRU−RPT content, the HN may broadcast such a WTRU−RPT content as a blockchain transaction in the blockchain system).

Once the blockchain system validates the WTRU−RPT, a confirmation with the WTRU−RPT address (or the sequence number of the transaction, or the sequence number of the block including the transaction) may be sent to the HN at 1106.

After successfully generating the WTRU−Proof, the HN may send the WTRU a response for the roaming service activation request 1 at 1107. The response may include the WTRU−RPT address in the blockchain network, the computed authentication parameters (e.g., WTRU Roaming Proof Parameters (WTRU−RPP)), and/or the generated WTRU−Proof value, as shown in FIG. 12 and FIG. 13.

Once the WTRU receives the WTRU−RPP and the WTRU−RPT, the roaming WTRU may then send a request in 1108 to the blockchain system to check the VN−Roaming−Key−Repo smart contract obtained by the HN and the VN at 1007 of FIG. 10. The roaming WTRU may invoke the VN−Roaming−Key−Repo smart contract from the blockchain to get the needed information about the VN and/or the public keys of the VN to verify and/or authenticate the VN. The extracted information from the VN−Roaming−Key−Repo may be stored locally with the roaming UE, such that the roaming WTRU may use the extracted information from the VN−Roaming−Key−Repo to authenticate the VN during the roaming mutual authentication and/or initial access stage.

Once the blockchain system (e.g., a blockchain node) receives the request sent by the roaming WTRU to acquire the VN−Roaming−Key−Repo, the blockchain system may get the VN−Roaming−Key−Repo transaction from the blockchain ledger. At 1109, the blockchain system may send a response to the WTRU with the content of the VN−Roaming−Key−Repo transaction.

Described herein are roaming WTRU Mutual Authentication and Initial Access embodiments. The roaming WTRU may be assumed to have already received the WTRU−Proof from the HN. The WTRU−Proof may have a similar representation as the SUPI identifier. However, the WTRU−Proof may not be a private permeant identifier, like SUPI. In other words, the WTRU−Proof may be represented as a string of 15 decimal digits like the SUPI value as determined by the 3GPP specifications. One or more of the first few (e.g., the first two or three) digits may represent the Mobile Network Code for the VN (VN−MNC) while the next two or three digits may form the Mobile Network Code of the HN (HN−MNC). The remaining (e.g., nine or eleven) digits may represent the Temporary Roaming-Mobile Subscriber Identification Number (TR-MSIN). The exact value of the WTRU−Proof may be known only for the roaming WTRU and the HN.

The VN may not have any accessibility to the WTRU−Proof. The VN may verify and authenticate the roaming WTRU in an anonymous way without revealing the WTRU−Proof value. In case the roaming WTRU misused the VN resources or did not follow the VN regulations and policy, the VN may contact the HN to check the record of the roaming WTRU. The VN may identify the roaming WTRU to the HN through the WTRU−RPT created by the HN. The HN may identify the roaming WTRU from the generated WTRU−Proof, which may be known by the HN.

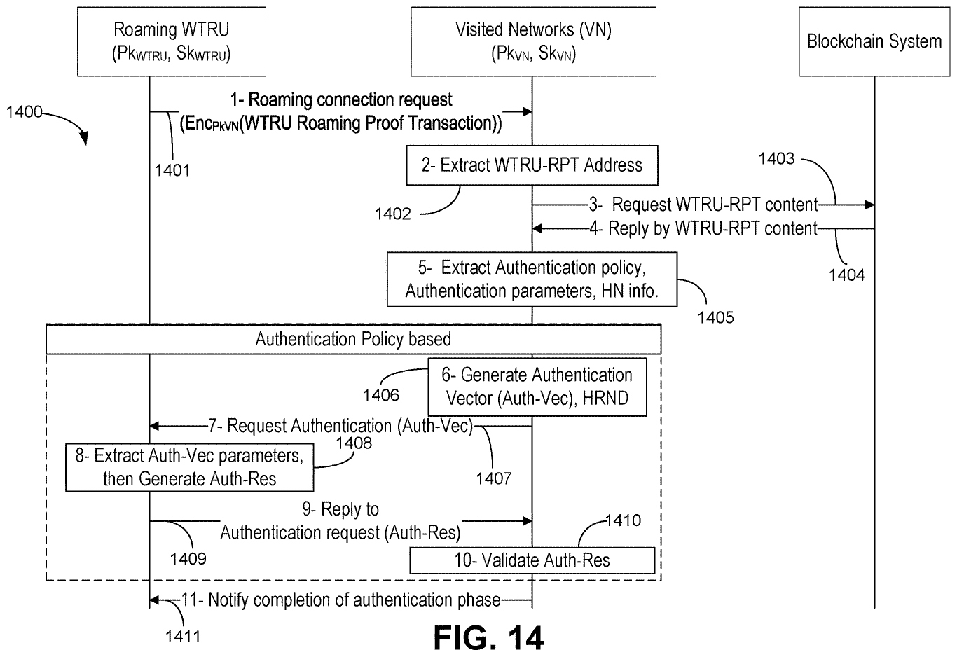

The WTRU−Proof may be a secret identifier or a random number the HN issued to the roaming WTRU, for example, as shown in FIG. 11. The WTRU−Proof value may be known only by the roaming WTRU and the HN. The WTRU−Proof may be used anonymously to authenticate the roaming WTRU to the VNs without requesting any interaction from the HN, for example, as depicted in FIG. 14. For the VN to authenticate the roaming WTRU through the WTRU−Proof, the VN may need to acquire information about the WTRU−Proof (e.g., authentication policy, public keys of the roaming WTRU, etc.), which may be published as a blockchain transaction denoted as WTRU−RPT, as shown in FIG. 11.

The VN may initiate the authentication process. Instead of requesting the needed parameter and information about the WTRU−Proof from the HN, the VN may acquire the needed parameters from the blockchain, for example, as demonstrated in FIG. 14. The HN may publish WTRU Roaming Proof Transaction (e.g., WTRU−RPT) in the blockchain ledger to refer to the needed parameters to initiate the roaming WTRU authenticating and/or verify the WTRU−Proof authenticity, for example, as depicted in FIG. 11 (and briefly shown in FIGS. 12 and 13).

The issued WTRU−Proof may be used to verify the roaming WTRU to the VN without the need of requesting any interactions from the HN. The method of issuing and verifying the WTRU−Proof may follows the following considerations to achieve a decentralized WTRU-centric roaming solution.

The method of issuing the WTRU−Proof may guarantee the authenticity and verifiability of the roaming WTRU to the VN without revealing any relatable information about the roaming WTRU's permanent identity (e.g., SUPI or even the WTRU−Proof).

The method of issuing the WTRU−Proof may guarantee the authenticity and/or verifiability of the roaming WTRU to the VN without the need for any interaction or reaction from the HN side.

Any authentication mechanism or policy that may guarantee achieving the aforementioned WTRU−Proof issuance considerations may be adopted. Alternatively or additionally, the authentication mechanism may guarantee mutual authentication between the VN and the roaming WTRU without relying on the HN as a man-in-the-middle to handle the authentication and verification process. One or more (e.g., two) methods of generating the WTRU−Proof are provided herein. The method of generating the WTRU−Proof may be known as an authentication policy. As shown in FIG. 12 and FIG. 13, the method of determining the authentication policy and/or issuing the WTRU−Proof may depend on the interaction between the roaming WTRU and the HN and/or results in creating a blockchain transaction published publicly in the blockchain system. The procedures in FIG. 12 and FIG. 13 depict the potentially required interaction between the roaming WTRU and the roaming WTRU's HN to issue the WTRU−Proof given the determined authentication policy.

FIG. 12 depicts an example RSA-based Authentication Policy 1200. As shown in FIG. 12, authentication policy 1 may depend on an RSA-based authentication mechanism. A basic homomorphic encryption method may be used, where RSA encryption may have multiplicative homomorphism. The RSA encryption scheme may work by first selecting two large primes (p_{RSA} and q_{RSA}) and sets n_{WTRU}=q_{RSA}. p_{RSA}. The public and private keys (Pk_{WTRU} and Sk_{WTRU}) for the RSA encryption scheme may be chosen such that Pk_{WTRU}·Sk_{WTRU}=1 mod n_{WTRU}. The generated prime numbers (p_{RSA} and q_{RSA}), and (Sk_{WTRU}) may be considered private values and no one may not know them except for the generating WTRU (e.g., the roaming WTRU). The values (Pk_{WTRU}) and (n_{WTRU}) may be public values that may be known to anyone interacting with the generating WTRU (e.g., the roaming WTRU). The encryption function may then be expressed as Enc_{PK}_{_{WTRU}}(Info)=Info^{Pk}^{_{WTRU}} mod n_{WTRU}, where Info may be the message or information being encrypted.

The decryption function, on the other hand, may be expressed as Dec_{SK}_{_{WTRU}}(Enc_{PK}_{_{WTRU}}(Info))=(Info^{Pk}^{_{WTRU}})^{Sk}^{_{WTRU}} mod n_{WTRU}=Info. To prove the homomorphism of the RSA encryption scheme, suppose that Info₁ and Info₂ may be two plain text information, then,

$${Enc}_{{PK}_{WTRU}} ( {Info}_{1} ) \cdot {Enc}_{{PK}_{WTRU}} ( {Info}_{2} ) = ( {Info}_{1}^{{Pk}_{WTRU}} \cdot {Info}_{2}^{{Pk}_{WTRU}} ) mod {n}_{WTRU} = {( {Info}_{1} \cdot {Info}_{2} )}^{P {K}_{WTRU}} mod {n}_{WTRU} = {Enc}_{{PK}_{WTRU}} ( {Info}_{1} \cdot {Info}_{2} ) .$$

### Consequently,

$$D e {c}_{S {k}_{WTRU}} ( E n {c}_{P {K}_{W T R U}} ( {Info}_{1} ) \cdot {Enc}_{P {K}_{W T R U}} ( {Info}_{2} ) ) = {Info}_{1} \cdot {Info}_{2} .$$

A first authentication policy 1 may depend on an RSA-based authentication mechanism. A procedure performed in accordance with FIG. 12 may be given as follows.

The HN and the roaming WTRU may initiate the generation of a WTRU−Proof and determine an authentication policy at 1201. For example, the step at 1201 may be similar to that described with reference to 1103 in FIG. 11 according to RSA-based authentication policy. For example, as shown in FIG. 11, the roaming WTRU may send the HN a request to activate the roaming services, as depicted in 1101 in FIG. 11. Accordingly, the roaming WTRU and the HN may negotiate which authentication policy to be used in issuing the WTRU−Proof. The procedure in FIG. 11 may start by showing the roaming WTRU and the HN negotiating about the method of issuing the WTRU−Proof and/or may determine the authentication policy that may be used to authenticate and/or verify the roaming WTRU to the VN.

When the HN and the roaming WTRU determine the authentication policy method, which may be “Authentication Policy 1”, the HN may start generating the corresponding WTRU−Proof for the roaming WTRU at 1202. Authentication Policy 1 may refer to the RSA-based authentication model, which may include the RSA-based homomorphic encryption method. Given that the HN will generate a WTRU−Proof, which may be a roaming identifier. After generating the WTRU−Proof, the HN may split the WTRU−Proof into a least a few (e.g. two) secret values or shares (e.g., S1 as the first share and S2 as the second share), in such a way that none of the shares alone may reveal or point to any intelligible information about the secret (WTRU−Proof), but when a sufficient number of the shares (e.g., S1 and S2) may be combined, the secret (WTRU−Proof) may be reconstructed.

After generating the shares (e.g., S1 and S2) for the generated WTRU−Proof, the HN may compute the encrypted version of one or more of the shares (e.g., S2) using the WTRU public key (Pk_{WTRU}) at 1203. The HN may then may digitally sign one or more of the shares using the HN private key (Sk_{HN}), e.g., (Enc_{SK}_{_{HN}}(Enc_{PK}_{_{WTRU}}(S2))). Alternatively or additionally, the HN may generate the encrypted version of the generated WTRU−Proof using the WTRU public key and/or compute the hash value (Fingerprint) of the encrypted version of the WTRU−Proof, e.g., (SHA256((Enc_{PK}_{_{WTRU}} (WTRU−Proof))).

The HN may generate the WTRU Roaming Proof Parameters (WTRU−RPP) and may send the WTRU−RPP to the roaming WTRU at 1204. The WTRU−RPP in this context may include the value of the WTRU−Proof and the first share of the WTRU−Proof which is S1.

The HN may generate the WTRU Roaming Proof Transaction (WTRU−RPT) at 1205. The HN may publish the WTRU−RPT to the blockchain system. The WTRU−RPT may include any of the following: HN identifier, applicable authentication policy, public key of the HN, public key of the roaming WTRU, WTRU−Proof Fingerprint, and/or encrypted version of the second share of the WTRU−Proof(S2). The WTRU−RPT may include the HN identifier may allow the VN to identify which network(s) the roaming WTRU is subscribed to. The WTRU−RPT may include the applicable authentication policy (e.g., authentication policy 1), for example, as described herein. The WTRU−RPT may include the public key of the HN (Pk_{HN}), which the VN may use to verify the HN's digital signatures.

The WTRU−RPT may include the public key of the roaming WTRU (Pk_{WTRU}) which the VN may use to verify the roaming WTRU's digital signatures or decrypt any encrypted data that may be received from the roaming WTRU.

The WTRU−RPT may include the WTRU−Proof fingerprint (SHA256(Enc_{PK}_{_{WTRU}}(WTRU−Proof))).

The WTRU−RPT may include the encrypted version of the second share of the WTRU−Proof (S2) encrypted using the roaming WTRU's public key and/or digitally signed by the HN's private key (Enc_{SK}_{_{HN}} (Enc_{PK}_{_{WTRU}}(S2))).

When the HN generates the WTRU−RPT and publishes the WTRU−RPT in the blockchain system, the HN may send the generated WTRU−RPT and/or the WTRU−RPP to the roaming WTRU at 1206. The roaming WTRU may use the WTRU−RPT and/or the WTRU−RPP to authenticate itself to the VN during roaming services.

FIG. 13 depicts an example CH-based Authentication Policy 1300. As shown in FIG. 13, authentication policy 2 may depend on a CH-based authentication mechanism. A main concept may include a chameleon hash collision property. This property may depend on the ability of the roaming WTRU to cause a hashing collision between the hash value of the generated WTRU−Proof and a value sent within a challenge generated by the VN when the roaming WTRU requests roaming services. This may be achieved by the HN issuing the roaming WTRU the WTRU−Proof in a way that may allow the WTRU to cause such a hashing collision. The second authentication policy may depend on a CH-based authentication mechanism, the procedures of which may be given as follows.

The HN may initiate the generation of the WTRU−Proof and determine an authentication Policy (2) at 1301. For example, the roaming WTRU and the HN may negotiate about the method of issuing the WTRU−Proof and/or determine the authentication policy that would be used to authenticate and verify the roaming WTRU to the VN. The determined authentication policy may be Authentication Policy 2. When the authentication policy is determined, the HN may send the roaming WTRU a request to generate the needed CH Public Parameters (CHPP), which are in this case the (Y_{WTRU}, g, p, q) at 1302.

When the roaming WTRU receives the HN request, the roaming WTRU may start generating the CHPP by executing the CH. Gen function at 1303, for example, as explained in FIG. 2. After executing the CH. Gen function, the roaming WTRU may respond to the HN request and/or may submit the generated CHPP to the HN at 1304.

The HN may generate a WTRU−Proof at 1305, which may be a roaming identifier as described herein. At 1306, the HN may generate any two random numbers to represent the CH Collision Public Parameters (CHCPP) values (a_{WTRU}, b_{WTRU}) that may be used to compute the CH hash value of the generated WTRU−Proof.

After determining the CHCPP and generating the WTRU−Proof, the HN may execute the CH. Hash function at 1307, for example as depicted in FIG. 2. For example, the HN may obtain the CH hash value of the WTRU−Proof (e.g., or WTRU−Proof fingerprint). Alternatively or additionally the HN may encrypt the generated CH hash value of the WTRU−Proof using the WTRU public key.

The HN may generate the WTRU−RPP at 1308. The WTRU−RPP may include the value of the WTRU−Proof.

The HN may generate the WTRU−RPT, which may include any combination of the following parameters at 1309. The HN may publish the WTRU−RPT to the blockchain system. The WTRU−RPT may include any of the following: HN identifier, applicable authentication policy, public key of the HN, public key of the roaming WTRU, CH value of the generated WTRU−Proof (CHPP), and/or encrypted version of the CH hash value of the generated WTRU−Proof (WTRU−Proof Fingerprint). The WTRU−RPT may include the HN identifier by which the VN can identify which network the roaming WTRU is subscribed to. The WTRU−RPT may include the applicable authentication policy (e.g., authentication policy 2), for example, as determined herein. The WTRU−RPT may include the public key of the HN (Pk_{HN}) which the VN may use to verify the HN's digital signatures. The WTRU−RPT may include the public key of the roaming WTRU (Pk_{WTRU}), which the VN may use to verify the roaming WTRU's digital signatures or decrypt any encrypted data that may be received from the roaming WTRU. The WTRU−RPT may include the CH value of the generated WTRU−Proof, the CHPP, and the CHCPP. The WTRU−RPT may include the encrypted version of the CH hash value of the generated WTRU−Proof (or WTRU−Proof Fingerprint) encrypted using the roaming WTRU's public key and digitally signed by the HN's private key.

When the HN generates the WTRU−RPT and publishes the WTRU−RPT in the blockchain system, the HN may send the generated WTRU−RPT and WTRU−RPP to the roaming WTRU at 1310, for example, to be used in authenticating the roaming WTRU to the VN during roaming services.

Roaming WTRU Mutual Authentication and Initial Access with a VN without HN Interaction may be provided. Once the roaming WTRU receives the WTRU−Proof from the HN, the roaming WTRU may start requesting the roaming service from the VN. The roaming service may be obtained in two complementary phases. One phase may require the roaming WTRU and the VN to mutually authenticate each other (e.g., mutual authentication phase). Once the roaming WTRU and the VN mutually authenticate each other, the VN may authorize the accessibility of the roaming WTRU to the VN resources through a decentralized agreement (e.g., initial access phase).

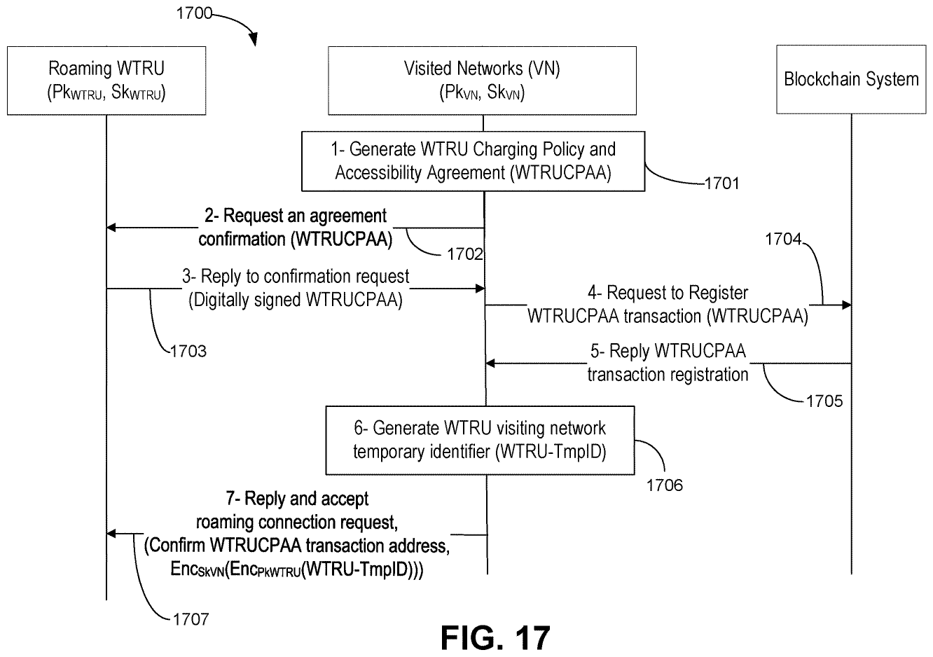

FIG. 14 depicts an example mutual authentication phase procedure 1400. FIG. 14 and FIG. 17 show in example of any required interactions between the VN and the roaming WTRU potentially without the need to request any assistance from the HN, for mutual authentication phase and/or initial access phase, respectively. As depicted in FIG. 14, the mutual authentication phase may include the following procedures to mutually authenticate the roaming WTRU and the VN to each other.

When the roaming WTRU reaches the VN coverage, the roaming WTRU may send a roaming connection request to the VN at 1401, which for example, may include the WTRU−RPT address (e.g., the transaction sequence number of the WTRU−RPT and/or the sequence number of the block that includes the WTRU−RPT) in the blockchain. The WTRU−RPT address may be encrypted by the VN's public key (i.e., Enc_{Pk}_{_{VN}}(WTRU−RPT)).

When the VN receives the roaming WTRU's request, the VN may decrypt the encrypted WTRU−RPT address using its private key by computing Dec_{Sk}_{_{vN}}(Enc_{Pk}_{_{VN}}(WTRU−RPT)) to obtain the WTRU−RPT address at 1402. When the VN is able to decrypt and/or recover the original WTRU−RPT address, the VN may send a request to the blockchain system to pull up the WTRU roaming proof transaction (WTRU−RPT) content at 1403. The blockchain system may look up and check the WTRU−RPT based on the WTRU−RPT address. The blockchain system may respond to the VN request by sending the WTRU−RPT content to the VN at 1404.

When the VN receives the WTRU−RPT content from the blockchain system, the VN may extract the needed information about the roaming WTRU at 1405. The VN may check the HN identifier to get enough information about the network that the WTRU is subscribed to. Then the VN may extract the roaming WTRU public key and/or identify the WTRU authentication policy to start authenticating and/or verifying the roaming WTRU.

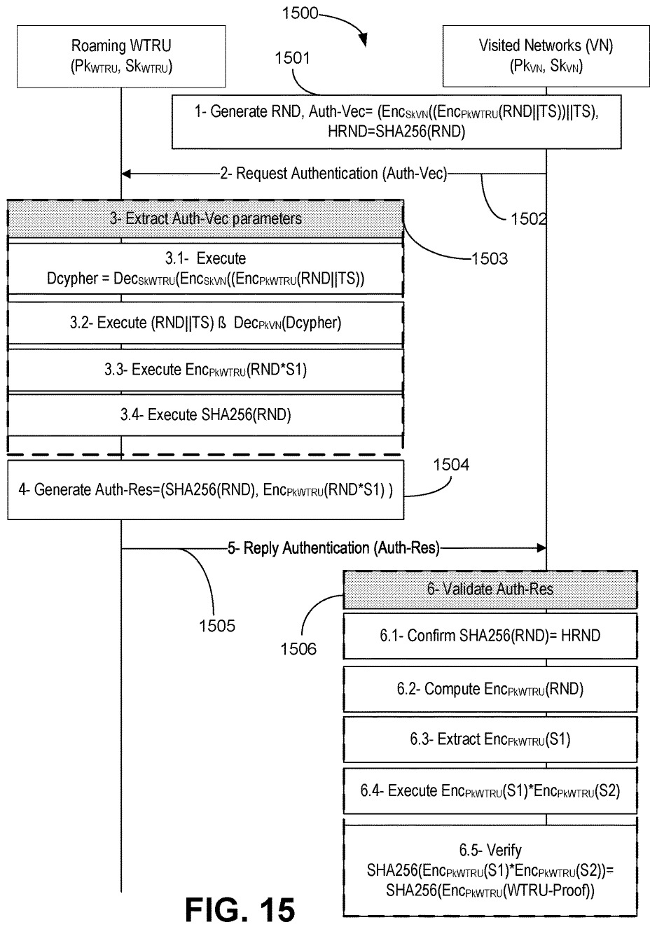

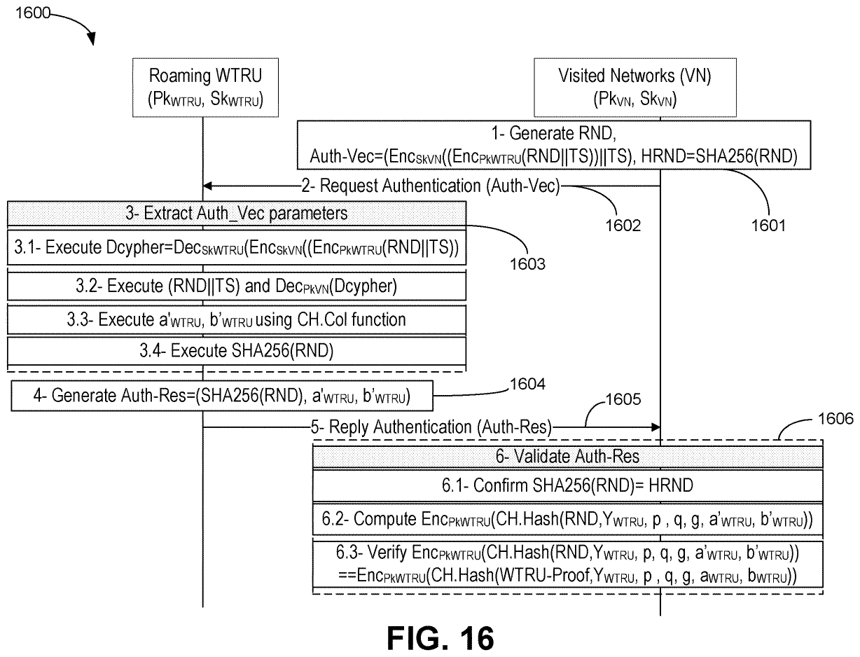

When the VN extracts one or more (e.g., all) of the required information from the WTRU−RPT content, the VN may authenticate the roaming WTRU according to the determined authentication policy as indicated in the WTRU−RPT content. It is important to note that the authentication procedures may differ according to the specific authentication policy and/or its requirements. FIG. 14 depicts an example of steps that may be performed regardless of the determined authentication policy. FIG. 15 and FIG. 16 respectively depict RSA-based and CH-based authentication policies.

The VN may generate an Authentication Vector (Auth−Vec) and/or may compute the hash value of the expected response from the roaming WTRU (HRES) at 1406. HRES may refer to the expected hash value of the generated RND value computed by the VN and expected to be extracted by the roaming WTRU while computing the Auth−Res. The Auth−Vec may be used to send the roaming WTRU an authentication challenge according to the authentication policy determined in the WTRU−RPT content. The VN may send an authentication request to the roaming WTRU to start the authentication process at 1407. The authentication request may include the generated Auth−Vec.

The roaming WTRU may extract the authentication challenge from the Auth−Vec received from the VN and/or may start generating the response to the received authentication challenge at 1408. The roaming WTRU may compute the needed parameters to compose an authentication response (Auth−Res) that may be sent to the VN as a response to the authentication request. The content of Auth−Res may depend on which authentication policy is used to authenticate the roaming WTRU, for example, in accordance with FIGS. 15 and 16. After generating the Auth−Res, the roaming WTRU may send the VN a response to the authentication request at 1409. The roaming WTRU may attach to this response the composed Auth−Res obtained.

When the VN receives the Auth−Res from the roaming WTRU, the VN may validate the received Auth−Res including the parameters included in the Auth−Res at 1410. The VN may validate if the hash value of the actual received Auth−Res is equal to HRES (the hash value of the expected response), for example, in accordance with FIGS. 15 and 16, respectively. The VN may send the roaming WTRU a notification indicating the successful completion of the authentication phase at 1411.

In FIG. 15 and FIG. 16, the details of the mutual authentication process between the VN and/or the roaming WTRU may be explained according to the authentication policy indicated in the WTRU−RPT, as depicted in FIG. 14. FIG. 15 shows an example of an authentication process according to RSA-based authentication policy.

Described herein are Mutual Authentication Phase embodiments. The following procedures may illustrate the required interactions between the VN and the roaming WTRU to obtain the required authentication process.

At 1501, the VN may generate a random number (RND). This random number (RND) may be used to compose an authentication challenge for the roaming WTRU to solve as a part of the authentication process. The VN may generate an Auth−Vec that may include a time stamp and/or the VN's signature. The time stamp (TS) may be when the Auth−Vec is determined. The VN's Signature may be generated by, for example, the VN computing the TS concatenated with the generated RND, then digitally signing the (RND∥TS) using the VN secret key. The VN may then encrypt the result using the roaming WTRU public key. Therefore, the VN may compute Enc_{Pk}_{_{WTRU}}(Enc_{Sk}_{_{VN}}(RND∥TS)).

Thus, the Auth−Vec may include Auth−VEC=(Enc_{Pk}_{_{WTRU}}(Enc_{Sk}_{_{VN}}(RND∥TS))∥TS). Alternatively or additionally, the VN may compute the hash value of the generated RND (e.g., HRES) as an expected response for the sent challenge to the roaming WTRU. The VN may maintain the HRES locally.

After generating the Auth−Vec, the VN may send the roaming WTRU an authentication request and/or may attach the composed Auth−Vec at 1502. When the roaming WTRU receives the VN authentication request, the roaming WTRU may start extracting the Auth−Vec parameters and/or may verify the VN's signature at 1503, for example as follows. The roaming WTRU may extract the TS from the received Auth−Vec and/or may then decrypt the rest of the received Auth−Vec by executing the D Dcypher=Dec_{Pk}_{_{WTRU}} Enc_{Pk}_{_{WTRU}}(Enc_{Sk}_{_{VN}} (RND∥TS))).

When the roaming WTRU decrypts the ((Enc_{Pk}_{_{WTRU}}(Enc_{Sk}_{_{VN}}(RND∥TS))), the roaming WTRU may start verifying the VN's signature. The roaming WTRU may know the public key of the VN from the roaming agreement between the HN and the VN (VN−Roaming−Key−Repo), which may have been stored in the blockchain system and/or which the roaming WTRU may acquire before roaming. The roaming WTRU may include the following Dec_{Pk}_{_{VN}}(Dcypher)=Dec_{Pk}_{_{VN}}(Enc_{Sk}_{_{VN}}(RND∥TS)=(RND∥TS). The ability of the VN to decrypt the received WTRU−RPT correctly, extract the WTRU information, and/or digitally sign the received (RND∥TS) may be proof for the WTRU that the VN may be a legitimate one. Thus, the roaming WTRU at this point may be able to authenticate the VN.

After obtaining the (RND∥TS) value, the roaming WTRU may extract the RND value and may multiply the RND value with the value of S1 (e.g., the first share of the WTRU−Proof value). Alternatively or additionally, once the roaming WTRU obtains (S1.RND), the roaming WTRU may compute the encrypted value EncPkWTRU (S1. RND). Alternatively or additionally, the roaming WTRU may compute the hash value of RND (SHA256(RND)) that may be used as a proof for the VN that the roaming WTRU may be able to extract the sent RND correctly.

When the roaming WTRU finishes one or more (e.g. all) of the aforementioned calculations, the roaming WTRU may start composing the Auth−Res at 1504, which for example, may include the hash value of the extracted RND (e.g. SHA256(RND)) and/or the encrypted value of the first WTRU−Proof share (S1) multiplied by the RND, where one or more (e.g., all) may be encrypted using the roaming WTRU public key (Enc_{Pk}_{_{UE}}(S1. RND)). At 1505, the roaming WTRU may respond to the authentication request sent by the VN. The roaming WTRU response to the authentication request may include the computed Auth−Res calculated.

When the VN receives the Auth−Res from the roaming WTRU, the VN may start executing the following procedures at 1506. The VN may extract the computed hash value of the RND (SHA256(RND)) received from the roaming WTRU and/or may compare its value to the HRES value computed in accordance with FIG. 15. If the HRES is equal to the SHA256(RND) received from the roaming WTRU, the VN may continue the rest of the authentication process; otherwise, the VN may terminate the process and reject the roaming connection request sent, for example, as described in accordance with FIG. 14.

The VN may then compute the encrypted value of the generated RND using the roaming WTRU public key (Enc_{Pk}_{_{WTRU}}(RND)). When the VN computes the (Enc_{Pk}_{_{WTRU}}(RND)), the VN may extract the (Enc_{Pk}_{_{WTRU}}(S1)) by dividing the (Enc_{Pk}_{_{WTRU}}(S1. RND)) received in the Auth−Res sent by the roaming WTRU to the value of (Enc_{Pk}_{_{WTRU}}(RND)). The VN may know the value of (Enc_{Pk}_{_{WTRU}}(S2)) from the WTRU−RPT obtained in accordance with FIGS. 11 and 14. The VN may know the value of (Enc_{Pk}_{_{WTRU}}(S1)), and/or the VN may compute the (Enc_{Pk}_{_{WTRU}}(WTRU−Proof)). The VN may compute (Enc_{Pk}_{_{WTRU}}(WTRU−Proof)) by following the homomorphic encryption property described herein. In other words, Enc_{Pk}_{_{WTRU}}(WTRU−Proof)=Enc_{Pk}_{_{WTRU}}(S1). Enc_{Pk}_{_{WTRU}}(S2).

The VN may validate Auth−Res and/or may authenticate roaming WTRU by verifying that the hash value of the computed Enc_{Pk}_{_{WTRU}}(WTRU−Proof) (e.g. SHA256(Enc_{Pk}_{_{WTRU}}(WTRU−Proof)) may match the hash value of the EncPkWTRU (UE-Proof), potentially published in the WTRU−RPT, for example, and obtained in accordance with FIG. 14.

Described herein are embodiments with affiliation to mutual authentication process according to CH-based authentication policy. FIG. 16 depicts an example of the mutual authentication process 1600 according to CH-based authentication policy. The following procedures illustrate an example of the required interactions between the VN and the roaming WTRU to perform the mutual authentication to each other, for example, in accordance with FIG. 14.

The VN may generate a random number (RND) at 1601. This random number (RND) may be used to compose an authentication challenge for the roaming WTRU to solve as a part of the authentication process. After that, the VN may generate an Auth−Vec that includes a time stamp and/or the VN's Signature. The time stamp (TS) may be when the Auth−Vec is determined. To generate the VN's Signature, the VN may compute the TS concatenated with the generated RND, and/or then may digitally signing the (RND∥TS) using the VN's secret key, and/or then may encrypt the result using the roaming WTRU's public key. Therefore, the VN may compute Enc_{Pk}_{_{WTRU}}(Enc_{Sk}_{_{VN}}(RND∥TS)).

Thus, the Auth−Vec may include Auth−VEC=(Enc_{Pk}_{_{WTRU}}, (Enc_{Sk}_{_{VN}}(RND∥TS))∥TS). The VN may compute the hash value of the generated RND (e.g., HRES) as an expected response for the sent challenge to the roaming WTRU. The VN may maintain the HRES locally. Enc_{Pk}_{_{WTRU}}(Enc_{Sk}_{_{VN}}(RND∥TS)) may be equivalent to Enc_{Sk}_{_{VN}}(Enc_{Pk}_{_{WTRU}}(RND∥TS)), which means the RSA operations may be associative operations. In some examples, both expressions may be the same unless otherwise is specified. After generating the Auth−Vec, the VN may send the roaming WTRU an authentication request at 1602. The VN may attach the composed Auth−Vec to the authentication request.

When the roaming WTRU receives the VN authentication request, the roaming WTRU may start extracting the parameters that may be included in the Auth−Vec and/or may verify the VN's signature at 1603. The VN's signature verification may include the roaming WTRU extracting the TS from the received Auth−Vec and/or then decrypting the rest of the received Auth−Vec by executing the Dcypher=Dec_{Sk}_{_{WTRU}}((Enc_{Pk}_{_{WTRU}}(Enc_{Sk}_{_{VN}}(RND∥TS))).

Once the roaming WTRU decrypts the ((Enc_{Pk}_{_{WTRU}}(Enc_{Sk}_{_{VN}}(RND∥TS))), the roaming WTRU may start verifying the VN's signature. The roaming WTRU may know the public key of the VN from the roaming agreement between the HN and the VN (VN−Roaming−Key−Repo), which may have been stored in the blockchain system and/or which the roaming WTRU may acquire before roaming. Consequently, the roaming WTRU may compute the following Dec_{Pk}_{_{VN}} (Dcypher)=Dec_{Pk}_{_{VN}} (Enc_{Sk}_{_{VN}}(RND∥TS)=(RND∥TS). The ability of the VN to decrypt the received WTRU−RPT correctly, extract the WTRU information, and/or digitally sign the received (RND∥TS) may be a prove for the WTRU that the VN may be a legitimate one. Thus, the roaming WTRU may be able to authenticate the VN.

After obtaining the (RND∥TS) value, the roaming WTRU may extract the RND value. The roaming WTRU may induce the hash collision between the CH hash value of the extracted RND and/or the CH hash value of the WTRU−Proof included in the WTRU−RPT. The induced collision between the WTRU−Proof and the received RND from the VN may result in obtaining new CHCPP values (a′_{WTRU}, b′_{WTRU}) that causes the collision between the CH value of the received RND from the VN and the CH value of the WTRU−Proof. In other words, the roaming WTRU may be able to run the CH. Col such that (a′_{WTRU}, b′_{WTRU})=CH.Col (X_{WTRU}, WTRU−Proof fingerprint, RND, q, p, g). Alternatively or additionally, the roaming WTRU may compute the hash value (SHA256(RND)) that may be used as a proof for the VN that the roaming WTRU was able to extract the sent RND correctly.

When the roaming WTRU finishes one or more (e.g., all) of the aforementioned calculations, the roaming WTRU may compose the Auth−Res at 1604. The Auth−Res may include the hash value of the extracted RND (SHA256(RND)) and/or the computed new CHCPP (a′_{WTRU}, b′_{WTRU}) corresponding to the CH value of the received RND from the VN. The roaming WTRU may respond to the authentication request sent by the VN at 1605. The roaming WTRU response to the authentication request may include the computed Auth−Res calculated according to FIG. 15.

The VN may execute one or more procedures after the VN receives the Auth−Res from the roaming WTRU at 1606. The VN may extract the hash value of the RND (SHA256(RND)) received from the roaming WTRU and/or compare the hash value of RND(SHA256(RND)) to the HRES value computed, for example, according to FIG. 15. If the HRES is equal to the SHA256(RND) received from the roaming WTRU, the VN may continue the rest of the authentication process; otherwise, the VN may terminate the process and reject the roaming connection request sent, for example, as shown in FIG. 14.

The VN may compute the CH hash value of the generated RND using the received CHCPP (a′_{WTRU}, b′_{WTRU}). In other words, the VN may compute (CH.Hash(RND, Y_{WTRU}, p, q, g, a′_{WTRU}, b′_{WTRU}) given that CHPP (Y_{WTRU}, p, q, g) may already be published in the WTRU−RPT (e.g., as shown in FIG. 13) and/or the CHCPP (a′_{WTRU}, b′_{WTRU}) may be received from the roaming WTRU as a part of the Auth−Res.

The VN may then compute the encrypted version of the (CH.Hash (RND, Y_{WTRU}, p, q, g, a′_{WTRU}, b′_{WTRU})) using the roaming WTRU public key and/or may then verify that Enc_{Pk}_{_{WTRU}}(CH. HASH (RND, Y_{WTRU}, p, q, g, a_{WTRU}, b_{WTRU})) may be equivalent to Enc_{Pk}_{_{WTRU}}(CH. HASH (WTRU−Proof, Y_{WTRU}, p, q, g, a_{WTRU}, b_{WTRU})) that has been included in the WTRU−RPT (e.g., as shown in FIG. 13). In case Enc_{Pk}_{_{WTRU}}(CH. HASH (RND, Y_{WTRU}, P, q, g, a_{WTRU}, b_{WTRU})) may be equivalent to Enc_{Pk}_{_{WTRU}}(CH. HASH (WTRU−Proof, Y_{WTRU}, p, q, g, a_{WTRU}, b_{WTRU})), the VN may validate and/or verify the roaming WTRU; otherwise the VN may reject the roaming request received from the roaming WTRU (e.g., in accordance with FIG. 14) and/or terminate the authentication process.

After validating and/or authenticating the roaming WTRU to the VN, the VN may start initiating the network initial access phase. In this phase, the VN may deploy a decentralized smart contract in the blockchain system to represent the WTRU Charging Policy and Access Agreement (WTRUCPAA). The deployed WTRUCPAA smart contract may indicate the negotiation and/or agreement between the VN, and the roaming WTRU about, but not limited to, the charging criteria, the expected QoS the roaming WTRU may receive, the limitations and/or regulations the roaming WTRU may follow, the method the roaming WTRU may prefer to pay the service with, and/or the expected visited time of the roaming WTRU, etc.

Described herein are Initial Access embodiments. FIG. 17 is a flow diagram illustrating an example of an initial access procedure 1700. The VN may generate a WTRU Charging Policy and Access Agreement (WTRUCPAA) at 1701. The generated WTRUCPAA may indicate the negotiation and/or agreement between the VN, and the roaming WTRU about, but not limited to, the charging criteria, the expected QoS the roaming WTRU may receive, the limitations and/or regulations the roaming WTRU may follow, the method the roaming WTRU may prefer to pay the service with, and/or the estimated visited time for the roaming WTRU (e.g., the expiration time of the WTRU visit).

After generating the WTRUCPAA, the VN may send the WTRUCPAA to the roaming WTRU for confirmation and/or signature at 1702. When the roaming WTRU receives the WTRUCPAA, the roaming WTRU may check the parameters and/or terms included in the WTRUCPAA, add any additional terms if preferred, and/or then digitally sign the received WTRUCPAA using the roaming WTRU's private key. The roaming WTRU may then send the digitally signed version of the WTRUCPAA to the VN at 1703.

When the VN receives the digitally signed version of the WTRUCPAA, the VN may request deploying the WTRUCPAA to the blockchain ledger at 1704. For example, the VN may transform the WTRUCPAA as a smart contract, create a WTRUCPAA transaction including this WTRUCPAA smart contract, and/or send this transaction to the blockchain system (e.g., a blockchain node) for deployment and/or validation. The VN may also store a copy of the WTRUCPAA transaction in its local database storage, however this may cause storage overhead. An alternative option, the VN may be to keep including the blockchain capabilities of storing the WTRUCPAA smart contract content in a decentralized fashion, thus potentially reducing any possibilities of using too much local storage resources.

When the blockchain system receives the WTRUCPAA smart contract content, the WTRUCPAA smart contract may be broadcasted and/or validated within and/or by the blockchain system. After the validation of the WTRUCPAA smart contract, the blockchain system may send a response to the VN indicating that the WTRUCPAA smart contract may have been successfully validated and/or stored in the blockchain ledger at 1705. This response may include the address of the WTRUCPAA smart contract stored in the blockchain system and/or any additional information that may be needed in order to access the WTRUCPAA smart contract from the blockchain system.

The VN may generate a temporary identifier (WTRU−TmpID) for the roaming WTRU at 1706, for instance, to represent a temporary SUPI. In this way, the VN may deal with the roaming WTRU as a temporary subscriber, such that the roaming WTRU may be authenticated, access, and/or utilize the VN resources similar to any other WTRUs subscribing to the VN as a HN. This WTRU−TmpID may be temporarily used during the roaming WTRU visit. Accordingly, the WTRU−TmpID may have a predetermined expiration date determined within the WTRUCPAA transaction.

In case the roaming WTRU may prefer to extend the visit to the VN coverage, the WTRU may send the VN a notification indicating that the roaming WTRU may like to increase the visited time period. The WTRU−TmpID may be represented as a set of structured digits (e.g., similar to the SUPI structure defined in 3GPP specification TS 23.501). As an example, the first three digits may represent the Mobile Country Code (MCC) of the VN, the next two or three digits form the Mobile Network Code (MNC) identifying the VN; and/or the remaining (nine or ten) digits may be known as Roaming-Mobile Subscriber Identification Number (R-MSIN) and may represent the roaming WTRU within the VN, which may be generated as a unique random number to identify the roaming WTRU.

The VN may accept the received roaming connection request, sent by the roaming WTRU. The VN may send a roaming connection response to the roaming WTRU at 1707. The VN may attach in the roaming connection response the WTRUCPAA address as a confirmation that the WTRUCPAA smart contract may have been successfully deployed in the blockchain. Alternatively or additionally, the VN may attach an encrypted version of the generated WTRU−TmpID using the roaming WTRU's public key and/or digitally signed by the VN's private key (Enc_{Sk}_{_{VN}}(Enc_{PK}_{_{WTRU}}(WTRU−TmpID))).

Dual Authentication between Roaming WTRU and the VN may be performed. To improve the roaming security and allow the same level of mutual authentication between the VN and the roaming WTRU, a dual authentication mechanism may be provided. Dual authentication in this context refers to obtaining two levels of authentication to guarantee the authenticity and/or verifiability between the VN and roaming WTRU. This means: 1) the roaming WTRU may authenticate the VN at least a few times (e.g., twice); and/or 2) the VN may also authenticate the roaming WTRU at least a few times (e.g., twice). More precisely, the VN may authenticate the roaming WTRU through verifying the roaming WTRU digital signatures followed by a second authentication through the WTRU−Proof using one of the proposed authentication-based policies described herein. Similarly, the roaming WTRU may authenticate the VN by verifying the digital signatures obtained by the VN and/or then may authenticate the VN through a similar proof to the WTRU−Proof denoted as the VN−Proof. In this matter, the roaming service mutual authentication phase may consider the roaming WTRU and the VN holding decentralized WTRU−Proof and/or a decentralized VN−Proof, respectively, which is a process denoted as dual authentication. To achieve this, the VN may need to request the issuance of the VN−Proof from one or more (e.g., multiple) trusted authorities that may be trusted by the VN, the HN, and/or roaming WTRU at the same time.

The HN is a trusted authority to issue both the VN−Proof and/or the WTRU−Proof for both the VN and/or roaming WTRU, respectively. It may not be necessary to consider the HN as the only trusted authority. In other words, any other trusted entity may be considered a viable issuer to issue the VN−Proof and/or the WTRU−Proof. For example, a trusted third-party identified by the blockchain system as a trusted authority may replace the HN in issuing either the VN−Proof, the WTRU−Proof, or both. In this case, the concept of the VN and the HN may be replaced with just networks (NWs).

The HN may be considered as the issuer of the VN−Proof. The VN and the HN may have the possibilities to agree on the way of issuing the VN−Proof during the roaming service enablement process (e.g., as shown in accordance with FIG. 10). The VN−Proof may be issued using the two proposed authentication policies, e.g., RSA-based authentication policy and CH-authentication-based policies described herein. That the HN may issue the VN−Proof for the VN using both authentication policies may enable enhanced flexibility for the VN to select a better (e.g., the best) authentication-policy that may match the roaming WTRU capabilities and/or the authentication policy method used to issue the roaming WTRU's WTRU−Proof. For example, a particular roaming WTRU may be capable of executing or computing the CH functions in a quick manner; therefore, the CH-based authentication policy may be a better (e.g., the best) option for that particular roaming WTRU to be adopted during the VN authentication process given the issued VN−Proof. In contrast, other roaming WTRUs may be capable of executing or computing the RSA-based calculations, thus the RSA-based authentication policy may be a better (e.g., the best) choice for these other roaming WTRUs if the VN−Proof was issued based on RSA-based authentication policy.

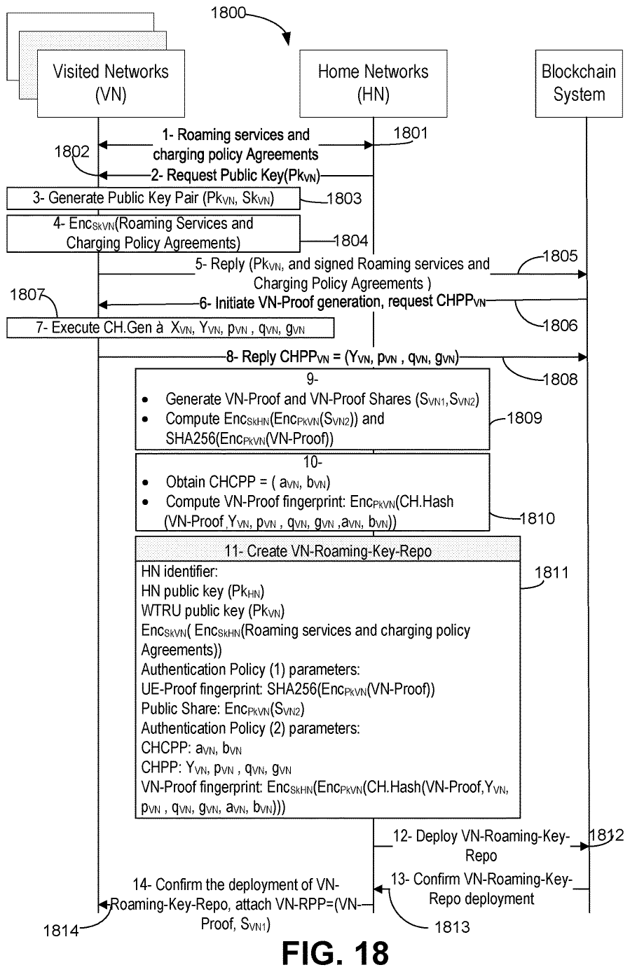

FIG. 18 depicts an example roaming service agreement 1800 considering VN−Proof. At 1801, the VN and the HN may exchange the potential roaming agreements, policies, and/or roaming service enablement criteria to determine the Roaming Service and Charging Policy Agreement. The HN may request the VN to generate a PKI key pair at 1802. The VN may generate the PKI key pair (e.g., Pk_{VN} as the public key of the VN and Skyn as the private/secret key of the VN) at 1803.

When the VN finishes the generation of the PKI key pair, the VN may digitally sign the roaming service and/or charging policy agreement Enc_{Sk}_{_{VN}}(Roaming Service and Charging Policy Agreement) using its private key Sk_{VN} at 1804. The VN may send a signed version of Roaming Service and Charging Policy Agreement to the HN alongside with the VN's generated public key (Pk_{VN}) at 1805.

When the HN receives the response from the VN, the HN may initiate the process to issue the VN−Proof for the VN at 1806. Given that the HN may issue the VN−Proof using the proposed authentication policies (e.g., CH-based and/or RSA-based). The HN may send the VN a request to provide the HN with the needed parameters in order to issue the VN−Proof accordingly. RSA-based authentication policy may require the VN's public key, which may already have been sent previously to the HN. For the CH-based authentication policy, the HN may require the CH public parameters associated with the VN (e.g., CHPP_{VN}). Therefore, the HN may send a request to the VN so that the VN may submit the generated CHPP_{VN} to the HN.

When the VN receives the HN request, the VN may start generating the CHPP_{VN} by executing the CH. Gen function at 1087, for example, as described herein. As a result, the VN may obtain the following parameters after executing the CH.Gen. The VN may obtain the private trapdoor key (X_{VN}) which may be considered a secret known only by the VN. The VN may obtain the CHPP_{VN} tuple, which may be public values representing the CH public parameters. The CHPP_{VN} may include the CH public key (Y_{VN}) and/or the CH cryptographic primitives (g_{VN}, p_{VN}, q_{VN}). After generating the CHPP_{VN}, the VN may respond to the HN's request and/or send the generated CHPP_{VN} to the HN at 1808.

The HN may start issuing the VN−Proof at 1809. The HN may generate the VN−Proof. VN−Proof content may be represented as a unique identifier representing the relationship between the HN and the VN. The HN may generate the authentication parameters related to the first authentication policy (e.g., RSA-based authentication policy). Given that, the HN may split the VN−Proof into at least a few (e.g., two) secret values or shares (e.g., S_{VN1} as the first share of the VN−Proof and S_{VN2} as the second share), in such a way that none of the shares alone may reveal or points to any intelligible information about the secret (VN−Proof), as described herein in the WTRU−Proof case.

After generating the shares (e.g., S_{VN1} and S_{VN2}) for the VN−Proof, the HN may compute the encrypted version of one or more of the shares (e.g., S_{VN2}) using the VN's public key (Pk_{VN}) and/or may then digitally sign one or more of the shares using the HN's private key (Sk_{HN}), e.g., (Enc_{Sk}_{_{HN}} (Enc_{Pk}_{_{VN}}(S_{VN2}) The HN may generate the encrypted version of the generated VN−Proof (e.g., the product of S_{VN1} and S_{VN2}) using the VN's public key and/or may compute the hash value (Fingerprint) of the encrypted version of the VN−Proof, e.g., (SHA256((Enc_{PK}_{_{VN}}(VN−Proof))).

The HN may then start generating the authentication parameters related to the second authentication policy (e.g., CH-based authentication policy) at 1810. In this case, the HN may pick any two random numbers to represent the CH Collision Public Parameters (CHCPP_{VN}) values (a_{VN}, b_{VN}) that may be used to compute the CH hash value of the generated VN−Proof. After determining the CHCPO_{VN}, the HN may execute the CH. Hash function (e.g., as described in FIG. 2), which for example, may result in obtaining the CH hash value of the VN−Proof (e.g., or VN−Proof fingerprint). Alternatively or additionally, the HN may encrypt the generated CH hash value of the VN−Proof using the VN's public key.

The HN may deploy the VN−Roaming−Key−Repo smart contract and/or determine its attributes at 1811, which may include any of, but not limited to, any combination of the following. Attributes may include the HN identifier which may identify the issuer of the VN−Proof. Attributes may include the public key of the HN (PK_{HN}) which the roaming WTRU may use to verify the HN's digital signatures. Attributes may include the public key of the VN (Pk_{VN}) which the roaming WTRU may use to verify the VN's digital signatures or decrypt any encrypted data that may be received from the VN.

Attributes may include the roaming service and charging policy agreement that may have been digitally signed by the VN and/or may have been received by the HN. Alternatively or additionally, the HN may be digitally signing the roaming service and/or charging policy agreement using its secret key. In other words, the HN may compute Enc_{Sk}_{_{HN}}(Enc_{Sk}_{_{VN}}(Roaming Service and Charging Policy Argeement)).

Attributes may include the authentication public parameters related to RSA-based authentication policy. Attributes may include the VN−Proof fingerprint (SHA256((Enc_{PK}_{_{VN}}(VN−Proof))). Attributes may include the encrypted version of the second share of the VN−Proof (S_{VN2}) encrypted using the roaming VN's public key (Enc_{Pk}_{_{VN}} (S_{VN2}) Attributes may include the authentication public parameters related to CH-based authentication policy. Attributes may include the CHPP_{VN}, and/or the CHCPP_{VN}. Attributes may include the encrypted version of the CH hash value of the generated VN−Proof (or VN−Proof Fingerprint) encrypted using the VN's public key and digitally signed by the HN's private key.

Once the HN finished composing VN−Roaming−Key−Repo smart contract, the HN may start deploying the VN−Roaming−Key−Repo smart contract (e.g., to publish its content) in the blockchain system at 1812. The blockchain system may process the received VN−Roaming−Key−Repo smart contract. The blockchain system may send a confirmation to the HN that the received VN−Roaming−Key−Repo smart contract has been validated at 1813. The confirmation may include the address of the VN−Roaming−Key−Repo smart contract deployed and/or validated in the blockchain system.

Once the HN receives the confirmation from the blockchain system that the VN−Roaming−Key−Repo smart contract has been validated, the HN may start preparing the VN Roaming Public Parameters (VN−RPP). VN−RPP may be composed of the generated VN−Proof and/or the first share of the VN−Proof which is S_{VN1}. At 1814, the HN may send the VN a confirmation with the deployment of the VN−Roaming−Key−Repo smart contract alongside with the VN−Roaming−Key−Repo smart contract address in the blockchain system and/or the generated VN−RPP.

The VN may be ready to receive the roaming WTRU requests. As explained earlier, the roaming WTRU may first request a roaming service activation from the HN (e.g., as depicted in FIG. 11). In other words, the roaming WTRU may have requested a WTRU−Proof from the HN to be ready for requesting the roaming services. Once the roaming WTRU receives the WTRU−Proof from the HN, the roaming WTRU may start requesting the roaming service from the VN as described herein. In this matter, the roaming service may be obtained through two phases: 1) The first phase may require the roaming WTRU and the VN to mutually authenticate each other. In this context, the roaming WTRU and the VN may initiate a mutual authentication process, where the VN and roaming WTRU may authenticate each other based on the selected authentication policy; and/or 2) once the roaming WTRU and the VN mutually authenticate each other, the VN may authorize the accessibility of the roaming WTRU to the VN resources through a decentralized agreement (e.g., as described herein in accordance with FIG. 17).

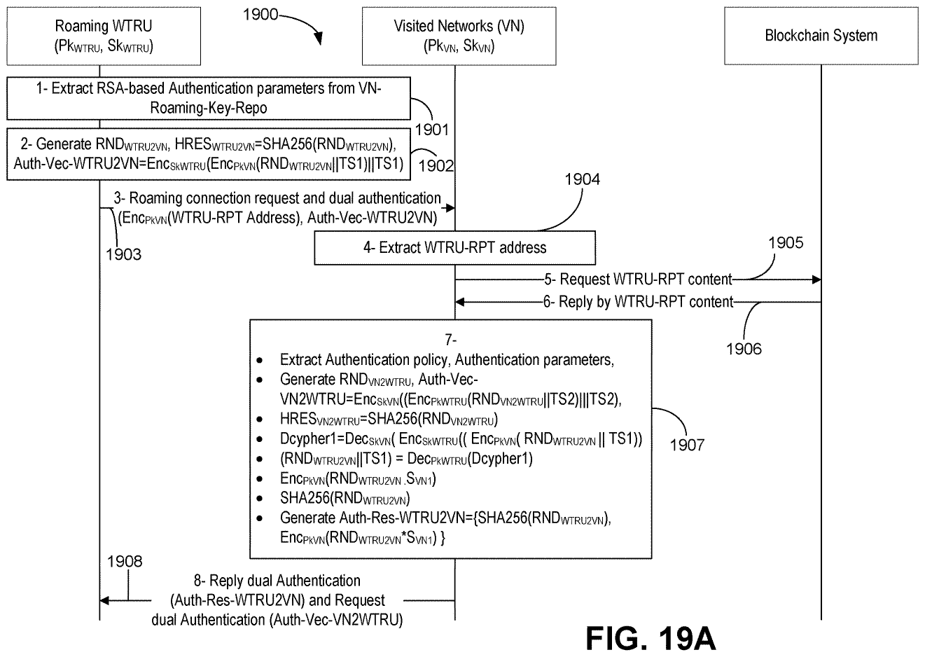

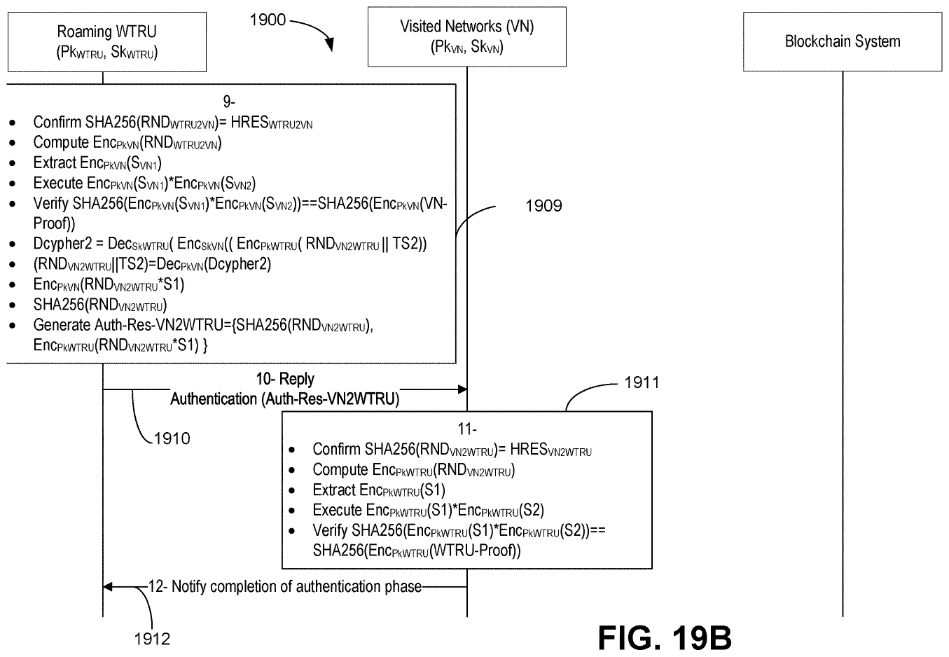

In order to obtain the dual authentication, where the WTRU and the VN may authenticate each other through the WTRU−Proof and/or the VN−Proof respectively, the mutual authentication process (e.g., depicted in FIG. 14) may need to be replaced with a dual authentication process (e.g., as depicted in FIG. 19A-B). Thus, a change applied to the mutual authentication process may include replacing the mutual authentication process with a dual authentication mechanism.

As described herein, the roaming WTRU may get issued the WTRU−Proof using either the RSA-based authentication policy (Authentication policy (1)) or CH-based authentication policy (Authentication policy (2)). Given that, the roaming WTRU may assumed to get issued the roaming WTRU−Proof using the RSA-based authentication policy. The same procedures may be applied if the WTRU−Proof was issued using the CH-authentication policy taking into consideration the CH-based authentication (e.g., in accordance with FIG. 16).

Described herein are Dual Authentication embodiments in accordance with FIG. 19A-19B. FIGS. 19A-19B is a flow diagram illustrating an example of a dual authentication procedure 1900. One embodiment may include the WTRU storing locally a copy of the VN−Roaming−Key−Repo smart contract that may include one or more (e.g., all) of the needed public authentication parameters related to the VN. Before the roaming WTRU request any roaming services, the roaming WTRU may extract the needed information about the VN at 1901 (e.g., the VN's public Key, the hash value of VN−Proof, and/or the hash value of encrypted version of S_{VN2} to be used for the roaming to authenticate the VN based on the RSA-based authentication policy).

The roaming WTRU may start preparing an Auth−Vec−WTRU2VN that may be sent to the VN as a challenge to authenticate the VN using the selected authentication policy (RSA-based). Given that the authentication policy is RSA, a similar approach to what is described herein in accordance with FIG. 15 may be applied. The roaming WTRU may generate a random number (RND_{WTRU2VN}) at 1902. This random number (RND_{WTRU2VN}) may be used to compose an authentication challenge for the VN to solve as a part of the authentication process. The roaming WTRU may generate the Auth−Vec−WTRU2VN, which for example, may include the following parameters. The roaming WTRU may include the time stamp (TS1) when the Auth−Vec−WTRU2VN is determined. The roaming WTRU may include the roaming WTRU's Signature. The roaming WTRU may concatenate TS1 with the generated RND_{WTRU2VN}, then digitally sign the (RND_{WTRU2VN}∥TS1) using the roaming WTRU's secret key and/or may then encrypt the result using the VN's public key. Therefore, the roaming WTRU may compute Enc_{Sk}_{_{WTRU}}(Enc_{Pk}_{_{VN}}(RND_{WTRU2VN}∥TS1)).

The Auth−Vec−WTRU2VN may be computed as: Auth−VEC−WTRU2VN=(Enc_{Sk}_{_{WTRU}} (Enc_{Pk}_{_{VN}}(RND_{WTRU2VN}∥TS1))∥TS1). The roaming WTRU may compute the hash value of the generated RND_{WTRU2VN} (e.g., HRES_{WTRU2VN}) as an expected response for the sent challenge to the VN. The roaming WTRU may maintain HRES_{WTRU2VN} locally and/or may not share the expected response (e.g., HRES_{WTRU2VN}) with any other entity.

When the roaming WTRU reaches the VN coverage, the roaming WTRU may send a roaming connection request to the VN at 1903, which for example, may include the WTRU−RPT address in the blockchain system. The WTRU−RPT address may be encrypted by the VN's public key (i.e., Enc_{Pk}_{_{VN}}(WTRU−RPT Address)). Alternatively or additionally, the roaming WTRU may request a dual authentication process to authenticate the VN and/or attach to the request the computed Auth−Vec−WTRU2VN.

When the VN receives the roaming VTRU's request, the VN may extract the encrypted WTRU−RPT address at 1904. The VN may decrypt the encrypted WTRU−RPT address using its private key by computing Dec_{Sk}_{_{vN}}(Enc_{Pk}_{_{VN}}(WTRU−RPT Address)) to obtain the WTRU−RPT address. Once the VN is able to decrypt and recover the original WTRU−RPT address, the VN may send a request(s) to the blockchain system to retrieve the WTRU roaming proof transaction (WTRU−RPT) content at 1905. The blockchain system may check the WTRU−RPT and/or may respond to the VN request by sending the WTRU−RPT content to the VN at 1906.

The VN may generate the Auth−Vec−VN2WTRU at 1907. The VN may start by extracting the WTRU authentication parameters and/or the roaming WTRU authentication policy from the WTRU−RPT received from the blockchain system. The VN may obtain the needed information about the roaming WTRU to start composing the Auth−Vec−VN2WTRU. The VN may generate the Auth−Vec−VN2WTRU that may be sent to the roaming WTRU as a challenge to authenticate the roaming WTRU using the selected authentication policy (RSA-based) determined in the WTRU−RPT. Given that the authentication policy is RSA-based authentication policy, a similar approach to what is shown in FIG. 15 may be applied.

The VN may then generate a random number (e.g., RND_{VN2WTRU}). This random number (e.g., RND_{VN2WTRU}) may I be used to compose an authentication challenge for the roaming WTRU to solve as a part of the authentication process. The VN may generate an Auth−Vec−VN2WTRU. The Auth−Vec−VN2WTRU may include the time stamp (TS2) when the Auth−Vec−VN2WTRU is determined. The Auth−Vec−VN2WTRU may include that the VN may concatenate the TS2 with the generated RND_{VN2WTRU}, and/or may then encrypt the (RND_{VN2WTRU}|TS2) using the roaming WTRU's public key and/or may then digitally sign the encrypted version using the VN's private key. Therefore, the VN will compute Enc_{Sk}_{_{VN}} (Enc_{Pk}_{_{WTRU}}(RND_{VN2WTRU}∥TS2)). Thus, the Auth−Vec−VN2WTRU may include Auth−VEC−VN2WTRU= (Enc_{Sk}_{_{VN}} (Enc_{Pk}_{_{WTRU}} (RND_{VN2WTRU}∥TS2))∥TS2). The VN may compute the hash value of the generated RND_{VN2WTRU} (e.g., HRES_{VN2WTRU}). HRES_{VN2WTRU} may represent the hash value of the expected response that may be received by the VN from the roaming WTRU as a part of solving the sent Auth_Vec_VN2WTRU challenge to the roaming WTRU. The VN may maintain the expected response (e.g. HRES_{VN2WTRU}) locally and/or may not share the expected response (e.g. HRES_{WTRU2VN}) with any other entity.

The VN may extract the Auth−Vec−WTRU2VN parameters and/or may then verify the roaming WTRU's signature. The VN may extract the TS1 from the received Auth−Vec−WTRU2VN and/or may then decrypt the rest of the received Auth−Vec−WTRU2VN by executing the Dcypher1=Dec_{Sk}_{_{vN}}((Enc_{Sk}_{_{WTRU}}(Enc_{Pk}_{_{VN}}(RND_{WTRU2VN}∥TS1))).

Once the VN decrypts the ((EncSkWTRU Enc_{Pk}_{_{VN}}(RND_{WTRU2VN}∥TS1))), the VN may start verifying the roaming WTRU's signature. The VN may know the public key of the roaming WTRU from the WTRU−RPT content Consequently, the VN may compute the following Dec_{PkW}_{_{TRU}} (Dcypher1)=Dec_{Pk}_{_{WTRU}} (Enc_{Sk}_{_{WTRU}}(RND_{WTRU2VN}∥TS1)=(RND_{WTRU2VN}∥TS1).

After obtaining the (RND_{WTRU2VN}∥TS1) value, the VN may extract the RND_{WTRU2VN} value and/or may multiply the RND_{WTRU2VN} value with the value of S_{VN1} (the first share of the VN−Proof value). Once the VN obtains (S_{VN1}.RND_{WTRU2VN}), the VN may compute the encrypted value Enc_{Pk}_{_{VN}}(S_{VN1}.RND_{WTRU2VN}). The VN may compute the hash value of RND_{WTRU2VN} (e.g., SHA256(RND_{WTRU2VN})) that may be used as a proof for the roaming WTRU that the VN may have been able to extract the sent RND_{WTRU2VN} correctly. Once the VN finishes one or more (e.g., all) of the aforementioned calculations, the VN may compose the Auth−Res−WTRU2VN, which may include the hash value of the extracted RND_{WTRU2VN} (e.g., SHA256(RND_{WTRU2VN})) and/or the encrypted value of the first VN−Proof share (S_{VN1}) multiplied by the RND_{WTRU2VN} at least some (e.g., all) encrypted using the VN public key (e.g., Encₚₖ_{_{VN}}(S_{VN1}. RND_{WTRU2VN})).

The VN may respond to the authentication request sent by the roaming WTRU at 1908. The VN response to the authentication request may include the computed Auth−Res−WTRU2VN calculated. The VN may send the computed Auth−Vec−VN2WTRU as a request to dual authentication to the roaming WTRU.

Once the roaming WTRU receives the Auth−Res−WTRU2VN and/or the Auth−Vec−VN2WTRU from the VN, the roaming WTRU may execute the following procedures at 1909. The roaming WTRU may extract the computed hash value of the RND_{WTRU2VN} from the Auth−Res−WTRU2VN, e.g., SHA256(RND_{WTRU2VN}). The roaming WTRU may compare SHA256(RND_{WTRU2VN}) value to the HRES_{WTRU2VN} value computed herein. If the HRES_{WTRU2VN} is equal to the SHA256(RND_{WTRU2VN}) received from the VN, the roaming WTRU may continue the rest of the authentication process; otherwise, the roaming WTRU may terminate the process and/or reject to attach itself to the VN service.

The roaming WTRU may then compute the encrypted value of the generated RND_{WTRU2VN} using the VN public key (Enc_{Pk}_{_{VN}}(RND_{WTRU2VN})). Once the roaming WTRU computes the (Enc_{Pk}_{_{VN}}(RND_{WTRU2VN})), the roaming WTRU may extract the (Enc_{Pk}_{_{VN}}(S_{VN1})) by dividing the (Enc_{Pk}_{_{VN}} (S_{VN1}. RND_{WTRU2VN})) received in the Auth−Res−WTRU2VN sent by the VN to the value of (Enc_{Pk}_{_{VN}}(RND_{WTRU2VN})). The roaming WTRU may know the value of (Enc_{Pk}_{_{VN}}(S_{VN2})) from the VN−Roaming−Key−Repo. The roaming WTRU may know the value of (Enc_{Pk}_{_{VN}}(S_{VN1})), the roaming WTRU may now compute the (Enc_{Pk}_{_{VN}}(VN−Proof)). The roaming WTRU may compute (Enc_{Pk}_{_{VN}}(VN−Proof)) by following the homomorphic encryption property described herein. In other words, Enc_{Pk}_{_{VN}}(VN−Proof)=Enc_{Pk}_{_{VN}}(S_{VN1}). Enc_{Pk}_{_{VN}}(S_{VN2}). The roaming WTRU may validate Auth−Res−WTRU2VN and/or may authenticate VN by verifying that the hash value of the computed Enc_{Pk}_{_{VN}} (VN−Proof) (e.g. SHA256(Enc_{Pk}_{_{VN}}(VN−Proof)) matches the hash value of the Enc_{Pk}_{_{VN}}(VN−Proof) published in the VN−Roaming−Key−Repo.

Once the roaming WTRU authenticates the VN, the roaming WTRU may perform a similar process to authenticate itself to the VN. This may be obtained by computing the Auth−Res−VN2WTRU that may match the request sent by the VN in the Auth−Vec−VN2WTRU. The calculation of the Auth−Res−VN2WTRU may follow the following procedures. The roaming WTRU may extract the TS2 from the received Auth−Vec−VN 2WTRU and/or may then decrypt the rest of the received Auth−Vec−VN2WTRU by executing the Dcypher2=Dec_{Sk}_{_{WTRU}}((Enc_{Pk}_{_{WTRU}} Enc_{Sk}_{_{VN}}(RND_{VN2WTRU}∥TS2) Once the roaming WTRU decrypts the ((Enc_{Pk}_{_{WTRU}} Enc_{Sk}_{_{VN}}(RND_{VN2WTRU}∥ TS2) the roaming WTRU may start verifying the VN's signature by computing Dec_{Pk}_{_{VN}}(Dcypher2)=Dec_{Pk}_{_{VN}}(Enc_{Sk}_{_{VN}}(RND_{VN2WTRU}∥TS2)=(RND_{VN2WTRU}∥TS2).

After obtaining the (RND_{VN2WTRU}|TS2) value, the roaming WTRU may extract the RND_{VN2WTRU} value and/or may multiply the RND_{VN2WTRU} value with the value of S1 (the first share of the WTRU−Proof value). Once the roaming WTRU obtains (S1. RND_{VN2WTRU}), the roaming WTRU may compute the encrypted value Enc_{Pk}_{_{WTRU}}(S1. RND_{VN2WTRU}). The roaming WTRU may compute the hash value of RND_{VN2WTRU} (e.g., SHA256(RND_{VN2WTRU})) that is used as a proof for the VN that the roaming WTRU has been able to extract the sent RND_{VN2WTRU} correctly.

Once the roaming WTRU finishes one or more (e.g., all) of the aforementioned calculations, the roaming WTRU may compose the Auth−Res−VN2WTRU. The Auth−Res−VN2WTRU may include the hash value of the extracted RND_{VN2WTRU} (e.g. SHA256(RND_{VN2WTRU})) and/or the encrypted value of the first WTRU−Proof share (S1) multiplied by the RND_{VN2WTRU}, one or more (e.g., all) of which may be encrypted using the roaming WTRU's public key (Enc_{Pk}_{_{WTRU}}(S1. RND_{VN2WTRU})).

Once the roaming WTRU finishes the calculation of the Auth−Res−VN2WTRU, the roaming WTRU may send a response to the VN about the dual authentication request and/or attach the value of the Auth−Res−VN2WTRU value to the message at 1910. Once the VN receives the Auth−Res−VN2WTRU from the roaming WTRU, the VN may start executing the following procedures at 1911. The VN may extract the computed hash value of the RND_{VN2WTRU} (e.g., SHA256(RND_{VN2WTRU})) received from the roaming WTRU and/or may compare the computed hash value (e.g., SHA256(RND_{VN2WTRU})) to the HRES_{VN2WTRU} value computed. If the HRES_{VN2WTRU} is equal to the SHA256(RND_{VN2WTRU}) received from the roaming WTRU, the VN may continue the rest of the authentication process; otherwise, the VN may terminate the process and/or may reject the roaming connection request.

The VN may then compute the encrypted value of the generated RND_{VN2WTRU} using the roaming WTRU's public key (Enc_{Pk}_{_{WTRU}}(RND_{VN2WTRU})). Once the VN computes the (Enc_{Pk}_{_{WTRU}}(RND_{VN2WTRU})), the VN may extract the (Enc_{Pk}_{_{WTRU}}(S1)) by dividing the (Enc_{Pk}_{_{WTRU}}(S1. RND_{VN2WTRU})) received in the Auth−Res−VN2WTRU sent by the roaming WTRU to the value of (EncpkwTRy (RND_{VN2WTRU})).

The VN may know the value of (Enc_{Pk}_{_{WTRU}}(S2)) from the WTRU−RPT obtained. The VN may know the value of (Enc_{Pk}_{_{WTRU}}(S1)). The VN may compute the (Enc_{Pk}_{_{WTRU}}(WTRU−Proof)). The VN may compute (Enc_{sPk}_{_{WTRU}} (WTRU−Proof)) by following the homomorphic encryption property. In other words, Enc_{Pk}_{_{WTRU}}(WTRU−Proof)=Enc_{Pk}_{_{WTRU}}(S1). Enc_{Pk}_{_{WTRU}}(S2).

The VN may validate Auth−Res−VN2WTRU and/or authenticate the roaming WTRU by verifying that the hash value of the computed Enc_{Pk}_{_{WTRU}} (WTRU−Proof) (e.g. SHA256(Enc_{Pk}_{_{WTRU}}, (WTRU−Proof)) matches the hash value of the Enc_{Pk}_{_{WTRU}}(WTRU−Proof) published in the WTRU−RPT. The VN may send the roaming WTRU a notification indicating the successful completion of the authentication phase at 1912.

Given that after the VN and the roaming WTRU successfully authenticate each other using the dual authentication mechanism, the VN may start initiating the roaming WTRU initial access phase to issue the roaming WTRU the WTRU−TmpID (e.g., in accordance with FIG. 17). Once the roaming WTRU has the UE-TmpID, the roaming WTRU may initiate the roaming WTRU temporary VN accessibility process, for example, to access the VN resources given the agreement obtained in the WTRUCPAA transaction within the roaming WTRU visit.

Described herein are embodiments affiliated with Roaming WTRU Temporary VN Accessibility. It may be assumed that the roaming WTRU and the VN have already negotiated the roaming WTRU accessibility to the VN resources. Further, the VN may have already determined the WTRU−TmpID as a temporary identifier for the roaming WTRU to access the VN resources. The VN may generate a temporary identifier (WTRU−TmpID) for the roaming WTRU to ease the roaming WTRU accessibility to the VN resources without the need of reinitiating the mutual authentication and/or initial access phases (e.g., as described herein and in accordance with FIGS. 14 and 17).

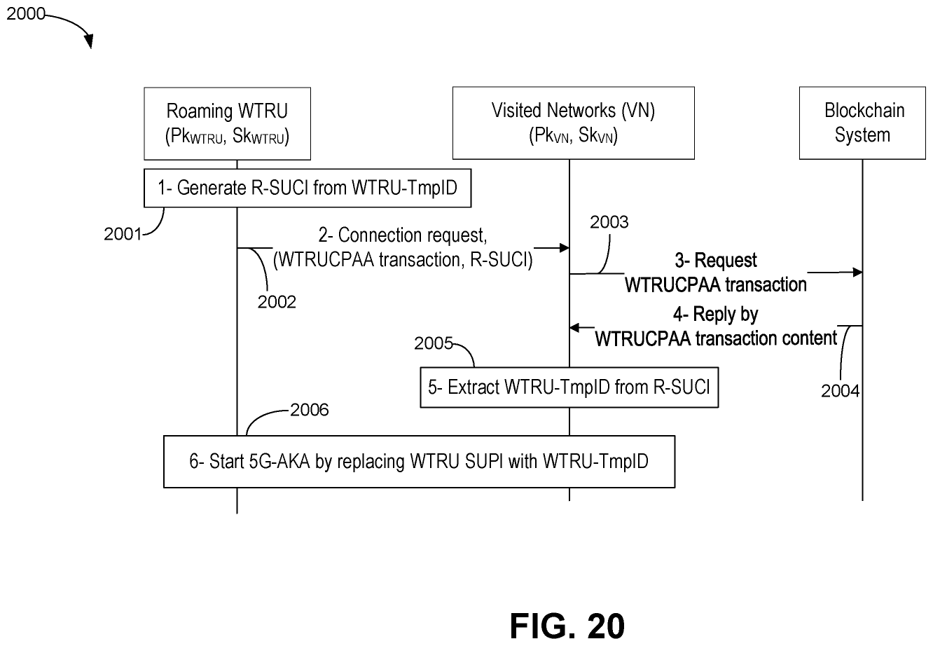

FIG. 20 is a flow diagram 2000 illustrating an example of roaming WTRU Temporary VN Accessibility. Some embodiments may exploit the same authentication models specified in the 3GPP standards by replacing the SUPI identifier of the network subscribers to be the WTRU−TmpID generated for the roaming WTRU. Hence, the following procedures, as shown in FIG. 20, illustrate any needed interaction to authenticate the roaming WTRU using the generated WTRU−TmpID issued by the VN.

When the roaming WTRU re-accesses the VN, the roaming WTRU may need to re-authenticate itself to the VN. It may be assumed that the roaming WTRU may be trying to access the VN resources within the negotiating visited time, as described herein. The roaming WTRU may use the WTRU−TmpID obtained from the VN as if it may be the roaming WTRU temporary SUPI (e.g., as shown in FIG. 17). The roaming WTRU may generate a Roaming-Subscription Concealed Identifier (R-SUPI) at 2001, for example, similar to the way the WTRU generates the SUCI from the SUPI.

Once the roaming WTRU generates the R-SUCI from the WTRU−TmpID, the roaming WTRU may send a connection request to the VN to re-access the VN resources at 2002. Through the connection request, the roaming WTRU may attach the computed R-SUCI and/or the WTRUCPAA (e.g., which may have been generated previously between the roaming WTRU and the VN).

Once the VN receives the connection request from the roaming WTRU, the VN may send a request to the blockchain system to retrieve the corresponding WTRUCPAA using the WTRUCPAA address at 2003. Once the blockchain system receives the VN request, the blockchain nodes may pull out the requested WTRUCPAA transaction from the blockchain ledger and/or may send the requested WTRUCPAA transaction from the blockchain ledger as a response to the VN at 2004.

Once the VN receives the WTRUCPAA from the blockchain system, the VN may start extracting the needed information to re-authenticate the roaming WTRU using the received R-SUCI at 2005. The extracted parameters from the WTRUCPAA transaction may include, but may not be limited to, the agreement obtained previously between the VN and the roaming WTRU during initial access phase, as described herein. The VN may check the expiration time of the roaming WTRU visited period to ensure validity of the WTRU−TmpID. The expiration time of the roaming WTRU visited period may have been determined by the VN (e.g., in accordance with FIG. 17).

The VN may start authenticating the roaming WTRU given the provided R-SUCI at 2006. The standard specification provided by the 3GPP to authenticate the network subscribers may be considered a perfect fit to authenticate the roaming WTRU to the VN. Alternatively, or additionally, the VN may use any of the standard authentication schemes (e.g., 5G-AKA) to authenticate the roaming WTRU, by replacing WTRU SUPI used in standard 3GPP authentication schemes with WTRU−TmpID.

A decentralized WTRU-centric roaming model may be provided. Described herein are updates or the roaming service enablement. In some embodiments, the VN network functions that may be employed for managing the roaming service enablement stage may be the PCF and the AUSF network functions. The VN−PCF may be responsible for negotiating the roaming services and/or charging policy agreement(s) with the HN network functions (e.g., HN−PCF). The VN−AUSF may be responsible for handling one or more (e.g., all) the security-related requests. For example, the VN−AUSF may be responsible for generating the public/private key pair used for authentication, digital signatures, encryption, and/or decryption purposes.

The HN network functions that may be employed to handle the roaming service enablement stage with the VN may be the PCF and the AUSF network functions. The HN−PCF may be responsible for negotiating the roaming services and/or charging policy agreements with the VN network functions (e.g., VN−PCF). Alternatively or additionally HN−PCF may also be responsible for the interactions with the blockchain nodes either to deploy the VN−Roaming−Key−Repo or to obtain any information from the blockchain ledger. The HN−AUSF may be responsible for handling all the security-related requests. For example, the HN−AUSF may be responsible for verifying the VN's digital signatures and generating for the VN the VN−Proof using the proposed authentication policies (e.g., RSA-based and CH-based).

A roaming service activation stage may be provided. The following HN function(s) may support the roaming service activation stage. The HN−AMF and HN−PCF may be responsible for managing the roaming services activation requests. The HN−AMF and HN−PCF may be responsible for negotiating the roaming service agreement with the roaming WTRU. The HN−AMF and HN−PCF may be responsible for handling the deployment of the UE−RPT transaction in the blockchain network. The HN−AMF and HN−PCF may be responsible for interacting with the blockchain nodes to either extract certain transactions or receive notifications about the deployed transaction in the blockchain network.

The HN−AUSF and HN−UDM may be responsible for generating the WTRU−Proof and/or the corresponding RPP that may be sent to the roaming WTRU. The HN−AUSF may be responsible for generating the corresponding public authentication parameters that may be published within the WTRU−RPT transaction.

A roaming WTRU mutual authentication and initial access stage may be provided. The following functions from the 3GPP 5G service architecture may be considered. In examples, the VN functions supporting the WTRU mutual authentication and/or initial access stage may be outlined as follows. The VN−AMF may be responsible for receiving the roaming service request from the roaming WTRUs. The VN−AMF may be also responsible for requesting the content of any transaction from the blockchain ledger. For example, the VN−AMF may be responsible for requesting the WTRU−RPT that may be published by the HN in the blockchain ledger.

The VN−AUSF may be responsible for handling one or more (e.g., all) the security-related requests. For example, the VN−AUSF may be responsible for generating the Auth−Vec−VN2WTRU challenge for the roaming WTRU according to the roaming WTRU authentication policy. The VN−AUSF may also be responsible for authenticating the VN to the roaming WTRU by generating the Auth−Res−WTRU2VN corresponding to the received Auth−Vec−WTRU2VN received from the roaming WTRU.

A roaming WTRU temporary VN accessibility stage may be provided. The following network function(s) may handle the interaction with the roaming WTRU to generate the WTRU−TmpID. The VN functions supporting the WTRU mutual authentication and/or initial access stage may be outlined as follows. The VN−AMF and/or VN−PCF may be responsible for handling the negotiation with the roaming WTRU to determine the WTRUCPAA smart contract agreement. The VN−PCF may be responsible for deploying the WTRUCPAA smart contract in the blockchain network or extracting any transaction content from the blockchain ledger.

The VN−AUSF may be responsible for handling one or more (e.g., all) the security-related processes related to issuing the temporary identifier (WTRU−TmpID) for the roaming WTRU.

The roaming WTRU may be the HN subscriber. During the roaming WTRU accessibility to the HN resources, the roaming WTRU may extract any transaction content (e.g., the transaction including the VN−Roaming−Key−Repo) from the blockchain ledger and/or store the transaction content locally. In this matter, the roaming WTRU may furthermore extract the VN−Roaming−Key−Repo content offline from the locally stored transaction content during the roaming service request, so that the roaming WTRU may authenticate the VN during the roaming process.

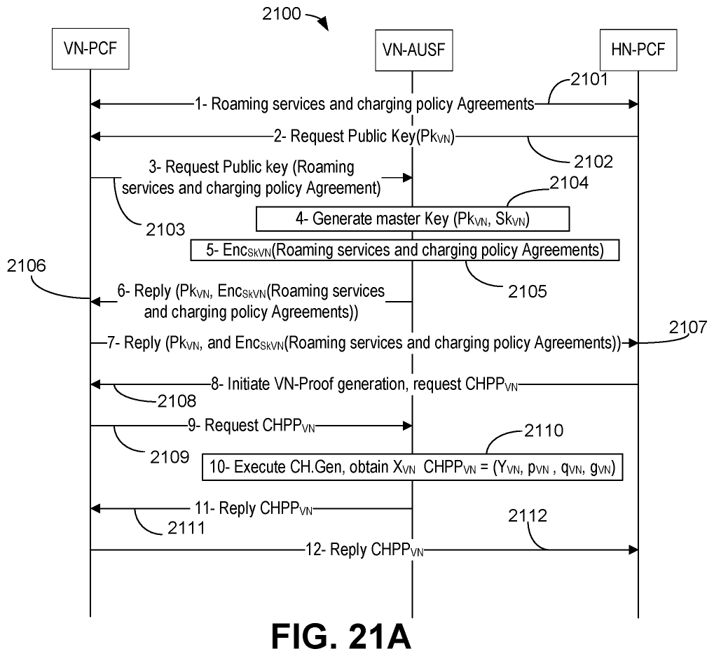

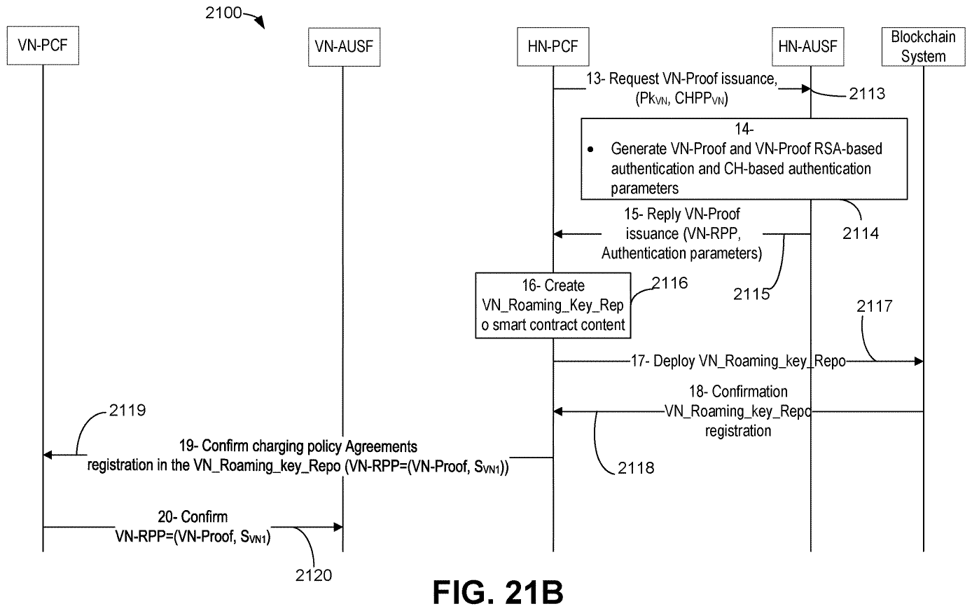

FIG. 21 depicts an example Service Flow 2100 for the Roaming Service Enablement. In examples, the VN and the HN may negotiate the roaming service and/or charging policy agreement. The HN may issue the VN the VN−Proof such that the roaming WTRU may authenticate the VN using one of the determined authentication policies. The HN may issue the VN−Proof for the HN using both authentication policies (e.g., RSA-based and/or CH-based authentication policy) such that the best authentication policy that fits the roaming WTRU capabilities may be selected to authenticate the VN.

The VN−PCF and/or the HN−PCF may exchange the potential roaming service and/or charging policy agreement that includes roaming agreements, policies, and/or roaming service enablement criteria at 2101, for example, to standardize the provided roaming services by the VN to the potential roaming WTRUs, who are subscribed to the HN as described herein. The HN−PCF may request the VN−PCF to generate a PKI key pair at 2102.

The VN−PCF may send a request to the VN−AUSF to generate the VN representative PKI (public/Private) key pair at 2103. The VN−PCF may attach the roaming service and/or charging policy agreement obtained with the HN−PCF to digitally sign the roaming service and/or charging policy agreement using the generated private key. The VN−AUSF may generate the PKI key pair (Pk_{VN} and Sk_{VN}) at 2104. When the VN−AUSF finishes the generation of the PKI key pair, the VN may digitally sign the roaming service and charging agreement at 2105 Enc_{Sk}_{_{VN}} (Roaming Service and Charging Policy Agreement).

When the VN−AUSF finishes the digital signature of the roaming service and/or charging policy agreement, the VN−AUSF may send the VN−PCF the generated public key (Pk_{VN}) and the Enc_{Sk}_{_{VN}} (Roaming Service and Charging Policy Agreement) at 2106. The VN−PCF may send the signed version of roaming service and charging agreement to the HN−PCF alongside the VN−generated public key (Pk_{VN}) at 2107.

When the HN−PCF receives the response from the VN−PCF, the HN−PCF may initiate a session to issue the VN−Proof for the VN at 2108. The HN−PCF may send the VN−PCF a request to provide the needed parameters to issue the VN−Proof accordingly. The RSA-based authentication policy may require the VN public key, which may already have been sent previously to the HN−PCF. For the CH-based authentication policy, the HN may require the CH public parameters associated with the VN (CHPP_{VN}). Therefore, the HN−PCF may send a request to the VN−PCF to submit the generated CHPP_{VN} at 2109.

When the VN−PCF receives the HN−PCF request, the VN−PCF may forward the request to the VN−AUSF to start generating the CHPP_{VN}. When the VN−AUSF receives the VN−PCF request, the VN−AUSF may generate the CHPP_{VN} by executing the CH. Gen function at 2110. As a result, the VN−AUSF may obtain a private trapdoor key (X_{VN}) and/or a CHPP_{VN} tuple after executing the CH. Gen. The private trapdoor key (X_{VN}) may be considered a secret that is known by (e.g., only by) the VN−AUSF. The CHPP_{VN} tuple may a public value representing the CH public parameters. The CHPP_{VN} may include the CH public key (Y_{VN}) and/or the CH cryptographic primitives (g_{VN}, p_{VN}, q_{VN}).

The VN−AUSF may send the generated CHPP_{VN} values to the VN−PCF as a response to the request sent by the VN−PCF at 2111. When the VN−PCF receives the CHPP_{VN}, the VN−PCF may respond to the HN−PCF request that was sent and/or may attach the generated CHPP_{VN} at 2112.

The HN−PCF may send a request to the HN−AUSF to start generating the VN−Proof and/or its corresponding authentication parameters at 2113. The HN−PCF may attach to the request the obtained CHPP_{VN} received from the VN−PCF alongside to the VN public key (Pk_{VN}). When the HN−AUSF receives the HN−PCF request to generate the VN−Proof, the HN−AUSF may start issuing the VN−Proof at 2114. The HN−AUSF may generate the authentication parameters related to the first authentication policy (RSA-based authentication policy) as described herein. Given that the HN−AUSF may split the VN−Proof into two secret values or shares (e.g., S_{VN1} and S_{VN2}). After generating the shares (e.g., S_{VN1} and S_{VN2}) for the VN−Proof, the HN−AUSF may compute the encrypted version of one or more of the shares (e.g., S_{VN2}) using the VN public key (Pk_{VN}) and/or may then digitally sign one or more of the shares using the HN private key (Sk_{HN}), e.g., (Enc_{SK}_{_{HN}} (Enc_{PK}_{_{VN}}(S_{VN2}) as described herein. The HN−AUSF may generate the encrypted version of the generated VN−Proof using the VN public key and/or compute the hash value (Fingerprint) of the encrypted version of the VN−Proof, e.g., (SHA256((Enc_{PK}_{_{VN}} (VN−Proof))). The HN−AUSF then may start generating the authentication parameters related to the CH-based authentication policy) as described herein. The HN−AUSF may pick any two random number to represent the CH Collision Public Parameters (CHCPP_{VN}) values (a_{VN}, b_{VN}) that may be used to compute the CH hash value of the generated VN−Proof.

After determining the CHCPP_{VN}, the HN−AUSF may execute the CH.Hash function (e.g., as shown in FIG. 2) to obtain the CH hash value of the VN−Proof (or VN−Proof fingerprint) (e.g., as shown in FIG. 18). The HN may encrypt the generated CH hash value of the VN−Proof using the VN's public key as described herein.

The HN−AUSF may generate the VN−RPP that may include the VN−Proof and/or S_{VN1}, which may be secret parameters known by the VN and/or the HN. The HN−AUSF may generate the public authentication parameters that may be composed in the VN−Roaming−Key−Repo smart contract. The HN−AUSF may send the VN−RPP and the generated authentication parameters to the HN−PCF as a response to the sent request at 2115.

When the HN−PCF receives the reply from the HN−AUSF, the HN−PCF may deploy the VN−Roaming−Key−Repo smart contract and/or determine its attributes at 2116, which for example, may include one or more the following parameters as shown in FIG. 18. The one or more parameters may include the HN identifier by which may identify which network issued the VN−Proof. The one or more parameters may include the public key of the HN (Pk_{HN}) which the roaming WTRU may use to verify the HN's digital signatures. The one or more parameters may include the public key of the roaming WTRU (Pk_{VN}) which the roaming WTRU may use to verify the VN's digital signatures or decrypt any encrypted data that may be received from the VN. The one or more parameters may include the digitally signed roaming service and/or charging agreement by both the VN and/or the HN secret keys (e.g., as shown in FIG. 18).

The one or more parameters may include the authentication public parameters related to RSA-based authentication policy. Public parameters may include the VN−Proof fingerprint (SHA256((Enc_{PK}_{_{VN}} (VN−Proof))). Public parameters may also include the encrypted version of the second share of the VN−Proof (S_{VN2}) encrypted using the roaming VN's public key Enc_{PK}_{_{VN}} (S_{VN2}). The one or more parameters may include the authentication public parameters related to CH-based authentication policy. Public parameters may include the CH value of the generated VN−Proof, the CHPP_{VN}, and the CHCPP_{VN}. Public parameters may also include the encrypted version of the CH hash value of the generated VN−Proof (or VN−Proof Fingerprint) encrypted using the roaming VN's public key and/or digitally signed by the HN's private key.

When the HN−PCF is finished composing VN−Roaming−Key−Repo smart contract, the HN may deploy the VN−Roaming−Key−Repo smart contract content in the blockchain network at 2117. The blockchain nodes may process the received VN−Roaming−Key−Repo smart contract and/or may then send a confirmation at 2118 to the HN that the transactions of the received VN−Roaming−Key−Repo smart contract may be validated. When the HN−PCF receives confirmation from the blockchain that the VN−Roaming−Key−Repo smart contract may be validated, the HN may send the VN−PCF a confirmation with the deployment of the VN−Roaming−Key−Repo smart contract alongside with the VN−Roaming−Key−Repo address in the blockchain network and/or the generated VN−RPP at 2119. The VN−PCF may then forward the received VN−RPP values to the VN−AUSF to be used later during any future authentication requests at 2120.

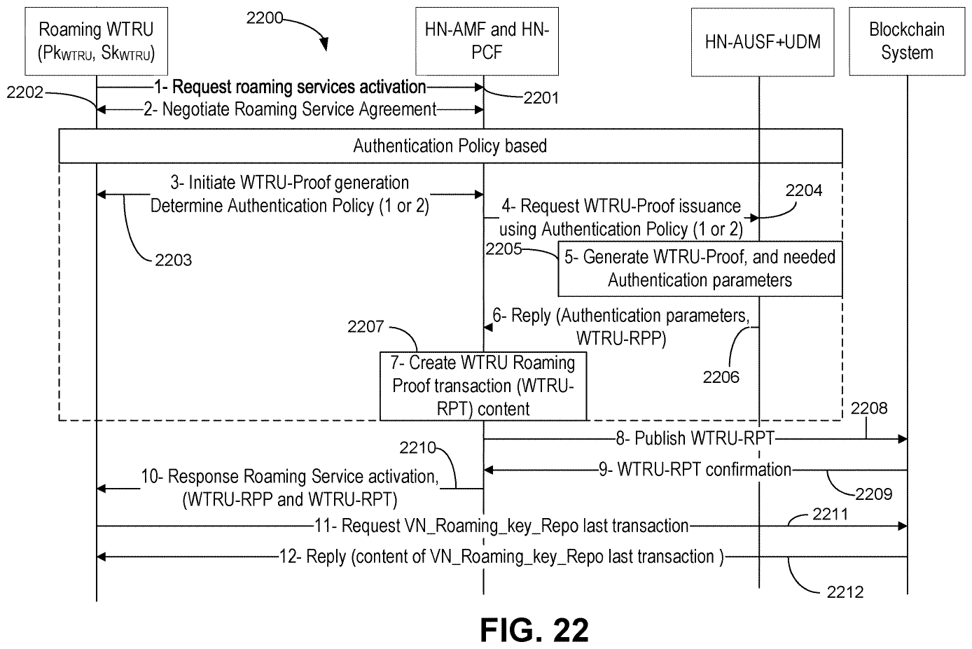

Described herein are service flow embodiments for the roaming service activation, as depicted in FIG. 22. FIG. 22 depicts an example service flow 2200 for a roaming service activation stage. The example service flow 2200 may include one or more (e.g., all) interactions, among the Roaming WTRU, the HN−AMF and HN−PCF, the HN−AUSF+UDM, and the blockchain system, that are needed to obtain roaming service activation process.

The roaming WTRU may negotiate with the HN to issue the WTRU−Proof such that the roaming WTRU can use it to authenticate itself to the VN without any assistance from the HN side. The roaming WTRU may send a request to the HN−AMF at 2201, which may be forwarded to the HN−PCF to activate the roaming services. This request may include the following parameters: WTRU-ID, WTRU−Proof-Lifetime, and/or Authentication-Policy. The WTRU-ID may denote the identifier of the WTRU (e.g., the SUCI of the WTRU, a decentralized identifier of the WTRU, a blockchain address of the WTRU, and/or the public key of the WTRU). The WTRU−Proof-Lifetime may denote the requested lifetime for the WTRU proof to be generated by the HN. The Authentication-Policy may denote the authentication policy(ies) that the WTRU supports and/or prefers (e.g., RSA-based, CH-based).

One or more procedures of FIG. 22 may be implemented by extending Registration Management. In examples, when the roaming WTRU sends a Registration Request (e.g., an Initial Registration, a Mobility Registration, a Periodic Registration Update, an Emergency Registration, a Disaster Roaming Initial Registration, and/or a Disaster Roaming Registration Update) to RAN and/or the HN−AMF, the Registration Request may include one or more (e.g., all) parameters as included in FIG. 22 or one or more (e.g., all) parameters as included in FIG. 11. Then, the HN−AMF may follow one or more procedures as depicted in FIG. 22.

When the roaming WTRU sends a Service Request to RAN and/or the HN−AMF, the Service Request may include one or more (e.g., all) parameters as included in FIG. 22 or one or more (e.g., all) parameters as included in FIG. 11. Then, the HN−AMF may follow one or more procedures, as depicted in FIG. 22.

When the HN−PCF receives the request for roaming services activation from the roaming WTRU through the HN−AMF, the HN−PCF may start negotiating the roaming services agreements at 2202. When the roaming WTRU and/or the HN reaches a roaming service activation agreement, the HN−PCF may initiate a session to issue the WTRU−Proof for the roaming WTRU at 2203 using one or more of the authentication policies as described herein.

After determining which authentication policy fits the roaming WTRU to issue the roaming WTRU proof (WTRU−Proof), as described herein, the HN−PCF may send a request to the HN−AUSF at 2204 to start generating the WTRU−Proof given the determined authentication policy (RSA-based or CH-based authentication policy). The HN−AUSF may start generating the WTRU−Proof and/or the needed authentication parameters to verify the WTRU−Proof at 2205. The generated authentication parameters may be determined based on the selected authentication policy determined by the HN and/or the roaming WTRU as depicted in FIGS. 12 and 13. The HN−AUSF may send the computed WTRU−Proof, the WTRU−RPP and/or the authentication parameters) to the HN−PCF as a reply to the request at 2206.

Once the reply is received, the HN−PCF may then create a WTRU Roaming Proof Transaction (WTRU−RPT) content at 2207. The WTRU−RPT content may include the used public key for the roaming WTRU (Pk_{WTRU}), the determined authentication policy for the roaming WTRU, the computed authentication parameters for the determined authentication policy, the HN identifier, and/or any other related information to ease the roaming WTRU authentication process, as described herein.

After creating the WTRU−RPT content, the HN−PCF may broadcast WTRU−RPT content as a blockchain transaction in the blockchain network at 2208. When the blockchain system validates the WTRU−RPT, the blockchain system may send a confirmation with the WTRU−RPT address (e.g., or the sequence number of the transaction, or the sequence number of the block including the transaction) to the HN−PCF at 2209. At 2210, the HN−PCF may send the roaming WTRU a response through HN−AMF for the roaming service activation request. The response may include the WTRU−RPT address in the blockchain network, the computed authentication parameters (WTRU roaming proof parameters (WTRU−RPP)), and/or the generated WTRU−Proof value.

One or more procedures, as depicted in FIG. 22, may be implemented by extending WTRU Configuration Update procedures. In examples, when the HN−AMF sends a WTRU Configuration Update Command to the roaming WTRU, the WTRU Configuration Update Command may include one or more (e.g., all) parameters as depicted in FIG. 22 and/or one or more (e.g., all) parameters as depicted in FIG. 11.

When the WTRU receives the WTRU−RPP and/or the WTRU−RPT, the roaming WTRU may send a request to the blockchain system to obtain the VN−Roaming−Key−Repo smart contract published by the HN and/or VN at 2211. When the blockchain system (e.g., a blockchain node) receives the request sent by the roaming WTRU to acquire the VN−Roaming−Key−Repo smart contract, the blockchain system may get the VN−Roaming−Key−Repo from the blockchain ledger and/or send a response to the WTRU with the content of the VN−Roaming−Key−Repo transaction at 2212.

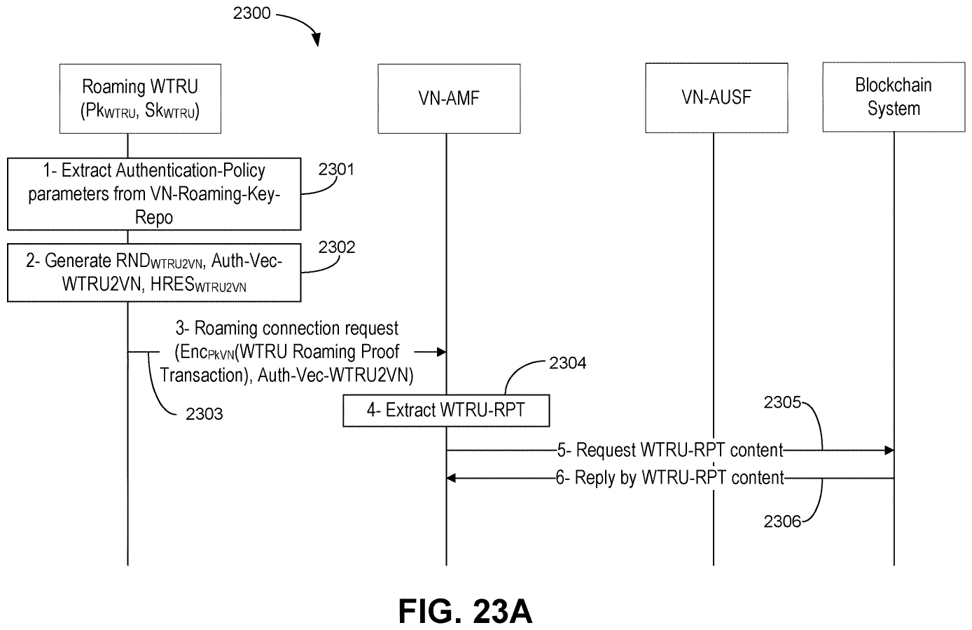

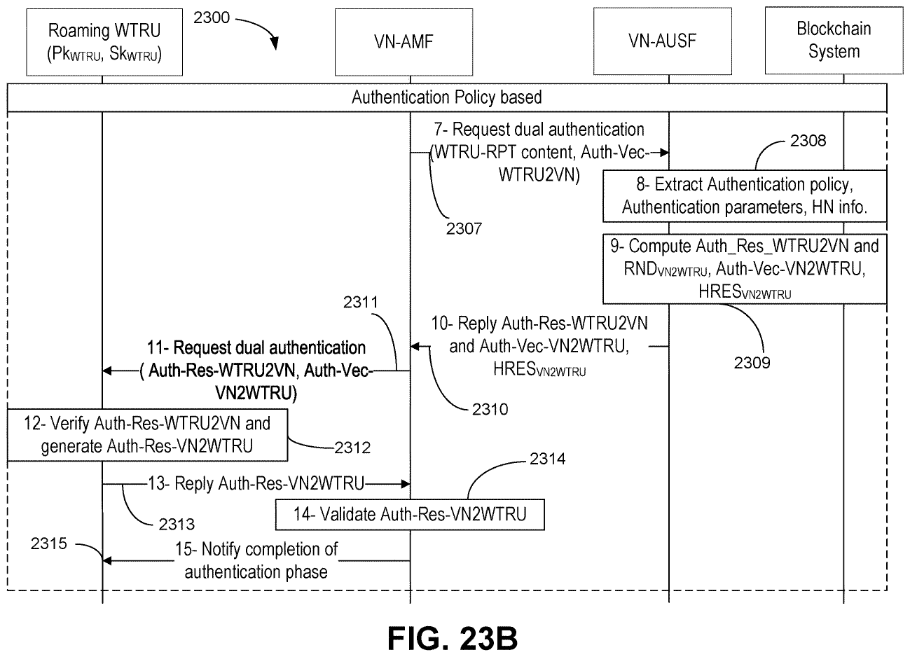

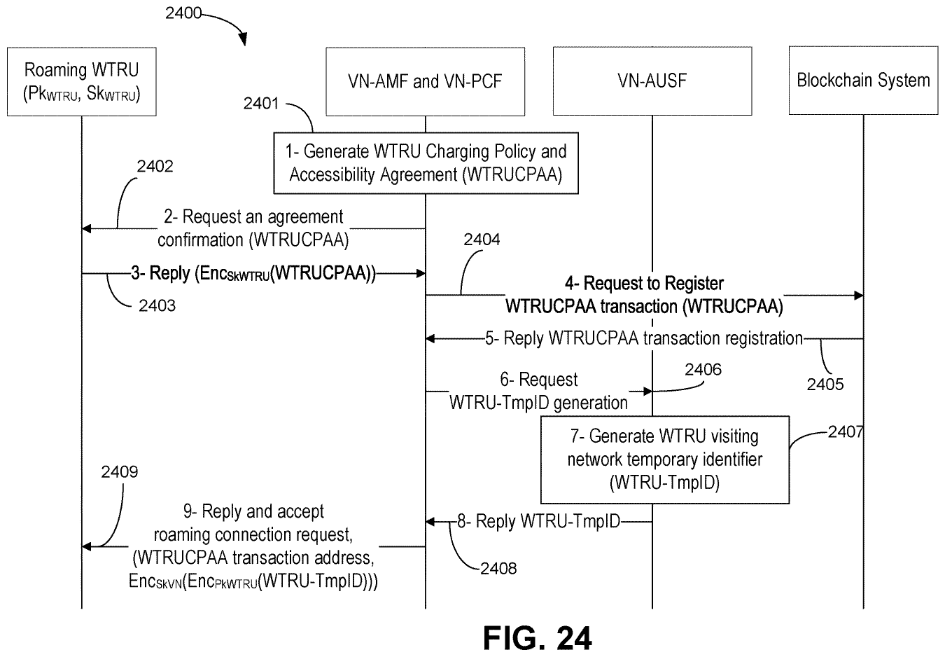

Described herein are service flow embodiments for the WTRU mutual authentication and initial access embodiments, as depicted in FIGS. 23A-B and 24. FIG. 23A-B depicts one or more (e.g., all) interactions between the VN and roaming WTRU that are needed to obtain dual authentication process. FIG. 24 depicts one or more interactions between the VN and roaming WTRU to handle the initial access process and/or issue the roaming WTRU the temporary identifier (WTRU−TmpID).

The roaming WTRU may send the VN a request to use the VN resources during the roaming process. The roaming WTRU and the VN may run a dual authentication mechanism as described herein. After the dual authentication process, the VN may start negotiating with the roaming WTRU to generate the temporary identifier for the roaming WTRU (WTRU−TmpID). One or more of the following assumptions may be considered. It may be assumed that the roaming WTRU may have already obtained the WTRU−Proof from the HN as described herein. It may be assumed that the HN and VN may have already had a decentralized agreement and/or published the Roaming−VN−Key−Repo as described herein. It may be assumed that the roaming WTRU may have already acquired the Roaming−VN−Key−Repo from the blockchain network and/or stored the Roaming−VN−Key−Repo locally in the roaming WTRU storage unit as described herein.

FIG. 23A-B depicts an example service flow 2300 for WTRU dual authentication stage. In examples, as shown in FIG. 22, the WTRU may store locally a copy of the VN−Roaming−Key−Repo smart contract that may include one or more (e.g., all) of the needed public authentication parameters related to the VN. Before the roaming WTRU requests any roaming services, the roaming WTRU may extract the needed information about the VN (e.g., VN public Key, hash value of VN−Proof, and/or hash value of S_{VN2} to be used for the VN authentication based on the RSA-based authentication policy) at 2301.

The roaming WTRU may start preparing the Auth−Vec−WTRU2VN that may be sent to the VN as a challenge to authenticate the VN using the selected authentication policy (e.g., RSA-based or CH-based authentication policy). For example, the WTRU may generate the Auth−Vec−WTRU2VN at 2302, for example, based on the RSA-based authentication policy.

When the roaming WTRU reaches the VN coverage, the roaming WTRU may send a roaming connection request to the VN−AMF at 2303, which may include the WTRU−RPT address in the blockchain. The WTRU−RPT address may be encrypted by the VN's public key (i.e., Enc_{Pk}_{_{VN}}(WTRU−RPT Address)). The roaming WTRU may request a dual authentication from the VN and/or attach to the request the computed Auth−Vec−WTRU2VN.

The roaming connection request procedure may be implemented by extending one or more Registration Management procedures. The roaming WTRU may send a Registration Request (e.g., an Initial Registration, a Mobility Registration, a Periodic Registration Update, an Emergency Registration, a Disaster Roaming Initial Registration, or a Disaster Roaming Registration Update) to the RAN and/or the VN−AMF (e.g., new AMF) at 2303. The Registration Request may include one or more (e.g., all) parameters (e.g., WTRU−RPT address) as shown in FIG. 23A-B and/or one or more (e.g., all) parameters shown in FIG. 14.

When the VN−AMF receives the Registration Request, the VN−AMF may decide to use one of the following two authentication options, for instance, based on its local policy. For example, the VN−AMF may use Authentication Option 2 first; when there may be no any response from the HN including the HN−AMF (e.g., old AMF), the VN−AMF may continue to use Authentication Option 1; in another example, the VN−AMF may use Authentication Option 1 first and it may change to use Authentication Option 2 when Authentication Option 1 may not work (e.g., the blockchain system may get congested and/or WTRU−RPT may not be retrieved from the blockchain system in a timely manner).

In examples, the roaming WTRU may include an Authentication-Indicator in the Registration Request to indicate which authentication option the VN−AMF may use. The Authentication-Indicator may indicate “Use Authentication Option 1”, “Use Authentication Option 2”, “Use Authentication Option 2 first and otherwise Authentication Option 1”, “Use Authentication Option 1 first and otherwise Authentication Option 2”, or “Use both Authentication Option 1 and Authentication Option 2”. It is important to note that even though the VN−AMF may decide or may be instructed to use Authentication Option 2, the VN−AMF may use WTRU−RPT address to retrieve the content of WTRU−RPT from the blockchain system to further verify if the authentication-related parameters returned back from the HN including the HN−AMF are correct and/or valid. Authentication Option 1 may continue to use the procedures as shown in FIG. 23A-B to perform the mutual authentication without contacting the HN. Authentication Option 2 may fall back to use one or more existing Registration Request procedures to contact the HN including the HN−AMF (e.g., old AMF) to register and/or authenticate the roaming WTRU.

The roaming connection request procedure may also be implemented by extending one or more Service Request procedures. In examples, when the roaming WTRU sends a Service Request to RAN and/or the VN−AMF (e.g., new AMF), the Service Request may include one or more (e.g., all) of the parameters (e.g., WTRU−RPT address), as shown in FIG. 23A-B, and/or one or more (e.g., all) of the parameters as shown in FIG. 14. Alternatively or additionally, when the VN−AMF receives the Service Request, the VN−AMF may use one or more of the procedures shown in FIG. 23A-B to replace one or more authentication procedures. Alternatively or additionally, the VN−AMF may use one or more procedures for the authentication purposes. Alternatively or additionally, the roaming may include an Authentication-Indicator to inform the VN−AMF to use one or more (e.g., the rest) of the procedures as depicted in FIG. 23A-B.

When the VN−AMF receives the roaming WTRU's request, the VN−AMF may decrypt the encrypted WTRU−RPT using its private key by computing Dec_{Sk}_{_{VN}} (Enc_{Pk}_{_{VN}}(WTRU−RPT Address)) to obtain the WTRU−RPT address at 2304. When the VN−AMF decrypts and/or recovers the original WTRU−RPT address, the VN−AMF may send a request to the blockchain system to pull up the WTRU Roaming Proof Transaction (WTRU−RPT) content at 2305. The blockchain system may check the WTRU−RPT and/or may respond to the VN−AMF request by sending the WTRU−RPT content to the VN−AMF at 2306.

When the VN−AMF receives the WTRU−RPT content from one or more blockchain nodes, the VN−AMF may send a request to the VN−AUSF to start performing a dual authentication process at 2307, for example, by generating the Auth−Vec−VN2WTRU and/or obtaining the Auth−Res−WTRU2VN. The VN−AMF may attach to the dual authentication request sent to the VN−AUSF, the UR−RPT content, and/or the received Auth−Vec−WTRU2VN received.

When the VN−AUSF receives the roaming WTRU dual authentication request from the VN−AMF, the VN−AUSF may start extracting one or more authentication parameters from the WTRU−RPT, check the authentication policy, and/or check the HN information at 2308. The VN−AUSF may generate the RND_{VN2WTRU}, Auth−Vec−VN2WTRU, compute the expected hash response (HRES_{VN2WTRU}) and/or extract the Auth−Vec−WTRU2VN parameters according to a RSA-based authentication policy at 2309. A similar approach may be adopted if the CH-based authentication policy were selected. Therefore, similar procedures to those shown in FIG. 16 may be performed.

The VN−AUSF may then send the generated Auth−Vec−VN2WTRU and/or HRES_{VN2WTRU} to the VN−AMF at 2310. The VN−AUSF may send the Auth−Res−WTRU2VN to the VN−AMF. The VN−AMF may respond to the authentication request sent by the roaming WTRU. The VN−AMF response to the authentication request may include the computed Auth−Res−WTRU2VN calculated. The VN−AMF may send the computed Auth−Vec−VN2WTRU as a request to dual authentication to the roaming WTRU at 2311.

When the roaming WTRU receives the Auth−Res−WTRU2VN and/or the Auth−Vec−VN2WTRU from the VN−AMF, the roaming WTRU may start executing one or more of the procedures shown in FIG. 19A-B. The roaming WTRU may authenticate the VN at 2312, for example, by validating the parameters received in the Auth−Res−WTRU2VN. The roaming WTRU may generate the Auth−Res−VN2WTRU, similar to the process depicted in FIG. 19A-B, in order to authenticate itself to the VN considering the authentication policy is RSA-based. A similar approach may be adopted if the CH-based authentication policy was selected. Therefore, one or more of the procedures shown in FIG. 16 may be performed.

When the roaming WTRU finishes the calculation of the Auth−Res−VN2WTRU, the roaming WTRU may send a response to the VN−AMF about the dual authentication request and/or attach the value of the Auth−Res−VN2WTRU value to the message at 2313. When the VN−AMF receives the Auth−Res−VN2WTRU from the roaming WTRU, the VN−AMF may validate the Auth−Res−VN2WTRU at 2314. The VN may send the roaming WTRU a notification indicating the successful completion of the authentication phase at 2315.

FIG. 24 is a flow diagram illustrating an example of 3GPP Service Flow 2400 for Initial Access Stage. After obtaining the dual authentication process, the VN may negotiate with the roaming WTRU to create the WTRUCPAA and/or generate the WTRU−TmpID (e.g., as shown in FIG. 20). The VN−PCF may generate a WTRU Charging Policy and Access Agreement (WTRUCPAA) at 2401. The generated WTRUCPAA may indicate the negotiation and agreement between the VN, and the roaming WTRU about, but not limited to, the charging criteria, the expected QoS the roaming WTRU should receive, the limitations and regulations the roaming WTRU may follow, the method the roaming WTRU may prefer to pay the service with, and/or the estimated visited time for the roaming WTRU (e.g., Expiry date of the WTRU visit), etc.

After generating the WTRUCPAA, the VN−PCF may send the WTRUCPAA to the roaming WTRU through the VN−AMF for confirmation and/or signature at 2402. When the roaming WTRU receives the WTRUCPAA, the roaming WTRU may check the parameters and/or terms included in the WTRUCPAA, add any additional terms if preferred. The roaming WTRU may then digitally sign the received WTRUCPAA using the roaming WTRU's private key and/or may then send the digitally signed version of the WTRUCPAA to the VN−PCF through VN−AMF at 2403.

When the VN receives the digitally signed version of the WTRUCPAA, the VN−PCF may request deploying the WTRUCPAA to the blockchain ledger at 2404. When the blockchain system receives the WTRUCPAA smart contract content, the WTRUCPAA smart contract may be broadcast and/or may be validated within and/or by the blockchain system. After the validation of the WTRUCPAA smart contract, the blockchain system may send a response to the VN−PCF indicating that the WTRUCPAA smart contract may have been successfully validated and/or stored in the blockchain ledger at 2405.

The VN−PCF may send the VN−AUSF a request to generate the WTRU−TmpID for the roaming WTRU at 2406. When the VN−AUSF receives the VN−PCF request, the VN−AUSF may generate a temporary identifier (WTRU−TmpID) for the roaming WTRU to represent a temporary SUPI at 2407. When the VN−AUSF finishes generating the WTRU−TmpID, the VN−AUSF may send the VN−PCF the generated WTRU−TmpID at 2408.

When the VN−PCF receives the WTRU−TmpID from the VN−AUSF, the VN−PCF may accept the received roaming connection request sent by the roaming WTRU. The VN−PCF may then send a roaming connection response through the VN−AMF to the roaming WTRU at 2409, while for example, attaching the WTRUCPAA address as a confirmation that the WTRUCPAA smart contract may have been successfully deployed in the blockchain. The VN−PCF may attach an encrypted version of the generated WTRU−TmpID using the roaming WTRU's public key and digitally signed by the VN's private key (Enc_{Sk}_{_{VN}} (Enc_{PK}_{_{WTRU}}(WTRU−TmpID))).

What is claimed is:

1-20. (canceled)

21. A wireless transmit/receive unit (WTRU) comprising:
at least one processor configured to:
send a request to a first network system requesting a roaming proof address from the first network system, wherein the first network system comprises a home network system through which the WTRU is registered for performing wireless communications;
receive a response from the first network system comprising the roaming proof address, wherein the roaming proof address comprises an address to a second network system where roaming proof information is accessible via the roaming proof address;
send the roaming proof address to a third network system to access the third network system, wherein the third network system is a visited network system;
receive an authentication request from the third network system, wherein the authentication request comprises a request to perform authentication based on the roaming proof information; and
send an authentication response to the third network system, wherein the authentication response comprises a response to the authentication request that is based on the roaming proof information.

22. The WTRU of claim 21, wherein the roaming proof information is accessible via distributed ledgers, and wherein the distributed ledgers comprise a blockchain.

23. The WTRU of claim 21, wherein the second network is a blockchain network.

24. The WTRU of claim 21, wherein the request sent to the first network system comprises an indication of an authentication policy supported by the WTRU.

25. The WTRU of claim 24, wherein the authentication policy performed by the at least one processor is a Rivest-Shamir-Adleman (RSA) authentication policy or a Chameleon Hash (CH) authentication policy.

26. The WTRU of claim 25, wherein the request sent to the first network system by the at least one processor further comprises:
an indication of a lifetime for the roaming proof address; and
a location of the WTRU.

27. The WTRU of claim 26, wherein the at least one processor is configured to:
receive an authentication challenge from the third network system, wherein the authentication challenge was determined based on the authentication policy supported by the WTRU; and
perform the authentication challenge to determine the authentication response.

28. The WTRU of claim 21 wherein the response from the first network system performed by the at least one processor further comprises authentication parameters and a WTRU−Proof value that is used to anonymously authenticate the WTRU.

29. The WTRU of claim 21, wherein the at least one processor is configured to:
send a request to a blockchain system to obtain one or more public keys of the third network system to verify and authenticate the third network system; and
receive a response from the blockchain system that comprises the one or more public keys of the third network system.

30. The WTRU of claim 21, wherein the at least one processor is configured to:
receive an indication from the third network system that indicates that the authentication is complete.

31. A method performed by a wireless transmit/receive unit (WTRU), the method comprising:
sending a request to a first network system requesting a roaming proof address from the first network system, wherein the first network system comprises a home network system through which the WTRU is registered for performing wireless communications;
receiving a response from the first network system comprising the roaming proof address, wherein the roaming proof address comprises an address to a second network system where roaming proof information is accessible via the roaming proof address;
sending the roaming proof address to a third network system to access the third network system, wherein the third network system is a visited network system;
receiving an authentication request from the third network system, wherein the authentication request comprises a request to perform authentication based on the roaming proof information; and
sending an authentication response to the third network system, wherein the authentication response comprises a response to the authentication request that is based on the roaming proof information.

32. The method of claim 31, wherein the roaming proof information is accessible via distributed ledgers, and wherein the distributed ledgers comprise a blockchain.

33. The method of claim 31, wherein the second network is a blockchain network.

34. The method of claim 31, wherein the request sent to the first network system comprises an indication of an authentication policy supported by the WTRU.

35. The method of claim 34, wherein the authentication policy performed by the method is a Rivest-Shamir-Adleman (RSA) authentication policy or a Chameleon Hash (CH) authentication policy.

36. The method of claim 35, wherein the request sent to the first network system by the method further comprises:
an indication of a lifetime for the roaming proof address; and
a location of the WTRU.

37. The method of claim 36, wherein the method further comprises:
receiving an authentication challenge from the third network system, wherein the authentication challenge was determined based on the authentication policy supported by the WTRU; and
performing the authentication challenge to determine the authentication response.

38. The method of claim 31 wherein the response from the first network system performed by the method further comprises authentication parameters and a WTRU−Proof value that is used to anonymously authenticate the WTRU.

39. The method of claim 31, wherein the method further comprises:
sending a request to a blockchain system to obtain one or more public keys of the third network system to verify and authenticate the third network system; and
receiving a response from the blockchain system that comprises the one or more public keys of the third network system.

40. The method of claim 31, wherein the method further comprises:
receiving an indication from the third network system that indicates that the authentication is complete.
